(19) United States
(12) Patent Application Publication
(10) Pub. No.: US 2008/0059279 A1
(43) Pub. Date: Mar. 6, 2008

(54) Network-based business process for improving performance of businesses

(76) Inventors: James D. Goldschneider, Newark, DE (US); Michael D. Blake, Oaklyn, NJ (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 09/887,414

(22) Filed: Jun. 22, 2001

Related U.S. Application Data
(60) Provisional application No. 60/249,860, filed on Nov. 17, 2000.

(51) Int. Cl. G06F 17/30

(52) U.S. Cl. 705/10

(57) ABSTRACT

The present invention relates to a network-based business process. The process allows a business owner through a logon procedure on his computer to access, preferably via a website, the process of the present invention loaded on a host computer. The customer then accesses a main menu having one or more business tools suitable for improving the performance of businesses and is then requested to choose one of the business tools. The customer then enters customer business data as per instructions provided on the web page of the selected business tool. The process of the present invention then processes the entered data and provides a business solution to the customer. The menu includes several important business tools, such as plant capacity planner, determining optimal sales potential of the business, run charts, plant layout, business evaluation, sales & production tracker, work-in-process, etc. The process of the present invention is suitable for any business, but it is especially suitable for small businesses that may not be able to afford expensive consultants or personnel to run sophisticated programs necessary to improve business efficiency and profit margins. Some of the suitable businesses include, an auto collision repair shops, machine shops, grocery stores, butcher shops, barber shops, and manufacturing plants.

### BACKGROUND OF THE INVENTION

1. Field of the Invention

The present invention is directed to a network based business process that improves the performance of businesses, more particularly to a business process that utilizes the worldwide web for access.

2. Description of Related Art

In order to run a business efficiently and profitably, a business manager or owner typically needs extensive, readily available data on how the business is currently performing against business forecast as well as how well or poorly the business is performing against similarly situated businesses in competition. Another important aspect of improving business efficiency and profitability is the business manager or owner's ability to develop real time alternate business models that forecast improved profits and efficiencies. Such models can be obtained by, for example, modifying current business processes or focusing on key problem areas affecting the competitiveness of the business. However, many businesses, especially small businesses, having only a handful of employees, may not be able to afford to hire additional employees or consultants that are typically needed to conduct such in-depth business analyses.

Currently, the process involved is quite cumbersome, expensive and time consuming. Typically, consultants or sales representatives meet with their customers, laboriously collect the information and convert the information into spreadsheet-based models to identify customer problems or ways of improving the profitability. There are several problems associated with such a process. Usually the data is not collected in an organized fashion to be useful to better understand the business practices. Moreover, such a data collection conducted by an outsider generally disrupts normal business operation. Employees tend to be either reticent while dealing with a consultant or are reluctant to fully provide requested information. Thus, unless the business manager is willing or able to spend money on a continuing long-term basis, it is too expensive or cumbersome for a business manager to make use of such services. Thus, a need exists for a less cumbersome business process that efficiently addresses the foregoing problems associated with current processes involved in improving business profitability and efficiency.

### BRIEF SUMMARY OF THE INVENTION

The present invention is directed to a network-based business process comprising the steps of:

(a) receiving an initial request from a customer computer linked with a host computer through a network;

(b) completing a log-on procedure to allow the customer computer to access said host computer having a main menu comprising one or more business tools suitable for improving performance of businesses;

(c) requesting the customer computer to choose a business tool from said menu;

(d) requesting the customer computer to enter customer business data required for business performance analysis in said chosen business tool;

(e) processing said data through an algorithmic module of said chosen business tool to carry out a business analysis for said business tool; and

(f) providing a business solution based on said business analysis to said customer computer.

The business tools in the aforestated main menu are selected from the group consisting of:

I. Capacity planner,

II. Sales potential,

III. Direct repair program analyzer,

IV. Run charts,

V. Plant layout,

VI. Bench marking,

VII. Business valuation,

VIII. PAINT DEPARTMENT OPTIMIZER^{SM},

IX. Sales & production tracker,

X. Team pay calculator,

XI. Process audits,

XII. Work in process, and a combination thereof.

### BRIEF DESCRIPTION OF THE DRAWINGS

FIG. 1 broadly illustrates the hardware involved in the process of the present invention.

FIG. 2 is a flowchart that broadly illustrates the steps taking place in the process of the present invention.

FIGS. 3A, 3B, 3C, 3D and 3E are flowcharts that illustrate the detailed steps taking place in the preferred embodiment of the process of the present invention.

FIG. 4 is a flowchart that illustrates the process steps taking place in a work in progress business tool of the process of the present invention.

FIGS. 5A, 5B, 5C, 5D and 5E illustrate the screen shots of a layout displayed on the customer computer during a logon process.

FIGS. 6A, 6BA, 6BB, 6BC, 6CA, 6CB, 6DA, 6DB, 6EA, 6EB, 6EC and 6ED illustrate the screen shots of a layout displayed on the customer computer when a capacity planner business tool is accessed.

FIGS. 7A, 7BA and 7BC illustrate the screen shots of a layout displayed on the customer computer when a sales potential business tool is accessed.

FIGS. 8A, 8BA, 8BB and 8BC illustrate the screen shots of a layout displayed on the customer computer when a direct repair program analyzer business tool is accessed.

FIGS. 9A, 9BA, 9BB, 9BC, 9BD, 9BE and 9BF illustrate the screen shots of a layout displayed on the customer computer when a run charts business tool is accessed.

FIGS. 10A, 10BA, 10BB and 10BC illustrate the screen shots of a layout displayed on the customer computer when a layout and design business tool is accessed.

FIGS. 11A, 1lB, 11CA, 11CB, 11DA, 11DB, 11EA, 11EB, 11EC, 11IF, 11GA, 11GB and 11H illustrate the screen shots of a layout displayed on the customer computer when a benchmarking business tool is accessed.

FIGS. 12A and 12B illustrate the screen shots of a layout displayed on the customer computer when a business valuation business tool is accessed.

FIGS. 13A, 13B, 13CA, 13CB, 13DA, 13DB, 13EA and 13EB illustrate the screen shots of a layout displayed on the customer computer when a PAINT DEPARTMENT OPTIMIZER^{SM}business tool is accessed.

FIGS. 14A, 14BA, 14BB, 14BC, 14CA, 14CB and 14CC illustrate the screen shots of a layout displayed on the customer computer when a sales and production tracker business tool is accessed.

FIGS. 15A, 15BA, 15BB, 15C, 15D and 15E illustrate the screen shots of a layout displayed on the customer computer when a team pay calculator business tool is accessed.

FIGS. 16A, 16B, 16BA1, 16BA2, 16BB1, 16BB2, 16BB3, 16BB4, 16BB5, 16BB6, 16BC1, 16BC2, 16BC3, 16BD1, 16BD2, 16BE1, 16BE2, 16BF1, 16BF2, 16BG1, 16BG2, 16BH1, 16BH2, 16BJ1 16BJ2, 16BJ3, 16BJ4, 16BK1, 16BK2, 16BK3, 16BK4, 16BL1, 16BL2, 16BL3, 16BM1, 16BM2, 16BM3, 16BN1, 16BN2, 16BN3, 16BN4, 16BP1, 16BP2, 16C, 16DA, 16DB and 16DC illustrate the screen shots of a layout displayed on the customer computer when a process audit business tool is accessed.

FIGS. 17A, 17B, 17C, 17D, 17E, 17F and 17G illustrate the screen shots of a layout displayed on the customer computer when a work-in-process business tool is accessed.

### DETAILED DESCRIPTION OF THE PREFERRED EMBODIMENT

As defined herein:

“Host” is the one who markets and offers the network-based business process of the present invention to one or more customers located worldwide.

“Customer” is the one who utilizes the network-based business process of the present invention offered by the host. One example of a customer is a collision repair shop.

“Client” is the one who utilizes the services offered by the customer. One example of a client is one who gets his car repaired and/or painted by the collision repair shop.

“Host computer” is a host-operated computer programmed with software to run the network-based business process of the present invention. The host computer can include one or more computers coupled to act as a host computer and the host computer can be located within the United States or outside the territories of the United States.

“Customer computer” is a customer-operated computer located at a customer's place of business that is programmed to communicate with the host computer. The customer computer can be located within the United States or outside the territories of the United States.

“Network” means any two-way communication system that allows one or more customer computers to access and interact with a host computer. Such communication systems are well known in the art, such as dedicated telephone network or preferably internet, such as the World Wide Web. The network also includes wireless networks, i.e., data can be entered via hand held devices that are connected to the internet via wireless signals.

The process of the present invention is directed to a network-based business process. The process improves the business performance by identifying process problems, such as process bottlenecks, poor business practices, and poor financial performance.

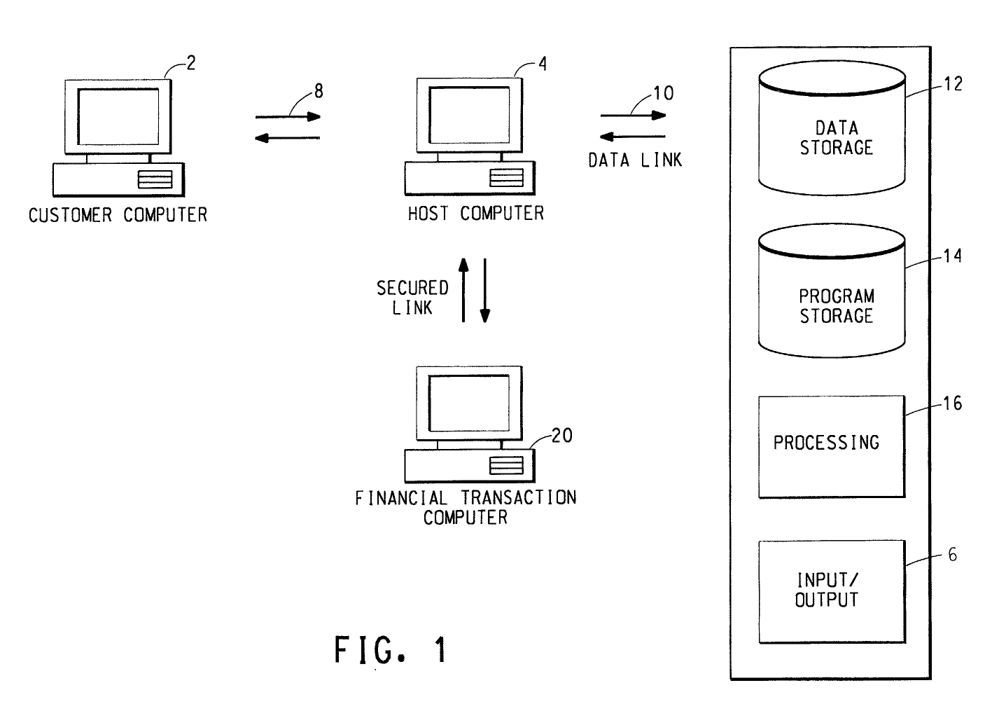

The hardware involved in the claimed process is shown in FIG. 1. One or more conventional customer computers 2 connect through a network 8 to a conventional host computer 4. Host computer 4 includes conventional input/output devices 6 that link via data link 10 with customer computer 2, data storage 12 that stores data generated during the use of the claimed business process. Program storage 14 stores specially developed software used to run the network-based business process of the present invention and a central processing unit 16. Optionally, host computer 4 is connected via conventional secured link 11 with a conventional financial transaction computer 20 used for performing financial transactions, such as those conventionally conducted by means of credit cards. A programming software known as Coldfusion® version 3.5 supplied by Macromedia, Inc., San Francisco, Calif. was utilized to develop the software used in the present invention, details of which are described in the attached Appendix A to this patent application.

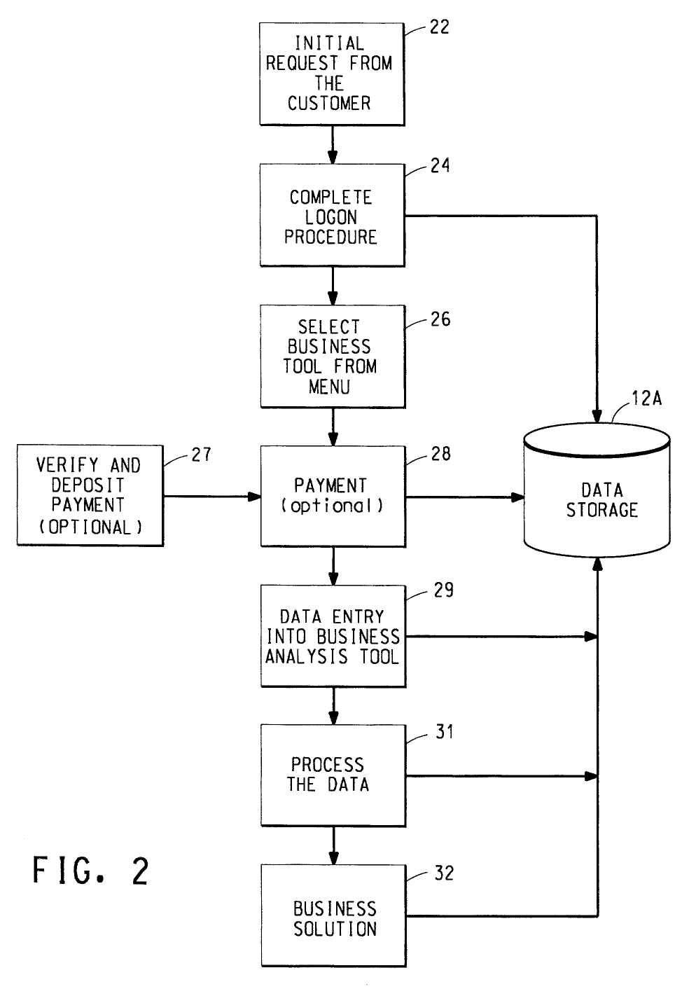

In its broadest aspects, as seen in FIGS. 1 and 2, the network-based business process of the present invention starts with a step 22 in FIG. 2 when host computer 4 receives an initial request from a customer, typically a business manager or business owner operating customer computer 2 via network 4. In a step, 24, a log-on procedure is completed. Customer information supplied by customer computer 2 or any updated information is stored in data storage 12A of host computer 4. In a step 26, preferably after proper authentication, customer computer 2 is allowed access to a main menu on host computer 4 and then requested to choose one or more business tools suitable for improving performance of businesses listed in the main menu. In an optional step 28, the customer computer 2 operated by the customer may be requested to make a payment, deposited through an optional step 27 to secured transaction computer 20 preferably connected via secured link 11. In a step 29, customer computer 2 is requested to enter customer business data required for business performance analysis in the chosen business tool. In a step 31, host computer 4 processes data through an algorithmic module of the chosen business tool to carry out a business analysis for said business tool. In a step 32, host computer 4 then provides a business solution based on the business analysis to customer computer 4. Data entered in steps 29 and 32, and in optional step 28 are stored for future use and archival purposes in data storage 12A of host computer 4.

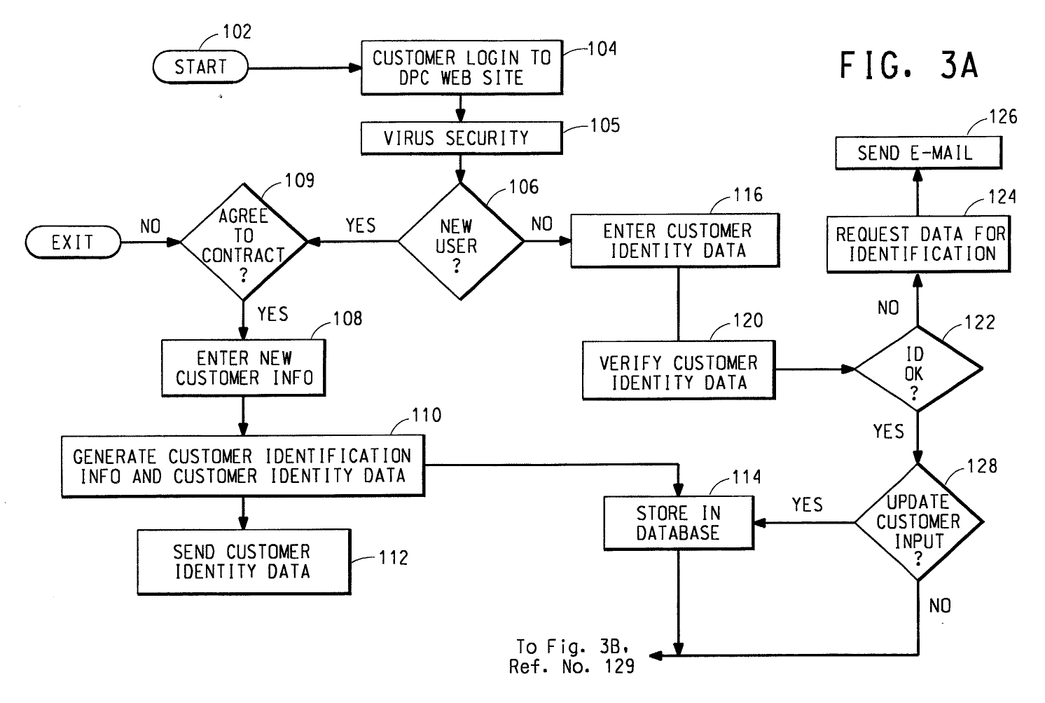

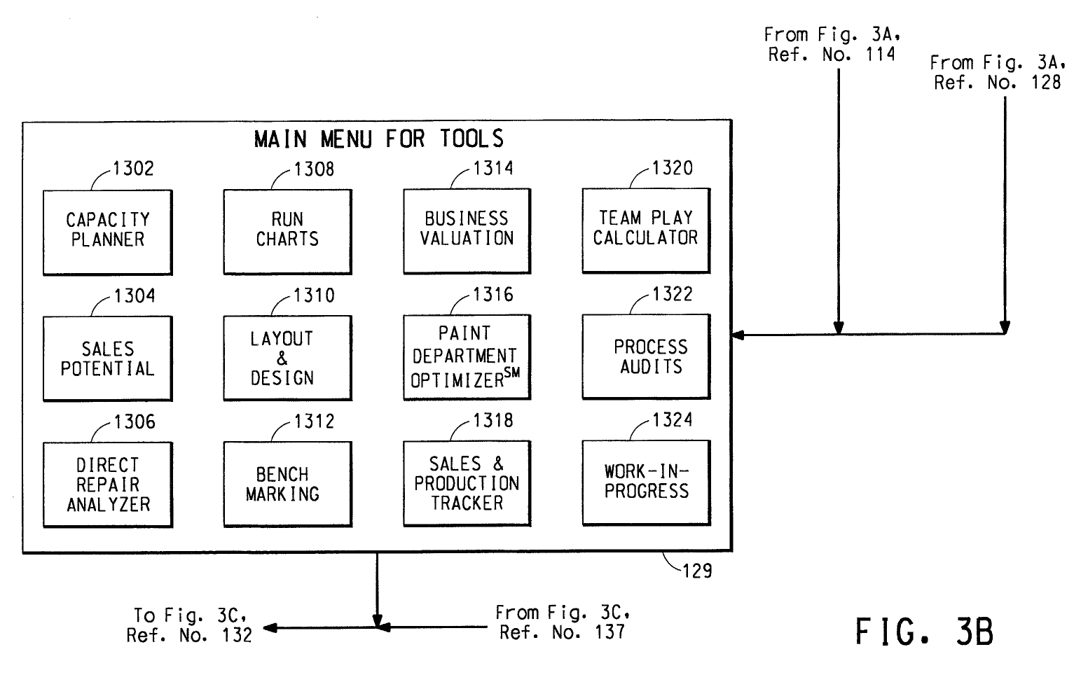

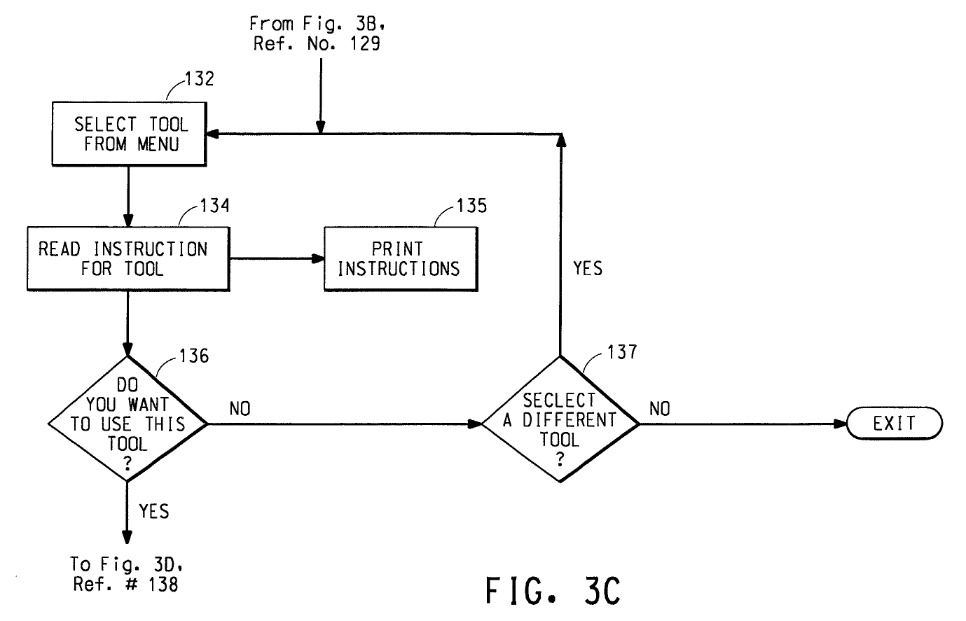

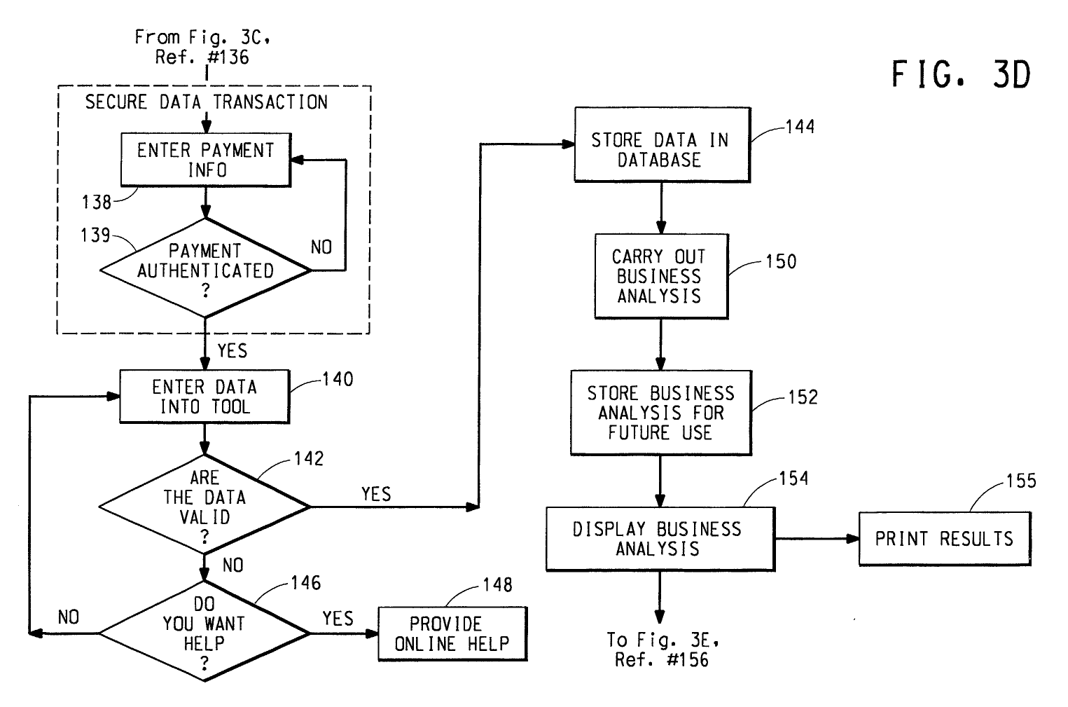

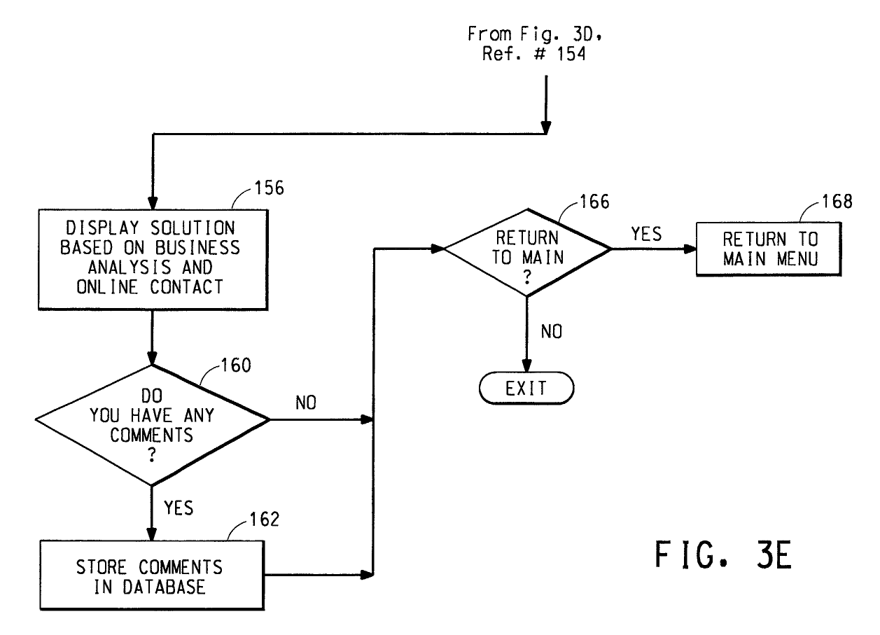

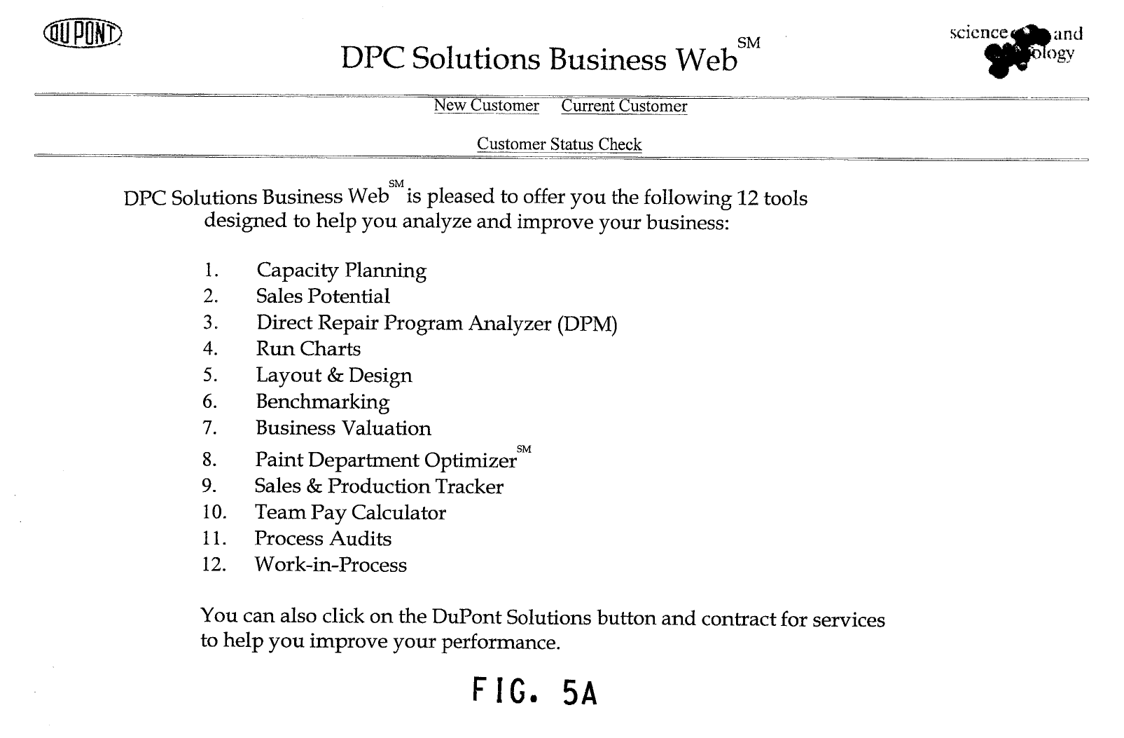

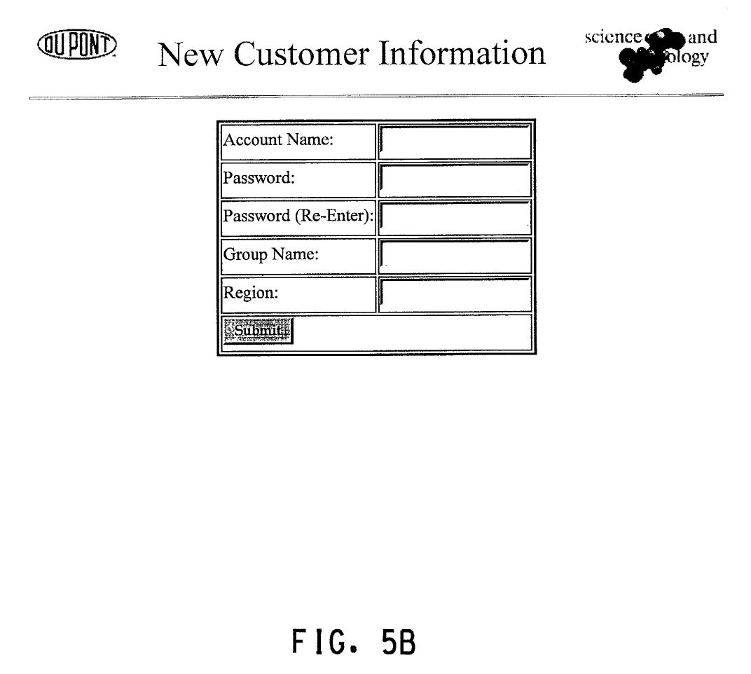

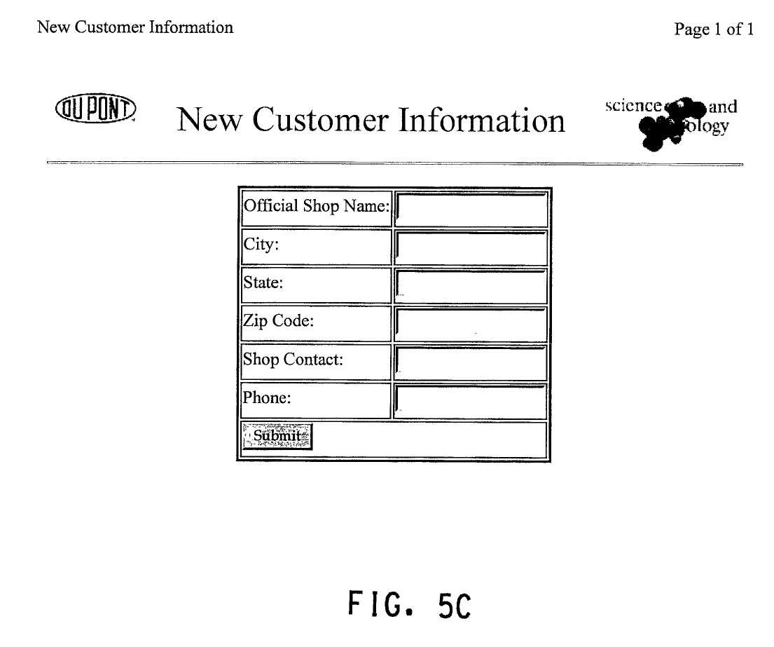

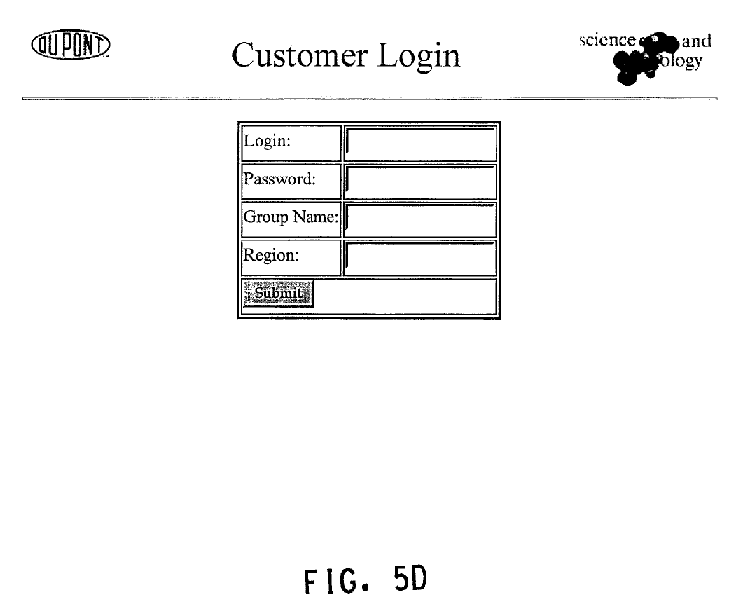

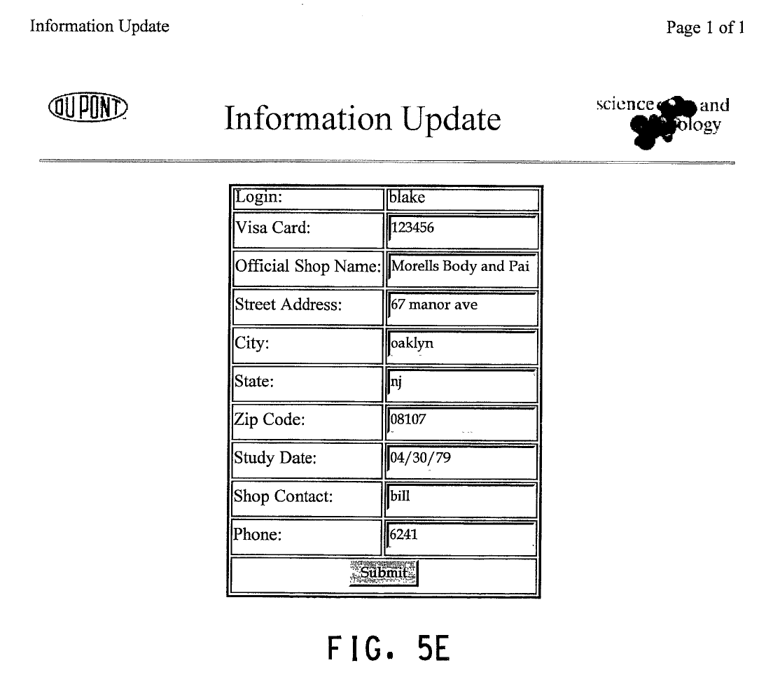

Further details of process step 22 in FIG. 2 are shown in FIG. 3A where a step 102 of the process starts when customer computer 2 accesses host computer 4 via internet, preferably a worldwide business web site. It should be noted that such an access could be provided via hard wire connections or via wireless connections. A screen shot of the website is shown in FIG. 5A. The process for accessing the worldwide business web site is conventional and well known. In a step 104, customer computer 2 customer logs on the web site to start the logon procedure. Preferably, conventional virus security program 105 can be utilized to prevent malicious entry into host computer 4 to thereby stop any tampering of the business software used in the process of the present invention and also to ensure that all the communication remains secure.

Details of process step 24 are shown in FIG. 3A where through a query 106 the identity of customer computer 2 is ascertained by host computer 4 to determine whether customer computer 2 is a new user computer or a current user computer. To a new user host computer 4 preferably sends customer computer 2 a downloadable contract, typically utilized in e-commerce that lists the terms and conditions that allow access to the process of the present invention. Through a query 106, customer computer 2, logging on as a new user computer is preferably requested to agree to abide by the contract for availing the services offered by the process of the present invention. If affirmative choice is made, host computer 4 through a step 108 requests customer computer 2 to enter data on a new customer information, which is preferably kept confidential and a notice to such an effect is sent to customer computer 2. FIGS. 5B and SC show screen shots of a typical information requested, which may be modified or varied depending upon the business requirement that is being analyzed. Upon completing the data entry of customer information, host computer 4, through a step 110, generates a customer identity data, which, through a step 112, is sent to customer computer 2 for future access. The customer identity data typically includes an account name and password. For a larger business entity, the account name can include any division or subsidiary of the business entity as well as the region of the country where the division or subsidiary of the business entity is located. Host computer 4 through a step 114 stores the customer information and the customer identity data in a database and allows the new user to access a main menu for business tools 129.

If in a query 106, customer computer 2 logs on as a current user computer, host computer 4 requests customer computer 2 through a step 116 to enter the customer identity data sent earlier in step 112 to match against the current identity data stored on host computer 4. FIG. 5D shows a screen shot of the log-in process for a current user. In a step 120, host computer 4 verifies the data entered by customer computer 2 against the current identity data stored on host computer 4. Once the identity of customer computer 2 is verified through a match, host computer 4 through a query 122 allows customer computer 2, logged on as a current user, access to main menu 129. If customer identity data entered by customer computer 2 fails to match with the previously stored customer identification data, host computer 4 through a step 124 sends a message to customer computer 2 to verify the customer identity data. If customer computer 2 fails again, host computer 4 can then send to customer computer 2, preferably on a previously provided e-mail address, the details of customer identity data to allow customer computer 2 properly logon again.

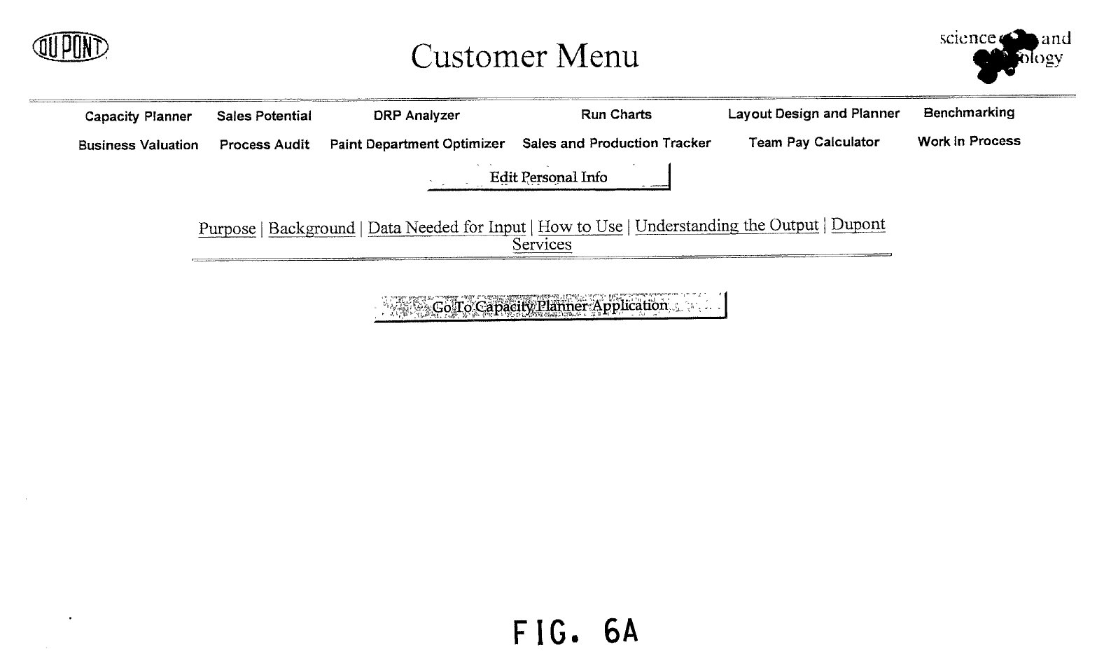

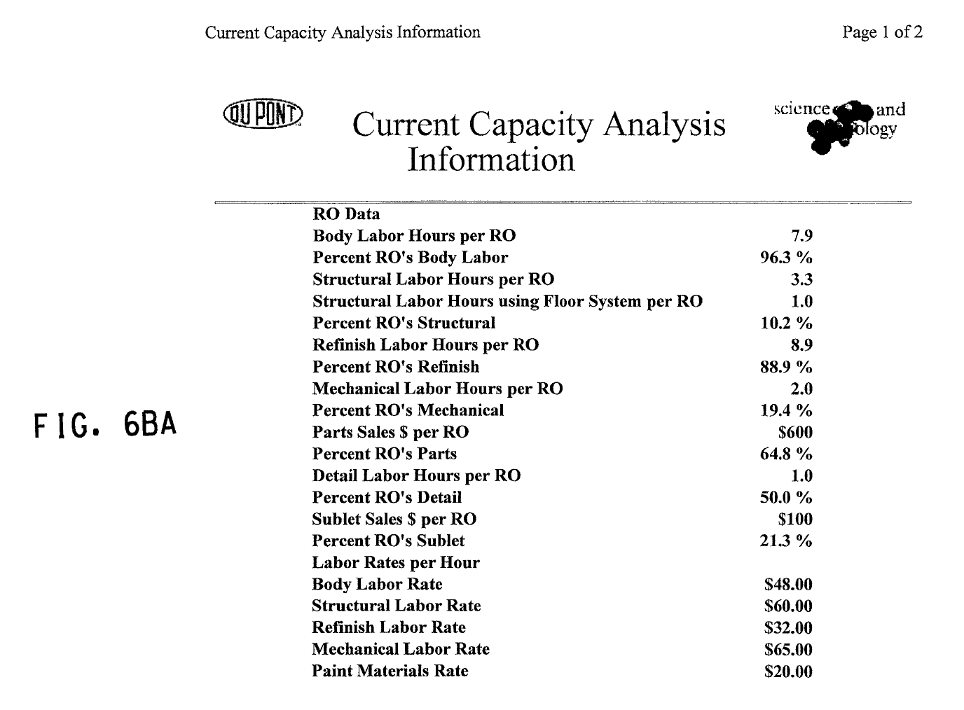

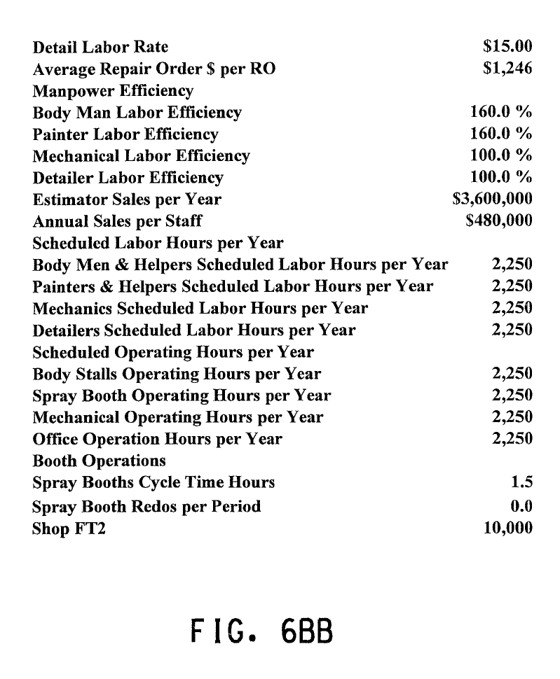

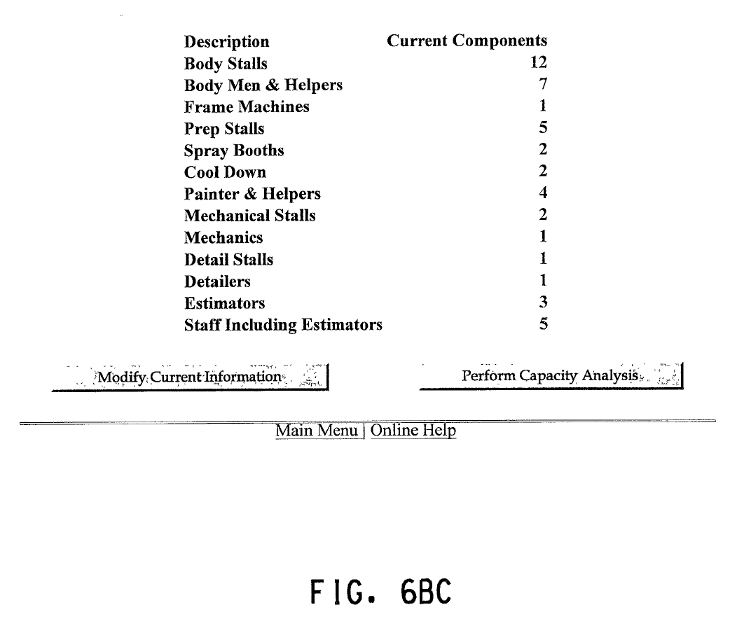

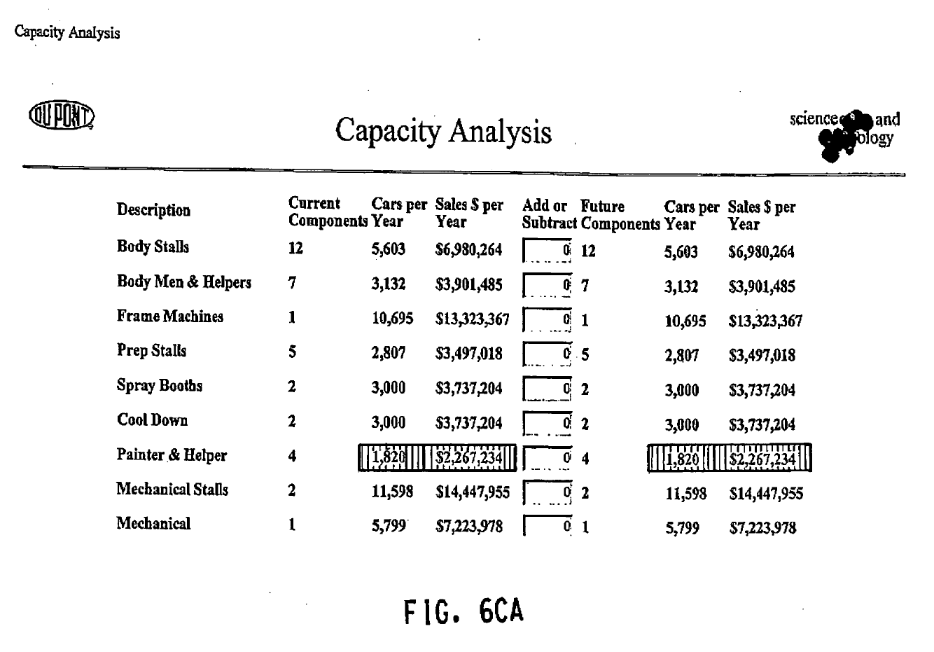

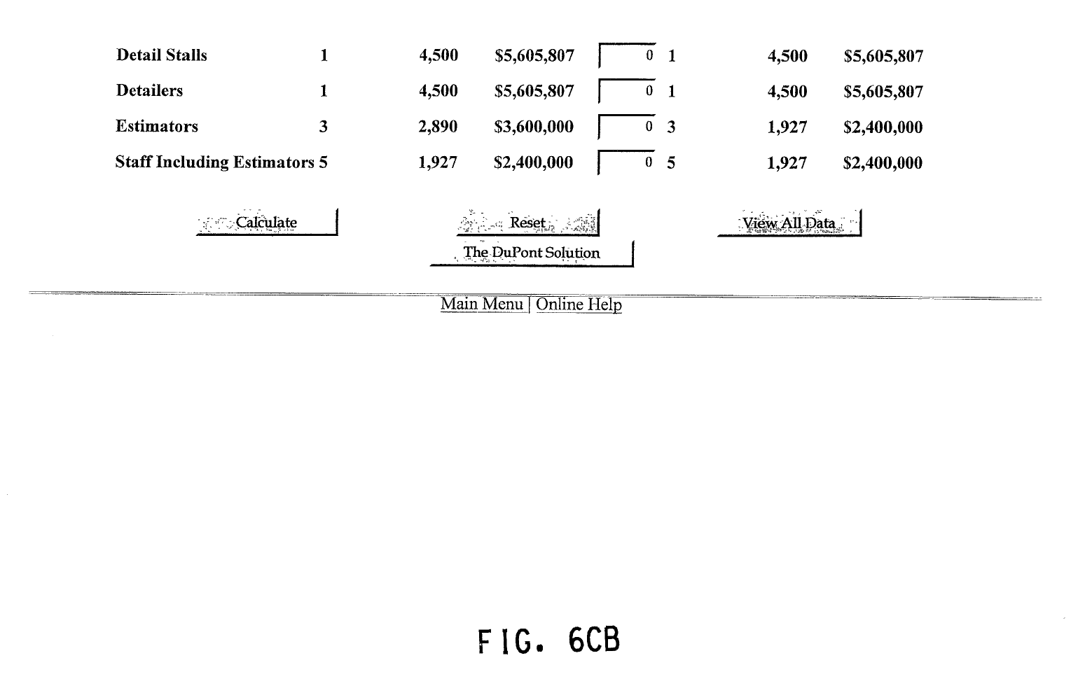

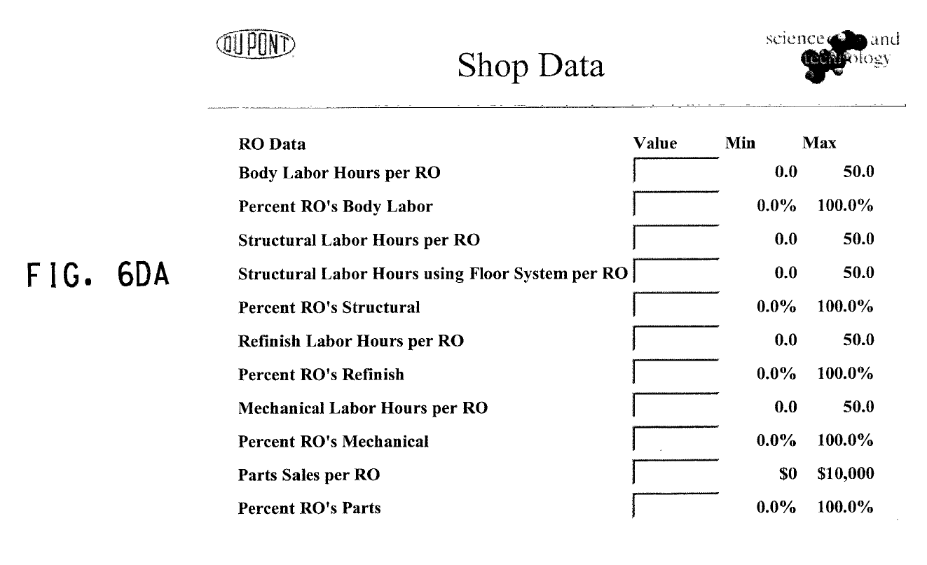

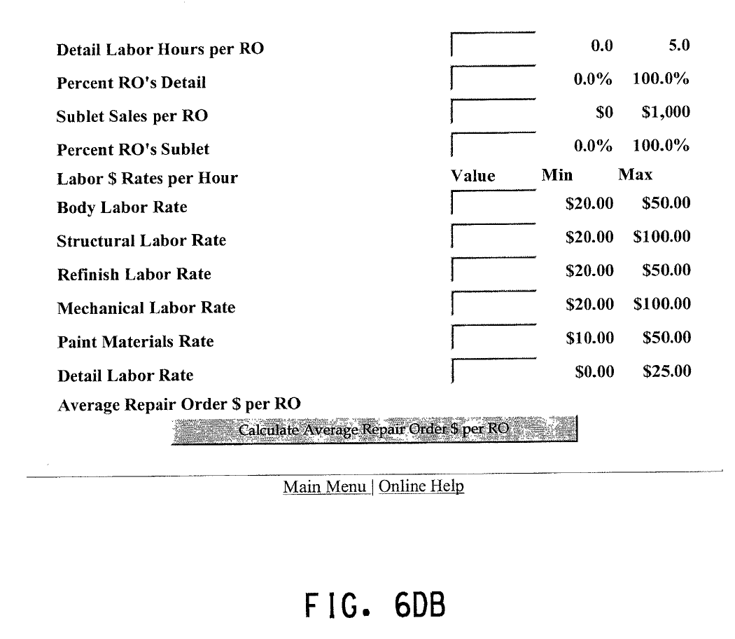

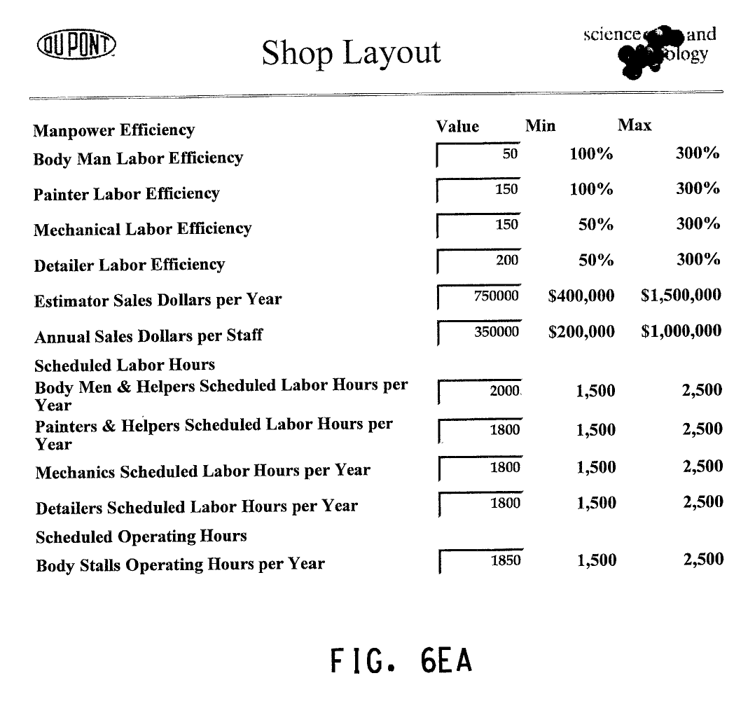

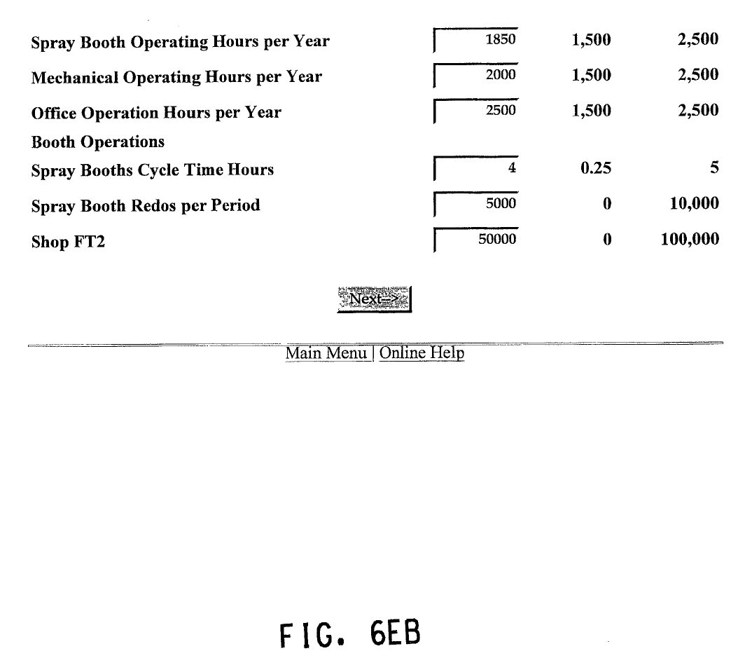

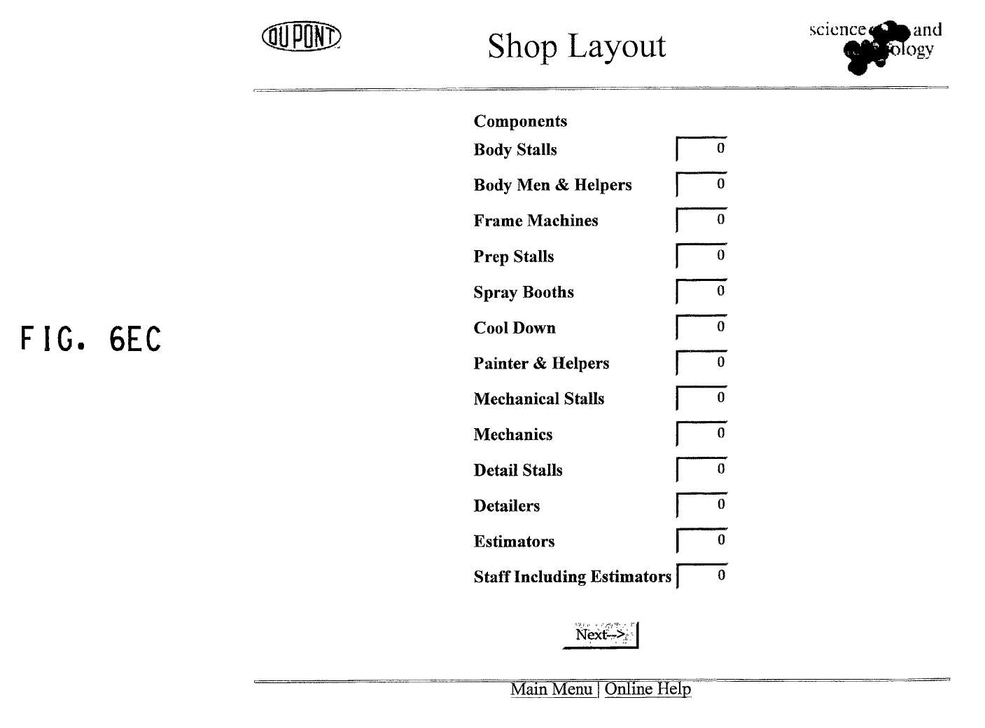

If customer computer 2 properly logs-in, host computer 4 directs customer computer 2 to main menu 129. FIG. 3A shows the relevant steps and FIG. 6A shows a screen shot of menu 129. Host computer 4 through a query 128 invites customer computer 2 to update current customer information stored in the database. FIG. 6A shows an “edit personal info” request button. FIG. 5E shows a screen shot of information update through which customer computer 2 can update any changes to the customer information that may be needed. Host computer 4, through a step 114, stores any updates in the database.

As shown in FIG. 3B, menu 129 contains offerings of various tools that can assist the customer in improving customer's business. The tools shown in menu 129 are by no means exhaustive. The present invention also contemplates other tools or additional tools that improve customer's business. As shown in FIG. 3C, customer computer 2 is invited through a step 132 to select a tool from menu 129. Host computer 4 through a step 134 then directs customer computer 2 to the selected tool, such as, for example, a capacity planner tool 1302. By way of example, FIG. 6A shows a screen shot of capacity planner tool 1302 and provides instructions for using the chosen business tool. A step 135 permits customer computer 2 to print the instructions if so desired. A query 136 directs customer computer 2 to confirm the selection of the tool, choose another tool through a step 137, or exit from the program.

By way of example, following instructions are provided in FIG. 6A for capacity planer business tool 1302 when used for analyzing plant capacity of an auto repair and paint shop:

### “Purpose”

The capacity planner allows you to identify process steps or equipment in your shop that results in the bottleneck.

### Background

Each part of your shop has a capacity to produce work. The overall capacity is dependent on the capacity of the slowest part of the process. This aspect of the process is called the bottleneck. The bottleneck could be facility related, technician related, or office related.

The ability to repair cars is dependent on many factors. It is not always obvious which part of the shop needs to be expanded to increase throughput. Even if you increase the constraining resource, you may not get much more throughput because another bottleneck can exist which has just a little higher capacity then the original bottleneck. What this means is that you will have to change several parts of the shop in order to achieve significant capacity increases. The reason for this is that you tend to size the shop based on the constraining resource. For example, if you are constrained by the number of spray booths, it makes no business sense to have more personnel in body or paint stalls that can produce more work than can be processed by the spray booth. Thus, when you add a new booth you may have to add a painter, a body man, office staff, a frame machine, etc. in order to take full advantage of the new booth.

### Data needed for input

The following information is needed in order to complete the input forms for the capacity analysis:

1. Repair order (RO) data.

2. Actual labor rates paid by insurers on average after any discounting. You may have to use the posted rates as a rough approximation.

3. Manpower efficiencies for body, paint, mechanical and detail stalls.

4. Annual sales per staff, which includes the estimators.

5. Annual sales per estimator.

6. Annual hours worked by body, paint, mechanical, detail. These are their scheduled hours.

7. Annual hours of operation for the shop. Usually these hours would be the same as the hours worked unless your shop works for more than one shift.

8. Spray booth cycle time in hours.

9. Number of Redo's per year through the spray booth.

10. Area in square meters or feet of the shop. Count all area where the shop processes take place. Don't count parking or other outside areas that are not related to the repair process. Include storage, office and aisle space.

11. The number of body stalls, frame machines, prep stalls, spray booths, cool down stalls, detail stalls and mechanical stalls.

12. The number of body men & helpers, painters & helpers, mechanics, detailers, office staff including estimators.

### How to Use

1. Click on the button to enter the “calculator”.

2. If you have never put in any data then begin entering the following data in areas marked in yellow color.
Repair order data
Labor rate data

3. Press the “calculate” button on the screen and scroll down to see the average repair order calculated. It should agree with your actual average cost/Repair order. If it does not, than there is a problem with the data collected. You may need to take a bigger sample of data. Once the cost/Repair order agrees with your actual value, you can proceed to the next step by clicking on the “next” button on the screen.

The enter the following data in areas marked in yellow color:
Efficiencies
Scheduled hours of work and schedule hours the shop is open by department.
Booth cycle time.
Redo's through the spray booth.
Shop area.

4. Click the “next” button on the screen and input the shop layout and people resources.

5. Finally we are ready to calculate the shop capacity. You should have a estimate about how many cars can be repaired per year. You can estimate this by determining how many cars you can produce in an average week and multiplying by the number of weeks you work each year.

6. Click “next” button.

7. Scroll down to the bottom of the page and click on the “perform capacity analysis” button.

8. The capacity of your shop will be highlighted in red. If the number of cars you estimated is close to the calculated number, you have validated the capacity model. You can now add and subtract parts of the shop to impact the capacity. If you did not get good agreement with your estimated number then you need to recheck the input data particularly in the area that is highlighted in red.

9. Call the telephone number listed here if you need assistance completing this analysis.

### Understanding the Output

1. The stall capacity is not adjusted for staffing density. What this means is that the capacity calculation for stalls assumes one technician per stall. If you begin to add people, make sure you keep at least 1.5 stalls per one technician.

2. The number of staff must always include the estimators. If you add an estimator then you should add a person to staffing as well.

3. You will have to make several additions to your shop in order to significantly affect the capacity.

4. Be careful when adding facilities because that is not always easy to do. If you add a prep stall then you should remove a stall from some place else. To remove stalls put a (−1) in the input box.

5. If you always have a lot of cars in prep stall and can't seem to get them through the spray booth, then the spray booths or the painters would be the bottleneck. If this is not the case then some of the data entered is not accurate.

6. By using this analysis you will make significant strides in your ability to reduce cycle times and increase throughput if you have the right balance of resources.”

Once the customer has selected the tool, customer computer 2, as shown in FIG. 3D, is optionally requested to deposit a payment for the service by entering payment information in a step 138. Once host computer 4 gets confirmation of receipt of the payment made by customer computer 4, typically via interaction with financial transaction computer 20 in a step 139, customer computer 2 is then permitted access to the details of using the selected tools. The communications in steps 138 and 139 are conducted preferably through secured lines to prevent unauthorized access to confidential information generated during these transactions.

Thereafter, host computer 4 in step 140 requests customer computer 2 to enter customer business data required for conducting business analysis for the chosen business tool. The customer can also make use of the aforedescribed instructions provided in FIG. 6A. By way of examples, FIGS. 6BA, 6BB, and 6BC show screen shots of business data previously entered. The screen shots of FIGS. 6DA, 6DB, 6EA. 6EB and 6EC are used to enter the data when it is entered for the first time by customer computer 2. Preferably the fields where customer computer 4 is requested to enter data are provided with a different color, such as yellow, to make it easy for the user to distinguish fields where data are entered from other fields displayed on the screen. Before processing the customer business data entered by customer computer 2, host computer 4 through a query 142 analyzes validity of the customer business data against a preprogrammed paradigm for the chosen business tool.

If the data entered in step 140 is incorrect, host computer through a query 148 requests customer computer 2 to reenter the data through step 140. Alternatively, host computer 4 though a step 148 offers an on-line user contact to explain the business solution. It is contemplated that the on-line help provided in step 148 includes on-line telephone contact, access to frequently asked questions (FAQs) library, or other automated help procedures well known in the art.

If the data entered in step 140 is correct, host computer through a step 144 stores the data entered into the database and then through a step 150 processes the entered data through an algorithmic module for the chosen business tool to carry out a business analysis for the chosen business tool. A software program supplied by Coldfushion® version 3.5 is used to produce the algorithmic module for the chosen business tool. It should be understood that other software programs, which are similar to the Coldfushion® version 3.5 are also well suited for the process of the present invention. Host computer 4 in a step 152 stores the results of the business analysis for future use.

By way of examples, FIGS. 6CA and 6CB show screen shots of the results of the business analysis, which customer computer 2 can print though a step 155. Host computer 4 then displays a business solution through a step 156, which for capacity planner tool 1302 is directed at reducing a bottleneck in the plant capacity by improving the production step or equipment having the least capacity of repairing numbers of vehicles per period. The solution displayed in step 156, also shown in screen shots in red color in FIGS. 6CA and 6CB, preferably includes an on-line contact name and phone number to further assist the customer in understanding the business solution being displayed.

By way of example, step 150 for capacity planner tool 1302 includes the following steps:

calculating a body stall capacity by multiplying number of body stalls in a shop with a quotient of the following formula:

$$\frac{\begin{matrix}Number of body stalls \times \\ hours of operation per period\end{matrix}}{( \frac{Body flag Hours per period}{Body man efficiency } )} ; \qquad ( i )$$

calculating a body man and helper capacity by using the following formula:

$$\frac{\begin{matrix}Number of body men \& helpers \times \\ Scheduled hours per period\end{matrix}}{( \frac{\begin{matrix}Body flag hours per year + \\ Frame flag hours per period\end{matrix}}{body man efficiency} )} \qquad ( ii )$$

calculating a frame stall capacity by using the following formula:

$$\frac{\begin{matrix}Number of frame stalls \times \\ Hours of operation per period\end{matrix}}{( \frac{Frame flag hours per period}{Body man efficiency} )} ; \qquad ( iii )$$

calculating a prep stall capacity by using the following formula:

$$\frac{\begin{matrix}Number of prep stalls \times \\ Hours of operation per period\end{matrix}}{( \frac{\begin{matrix}Paint flag hours per period - \\ spray booth cycle time\end{matrix} }{painter efficiency} )} \qquad ( iv )$$

calculating a spray booth capacity by subtracting number of redos per period from a quotient of the following formula:

$$\frac{\begin{matrix}Number of booths \times \\ Hours of operation per period\end{matrix}}{Booth cycle time} \qquad ( v )$$

calculating a cool down capacity by subtracting number of redos per period from a quotient of the following formula:

$$\frac{\begin{matrix}Number of cool down stalls \times \\ Hours plant stays open for business per period\end{matrix}}{Booth cycle time} . \qquad ( vi )$$

calculating a painter & helper capacity by using the following formula:

$$\frac{\begin{matrix}Number of painters \& helpers \times \\ Clock hours per period\end{matrix}}{( \frac{Paint flag hours per period}{Painter efficiency} )} \qquad ( vii )$$

calculating a mechanical stall capacity by using the following formula:

$$\frac{\begin{matrix}Number of mechanical stalls \times \\ Clock hours per period\end{matrix}}{( \frac{Mechanical flag hours per period}{Mechanic efficiency} )} \qquad ( viii )$$

calculating an auto-mechanic capacity by using the following formula:

$$\frac{\begin{matrix}Number of auto \text{-} mechanics \times \\ Scheduled hours per period\end{matrix}}{( \frac{Mechanical flag hours per period}{ Auto \text{-} mechanic efficiency} )} ; \qquad ( ix )$$

calculating a detail stall capacity by using the following formula:

$$\frac{\begin{matrix}Number of detail stalls \times \\ Hours plant stays open for business per period\end{matrix}}{( \frac{Detail flag hours per year}{Detail efficiency} )} ; \qquad ( x )$$

calculating a detailer capacity by using the following formula:

$$\frac{\begin{matrix}Number of detailers \times \\ Clock hours per period\end{matrix}}{( \frac{Detailer flag hours per period}{Detailer efficiency} )} \qquad ( xi )$$

calculating an estimator capacity by using the following formula:

$$\frac{\begin{matrix}Numbers of estimators \times \\ Cost estimates prepared per year\end{matrix}}{Average cost per repair} ; \qquad ( xii )$$

calculating an office staff capacity by using the following formula:

$$\frac{\begin{matrix}Office staff members \times \\ Revenue generated per period per office staff member\end{matrix}}{Average cost per repair} ; and \qquad ( xii )$$

selecting least capacity from said body stall, body man & helper, frame stall, prep stall, spray booth, cool down, painter & helper, mechanic, detail stall, detailer, estimator and total office staff capacities. The least capacity shows up in a different color, such as red, in FIG. 6CA to show the customer, which part of the business process has the least capacity that results in the bottleneck. The period selected in the foregoing steps is up to the customer's requirement. Thus, it can range from an hour, an eight-hour shift, a day, a week, a month to a year.

As shown in FIG. 3E, host computer 4 through an optional query 160 requests customer computer 2 to make comments if any, which host computer 4 in a step 162 stores in the database. After query 160 or after step 162, host computer 4 through an optional query 166 and a step 168 returns the customer computer 2 back to main menu 129 to allow customer computer 2 to choose another business tool listed in menu 129.

Menu 129 lists several business tools. Process steps similar to those stated above are generally followed in using other business tools, except for data entry and validity in steps 140, 142, 146, 148 and 144; business analysis performed and data stored in steps 150 and 152; business results displayed in step 154; and business solution offered in step 156. The process steps and software utilized for performing the business analysis would obviously be different for different business tools.

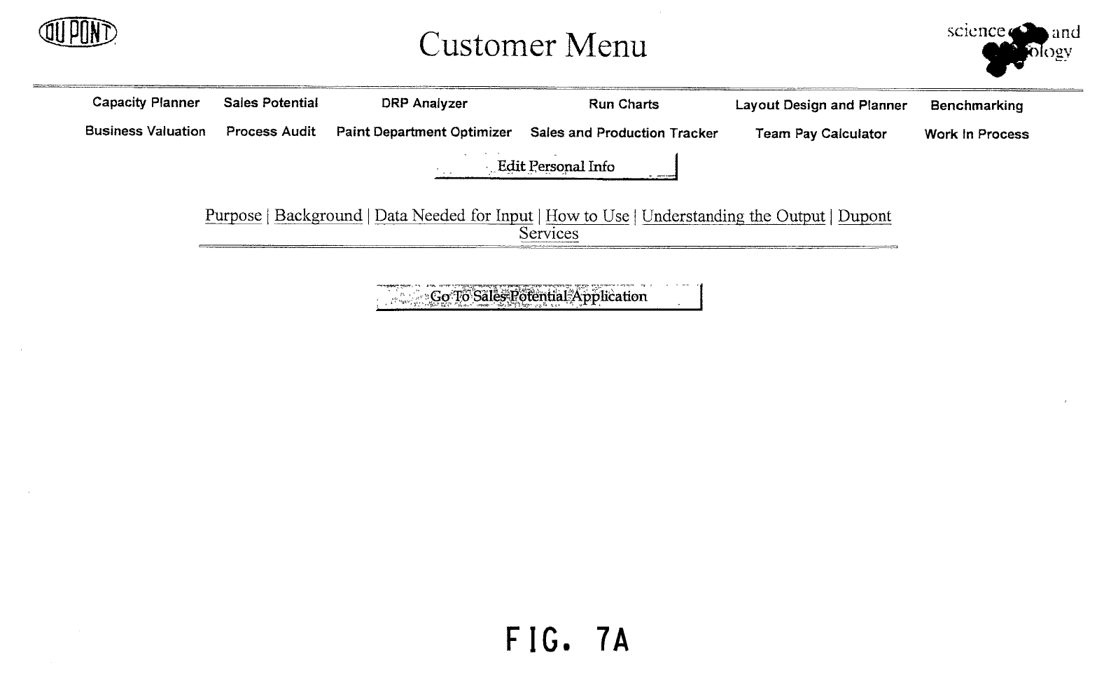

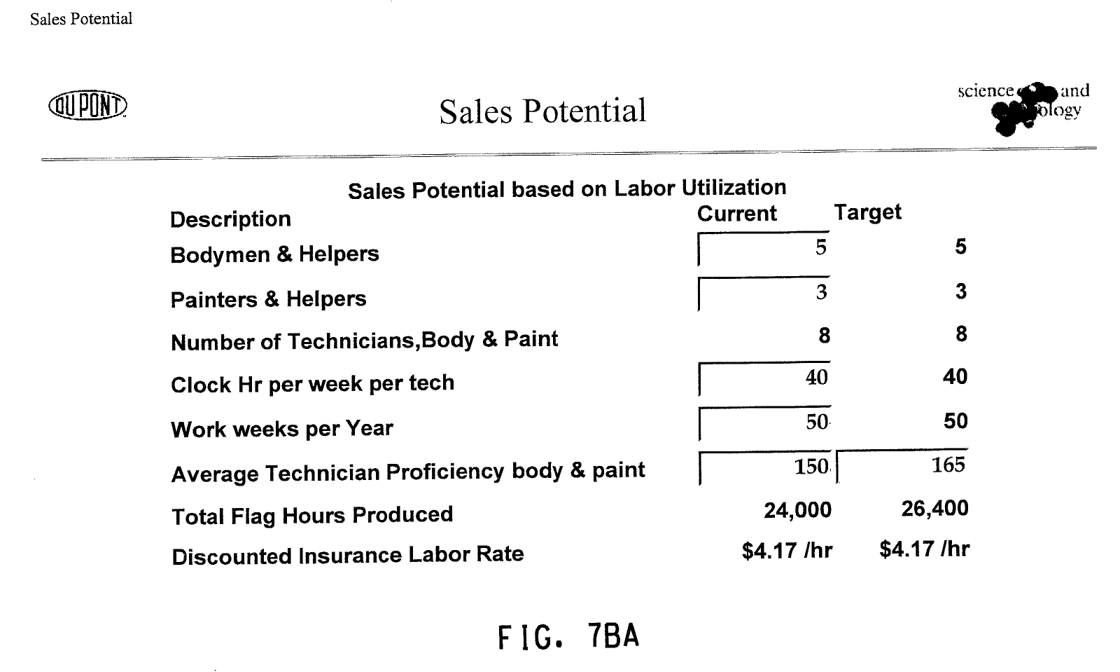

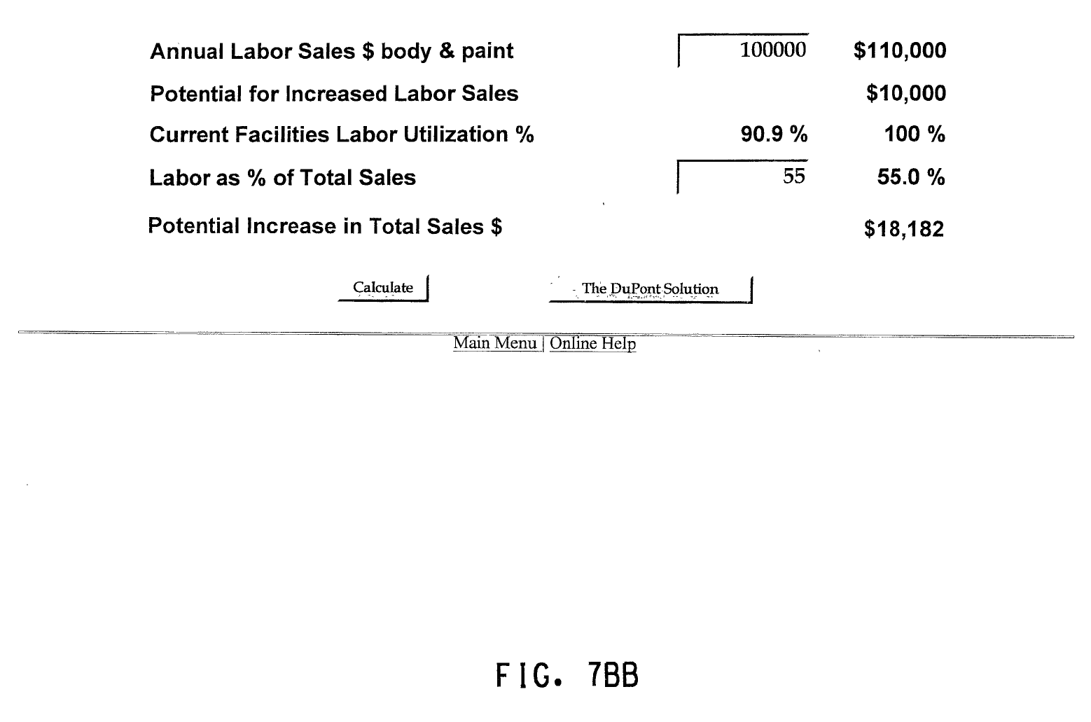

If customer computer 2 in step 132 selects a sales potential business tool 1304 from menu 129, host computer 4 through step 134 then directs customer computer 2 to tool 1304. FIG. 7A shows screen shot of sales potential business tool 1304 and provide instructions for using the chosen business tool.

The following instructions are provided in FIG. 7A for sales potential business tool 1304 when used for analyzing maximum sales potential of an auto repair and paint shop:

### “Purpose

The sales potential calculator lets you determine the maximum sales your crew can produce.

### Background

Each technician in your shop can produce a given amount of flag hours. The number of flag hours a technician can produce is dependent on many factors including:

1. How complete the estimate is?

2. How skilled the technicians are?

3. How efficient your management systems are?

4. How prompt and competent your suppliers are?

5. How productive are the paints your shop uses, and finally

6. Do you have enough customers arriving at the door to keep your shop busy?

To use the sales potential calculator tool you need to set a manpower efficiency target. The manpower efficiency is calculated by adding up the total flag hours for the shop and dividing by the total clock hours that all your technicians were available to work on those jobs during a specified period of time such as a month or a year. A reasonably acceptable manpower efficiency number to use is 165 as that is an acceptable target to aim for based on industry benchmarks. Facility labor utilization is just the % of the target labor potential that you are currently using.

### Data Needed for Input

The following information can be used to complete the input forms for the Sales Potential analysis:

1. The number of body and paint technicians, including helpers.

2. Total flag hours per week, and the total number of flag weeks per year.

3. Technician efficiency calculated by dividing flag hours by actual hours per time period, such as a year, and then multiplying the number by 100.

4. Average percentage technician efficiency calculated by averaging the technician efficiency over the technicians working in the shop.

5. The target for the average percentage technician efficiency you want to reach, is typically in the range of 165 to 200.

6. Annual labor sales.

7. Labor sales as a percent of total sales, which preferably ranges from 40% and 60%.

### How to Use

1. Input the data on the information shown in the preceding paragraph.

2. Click on the “calculate” button.

### Understanding the Output

The potential percentage increase in total sales represents the additional sales you could be getting if your technicians' efficiency was equal to the target. To achieve the projected sales you just determined from the sales potential calculator, you need to improve in the 6 factors described in the background section.”

Step 150 for sales potential business tool 1304 includes the following steps:

calculating total flag hours produced per year by using the following formula:

(Weeks per year)×(Hours per week per technician)×(Average technician efficiency)×(Number of technicians) (xiii)

wherein said technician comprise said body man & helper and said painter & helper;

calculating a discounted labor insurance rate by using the following formula:

$$\frac{Annual labor sales}{The total flag hours produced per year} ; \qquad ( xiv )$$

calculating target labor sales per year by using the following formula:

(The target flag hours per year)×(The discounted insurance labor rate) (xv);

calculating a potential increase in labor sales by subtracting actual labor sales per year from the target labor sales per year; and

calculating a potential increase in total sales per year by using the following formula:

$$\frac{Potential increase in labors sales}{Labor as a percetage of total sale} . \qquad ( xvi )$$

Screen shots in FIGS. 7BA and 7BB show the data entered in using business tool 1304. The business solution for sales potential business tool 1304 in step 156 includes the potential increase in labor sales and the potential increase in total sales.

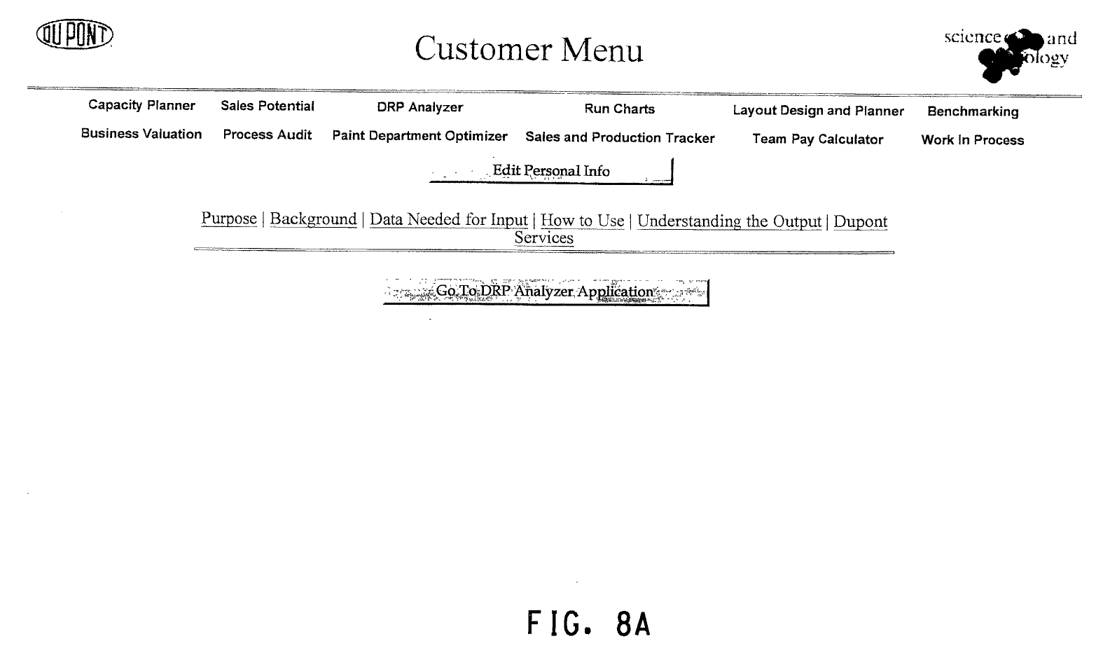

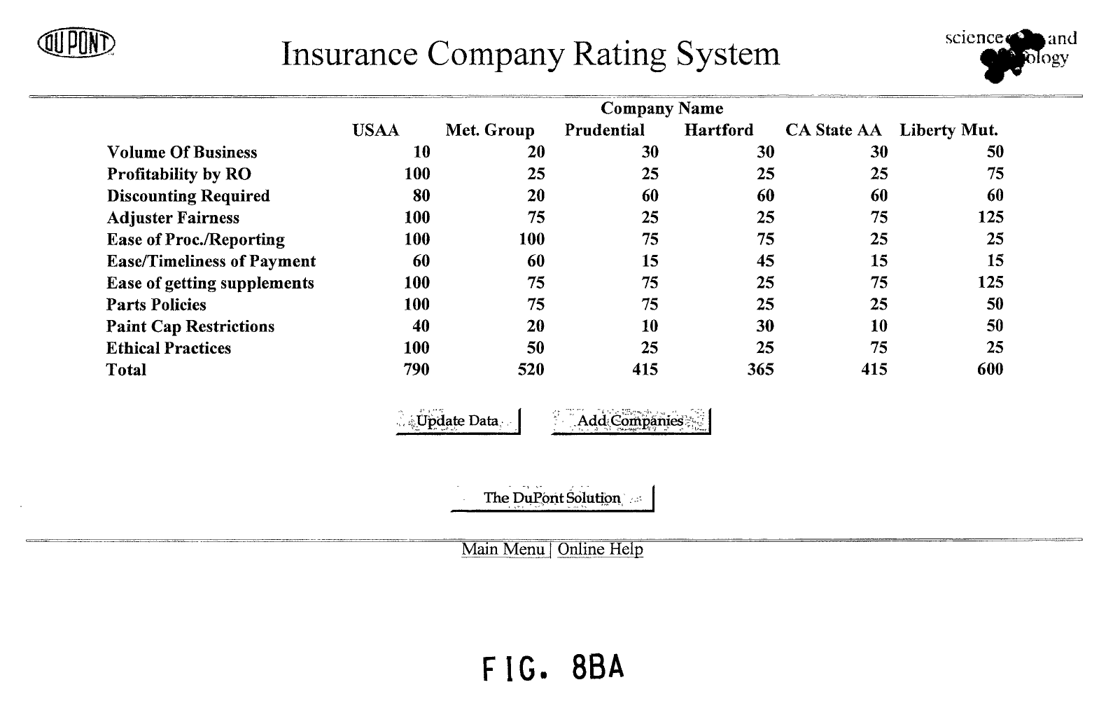

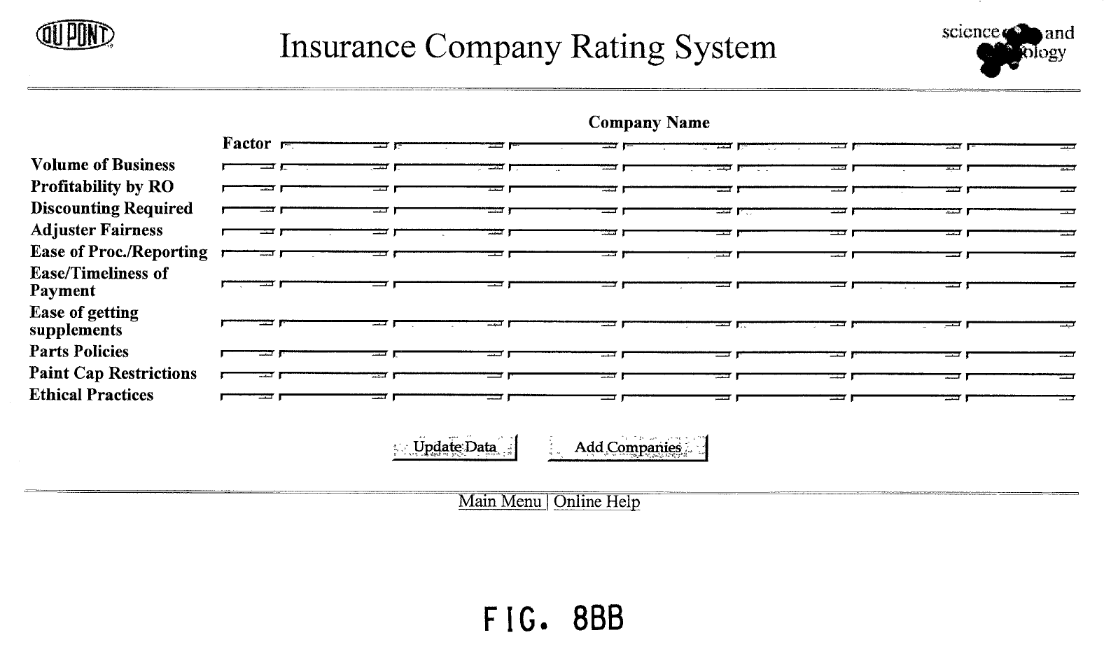

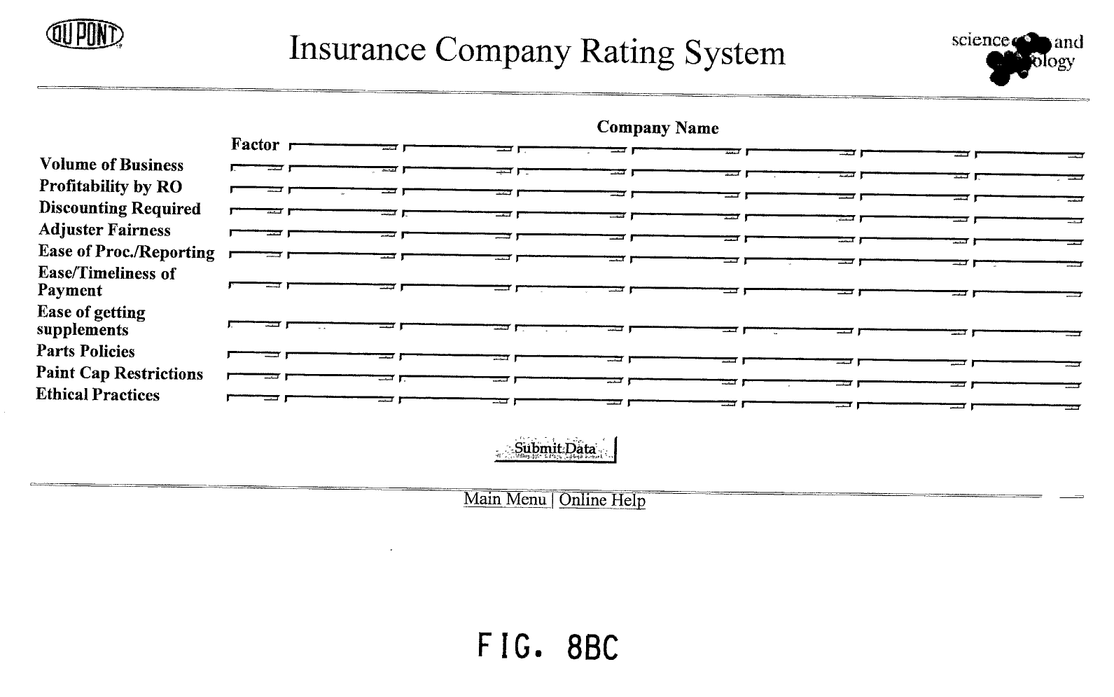

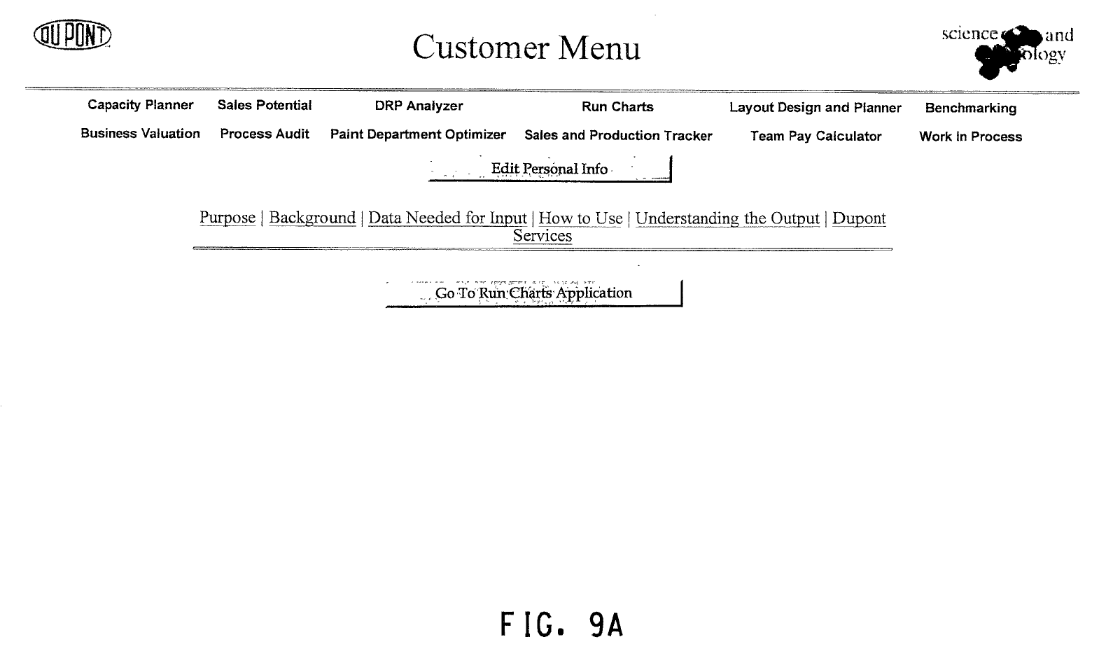

If customer computer 2 in step 132 selects a direct repair program (DRP) analyzer business tool 1306 from menu 129, host computer 4 through step 134 then directs customer computer 2 to tool 1306. FIG. 8A shows screen shots of DRP analyzer business tool 1306 and provides instructions for using the chosen business tool.

The following instructions are provided in FIG. 8A for DRP analyzer business tool 1306 when used to rate a supplier of goods, services, or financial services, such as an insurance company, who take part in DRPs. DRP is used to reimburse car repair shops for repair services performed to repair vehicle damage or collision.

### “Purpose

The insurance company rating system is used to allow you to determine which DRPs you would prefer to work with and what actions you should take to market your shop towards those DRPs.

### Background

The reimbursements made by insurance companies and adjusters vary from company to company, by location and by the degree of relationships you develop with the adjuster. Thus, based on your personal knowledge, you know which companies you prefer to work with. DRP analyzer business tool is a way for you to quantify and identify your preferred supplier.

### Data Needed for Input

To use this system you need to be familiar with all the insurance companies your are doing work for.

### How to Use

Rate each of the following characteristics for insurance companies from 1 to 5, with 5 being the most important to you. If volume of business is the most important factor, then assign it a rating of 5 in the factor column. Select the company you want to evaluate from the drop down box. For each of the categories, rate the company as follows:
Excellent—25 points
Good—20 points
Fair—15 points
Poor—10 points
Very Poor—5 points

Repeat steps 2 and 3 for each company you want to evaluate. Click on the “submit data” button to complete the analysis. If at some later date you want to add another company to the analysis you can select the “add companies” button and then repeat steps 1 to 5.

### Understanding the Output

The higher the rating, the more business you would like to do with that company. However, you should evaluate the results for reasonableness. If the numbers don't agree with reality then you should modify some of your ratings. Once you have determined which companies are the best to work with you can then establish a plan to get more business from the ones you like and negotiate more with the ones you don't care to do business with in the future.”

Step 150 for DRP analyzer business tool 1306 includes assigning a rating to suppliers on one or more factors selected from the group below:
1. Volume of business activity,
2. Profitability
3. Discounting, if required,
4. Fairness of supplier adjuster,
5. Ease of processing and reporting requirements,
6. Ease and timeliness of payment,
7. Ease of getting supplemental payments,
8. Policy regarding part reimbursement,
9. Policy regarding paint reimbursement, and
10. Policy regarding ethical practices.

A scale for rating the above factors varies from 1 to 5. The supplier can be an auto insurance company, a paint supplier company, part supplier company, or a service company.

The business solution for DRP analyzer business tool 1306 in step 156 includes:

adding the assigned rating for each factor for each supplier to arrive at an aggregated total for each supplier,

tabulating the aggregated totals for the suppliers, and

rating the suppliers on the basis of the aggregated totals for the suppliers, wherein those suppliers having higher aggregated totals are rated higher than those having lower aggregated totals.

FIG. 8BA shows the screen shot of the results obtained when using DRP analyzer business tool 1306. FIG. 8BB shows the screen shot of the screen shot used to update ratings of existing suppliers and FIG. 8BC shows the screen shot used to add additional suppliers to the data.

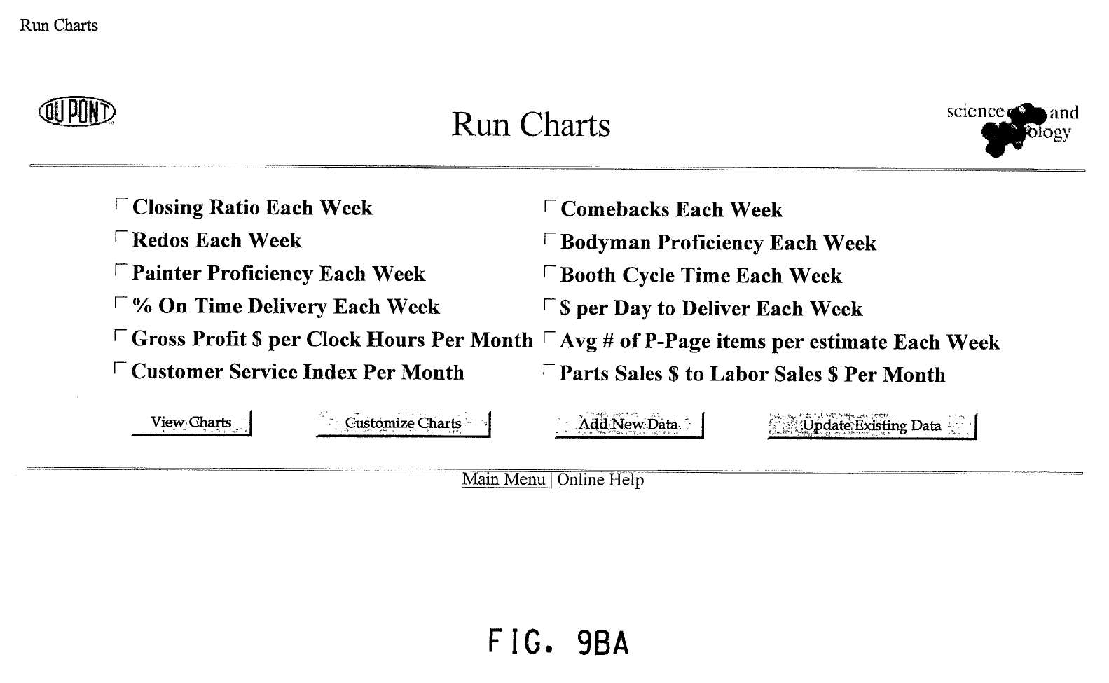

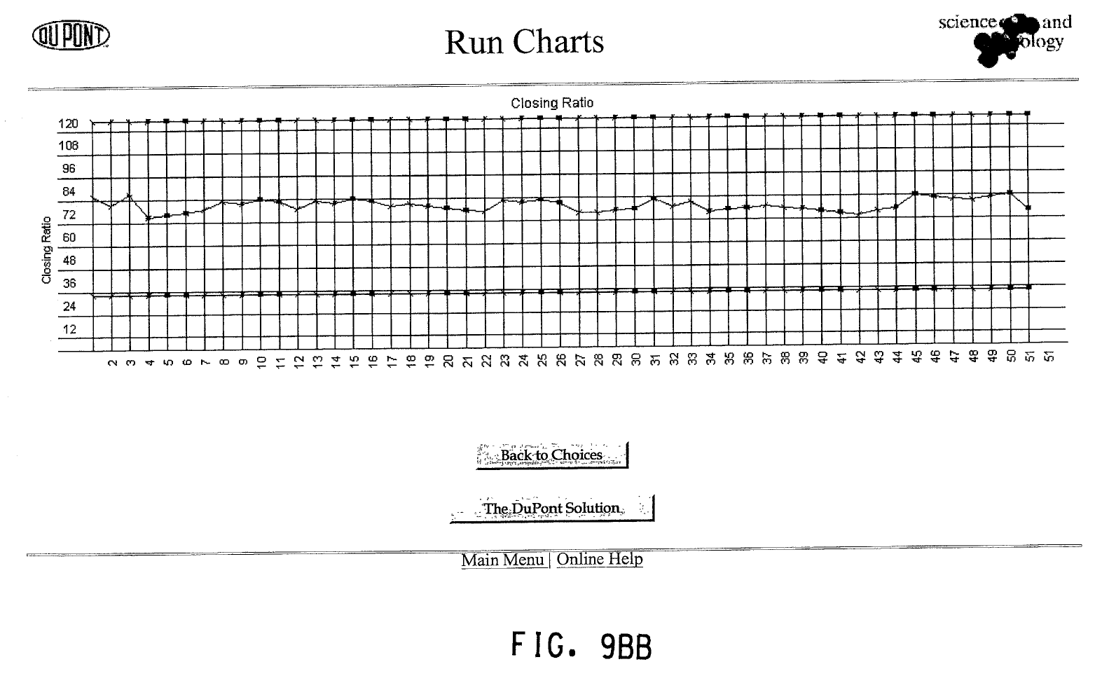

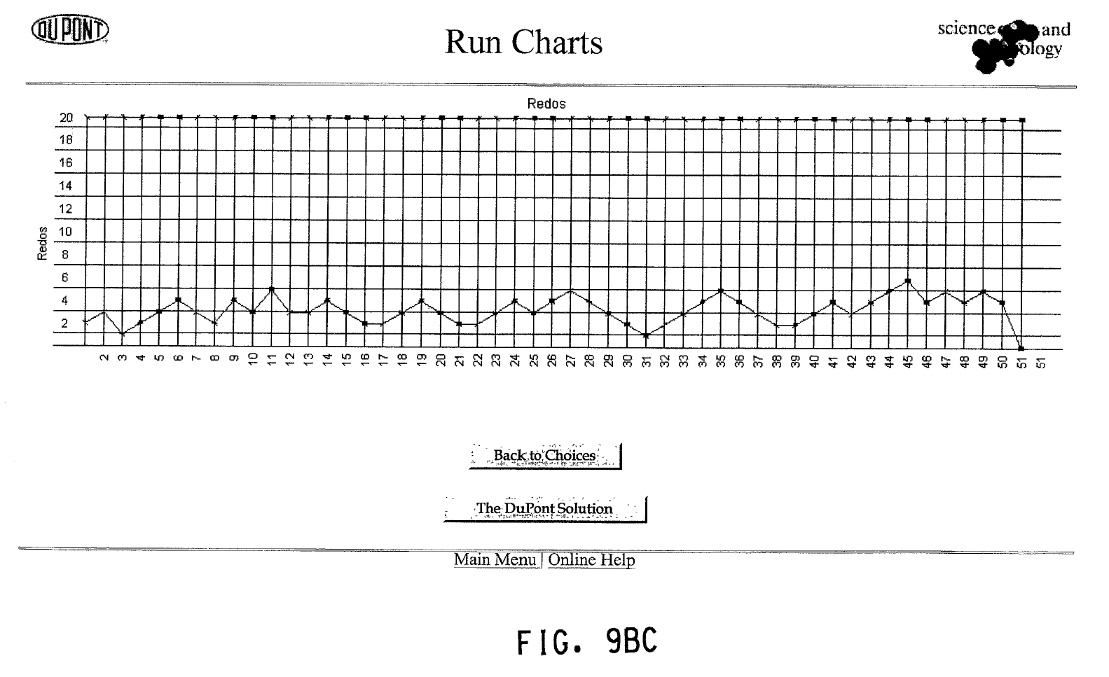

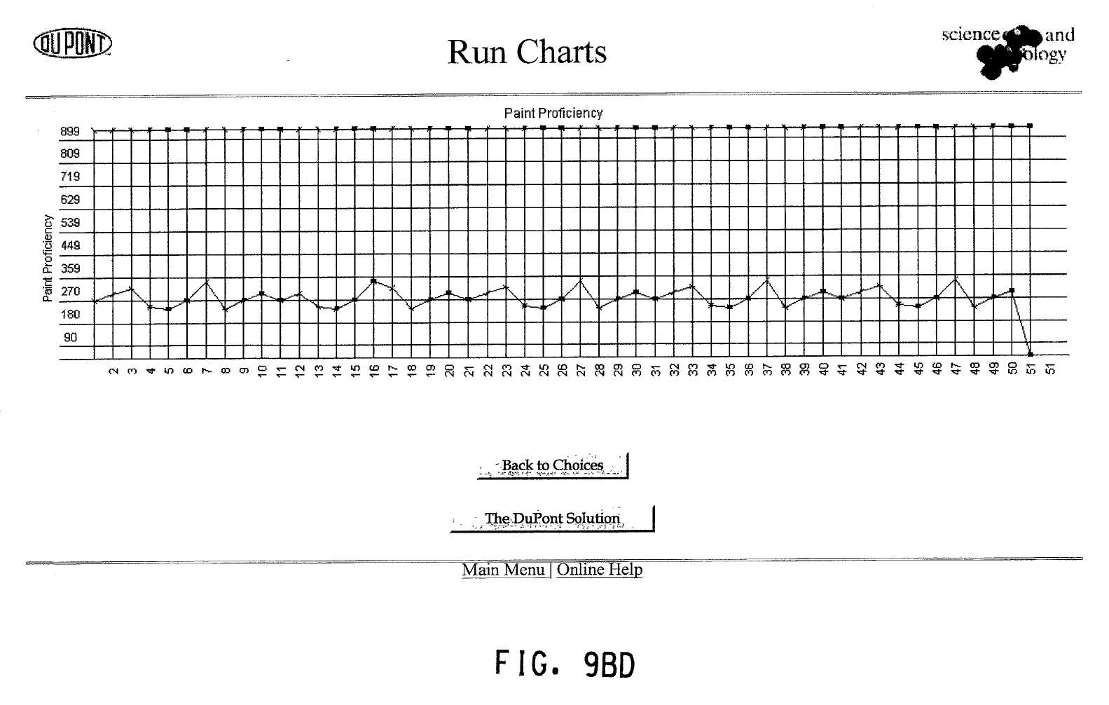

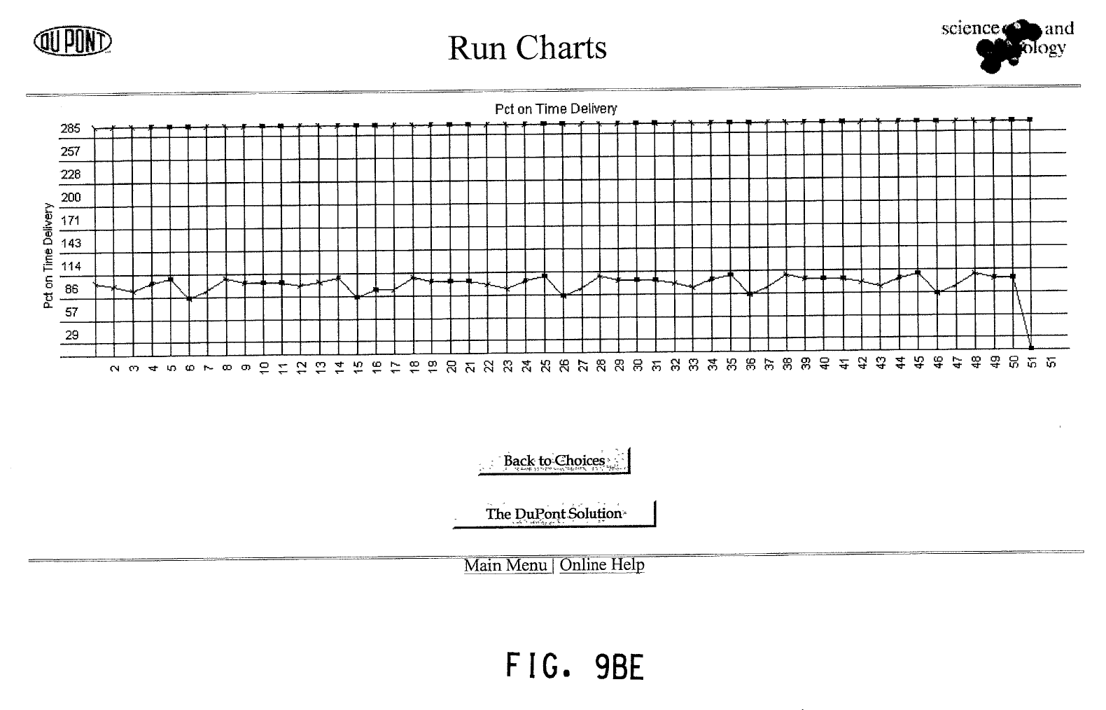

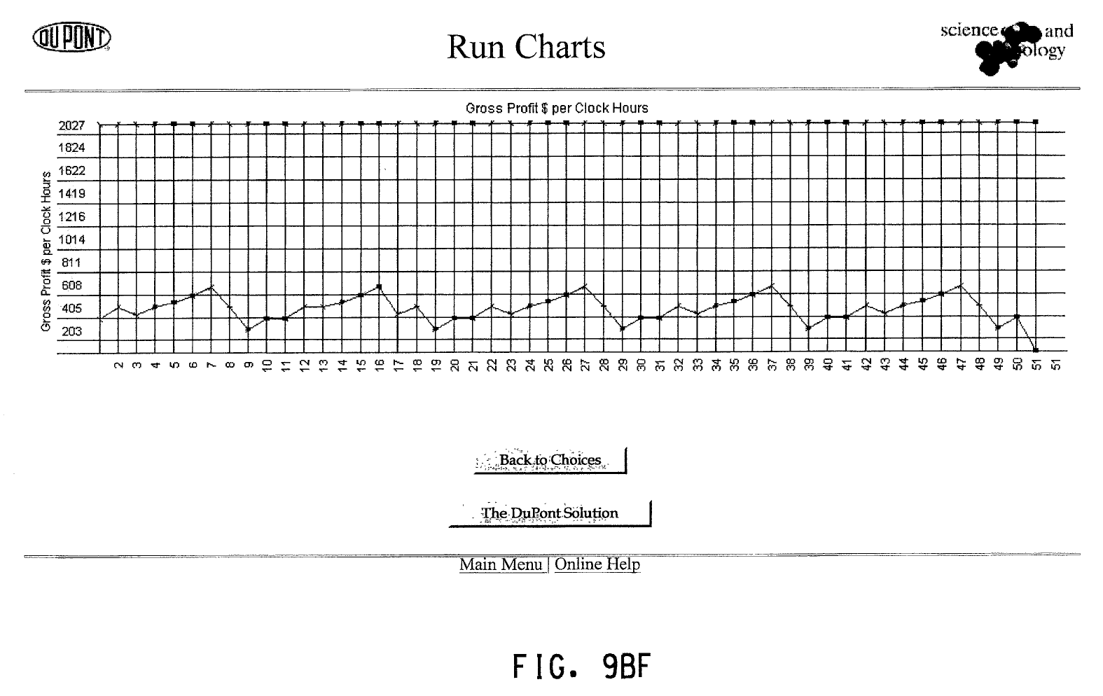

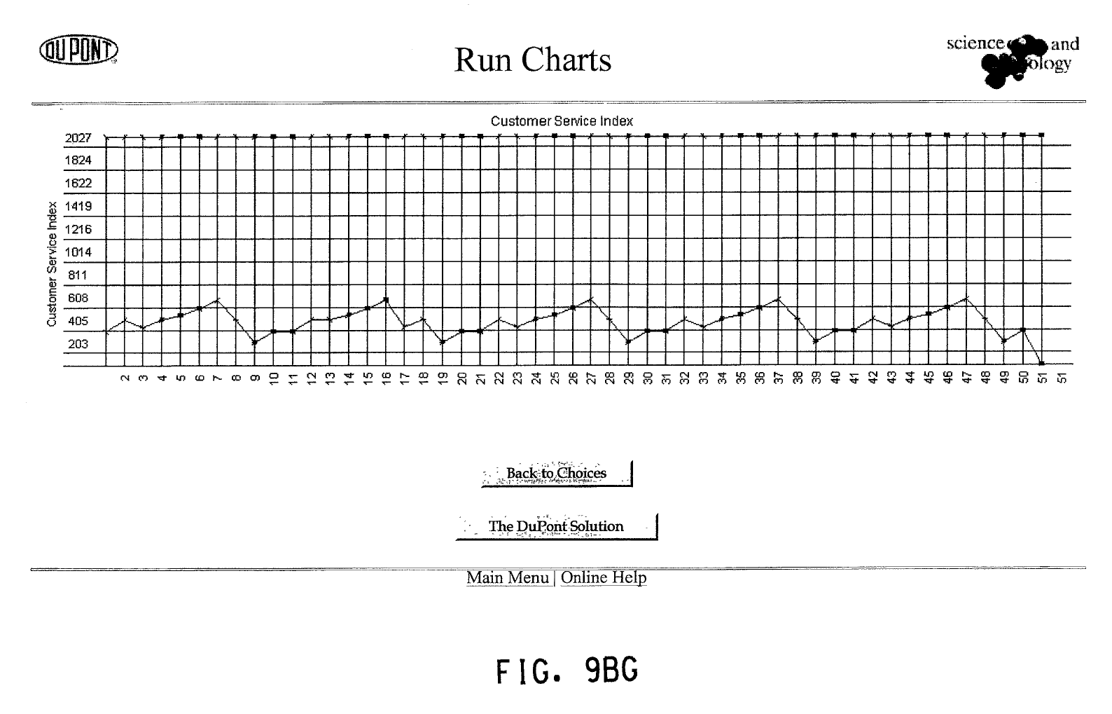

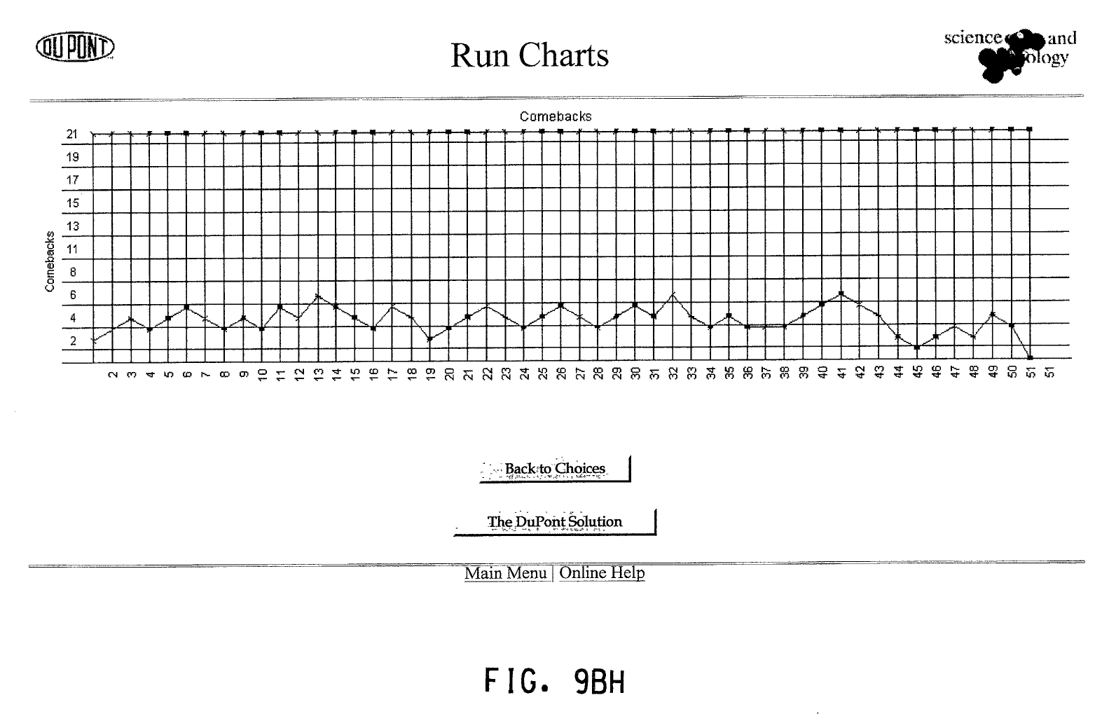

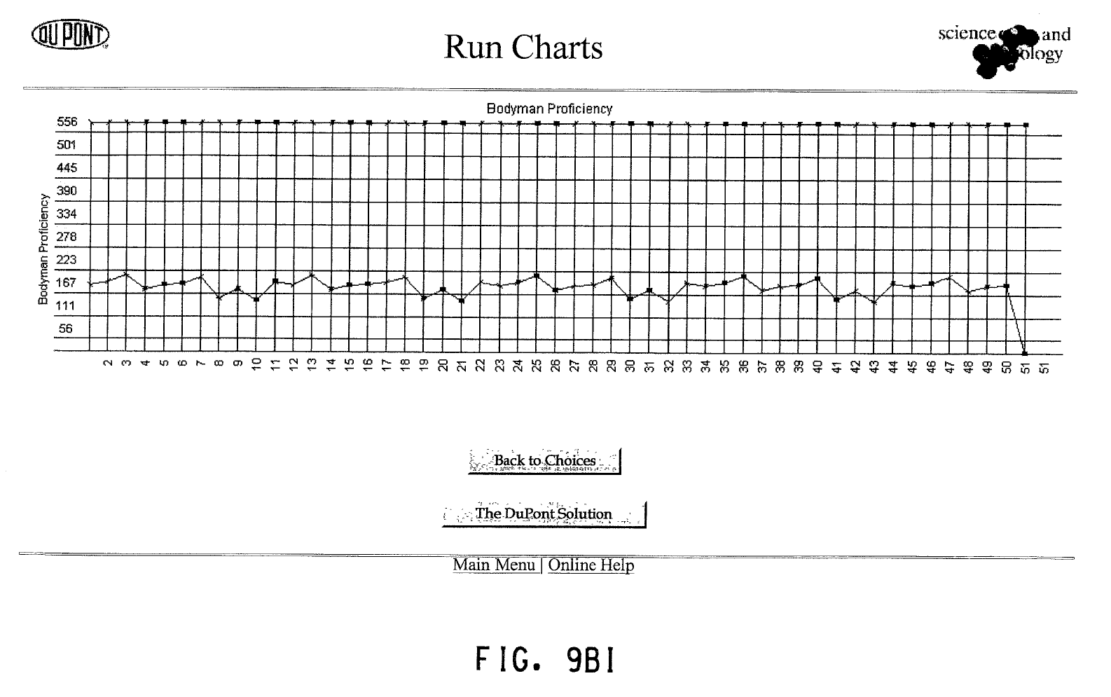

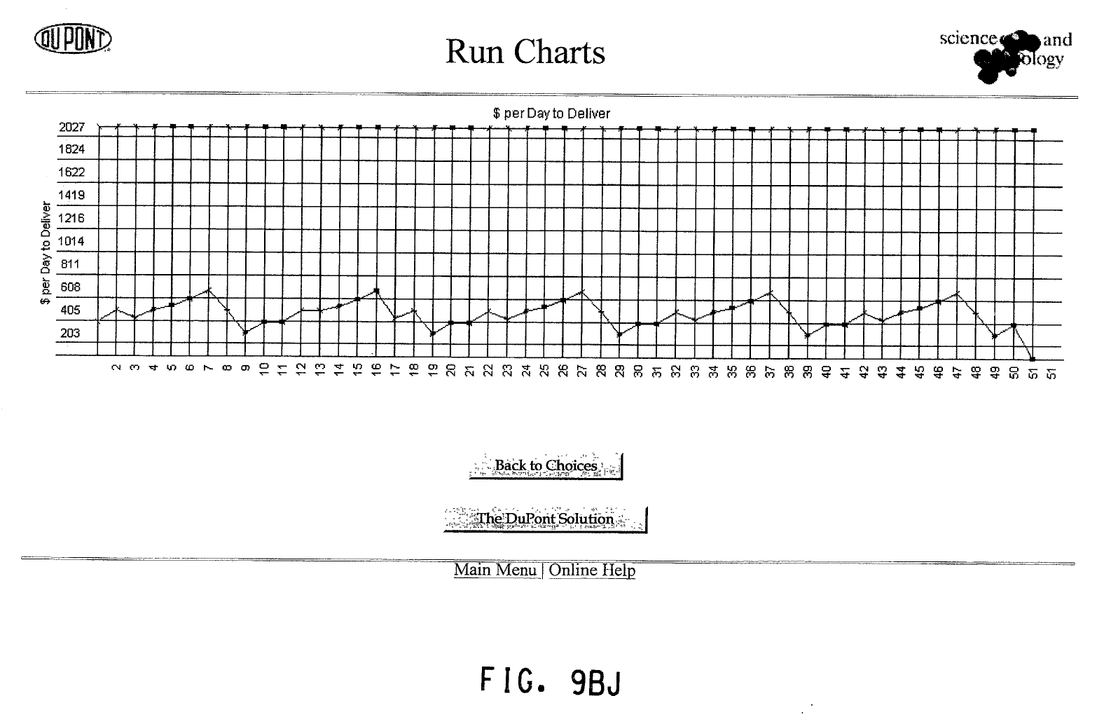

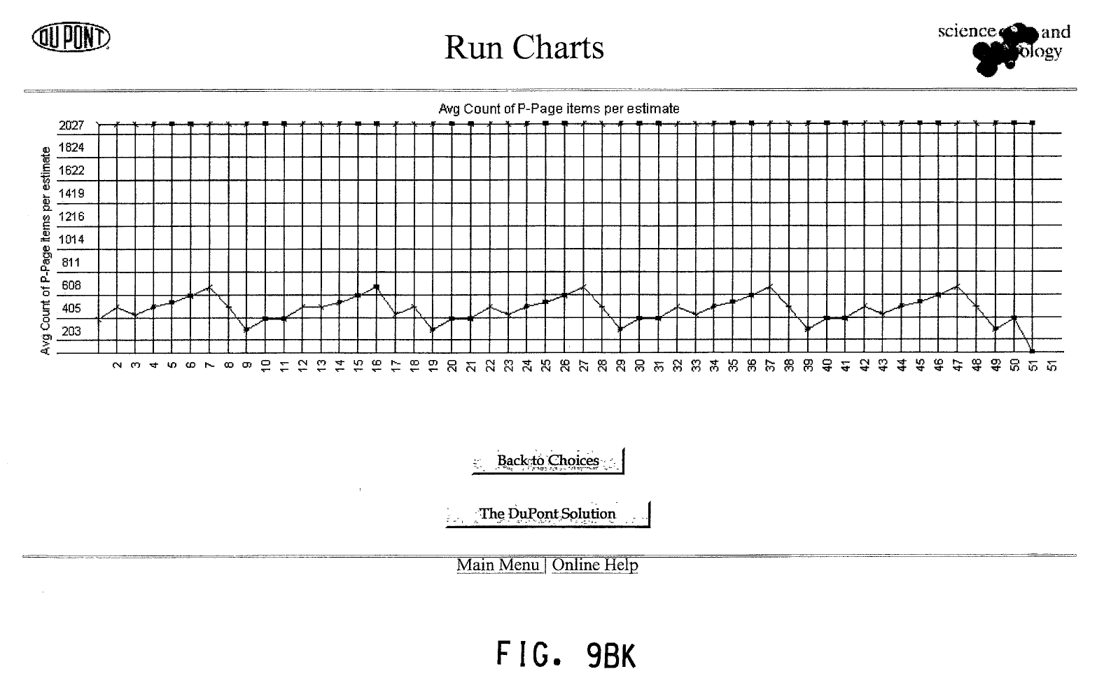

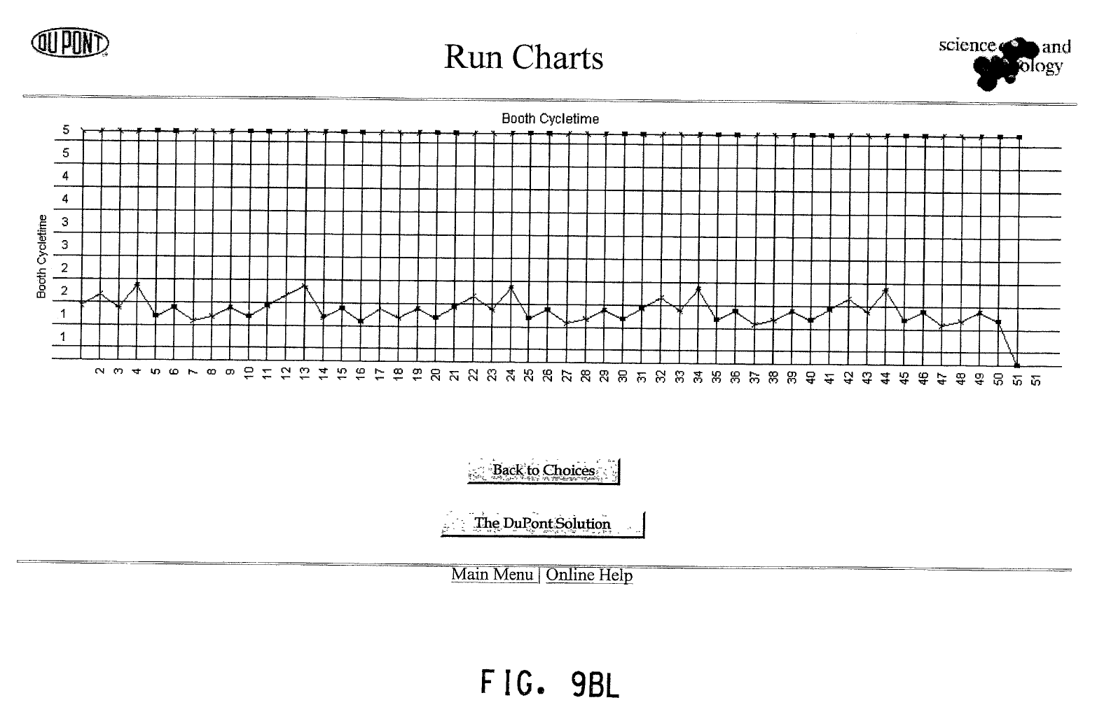

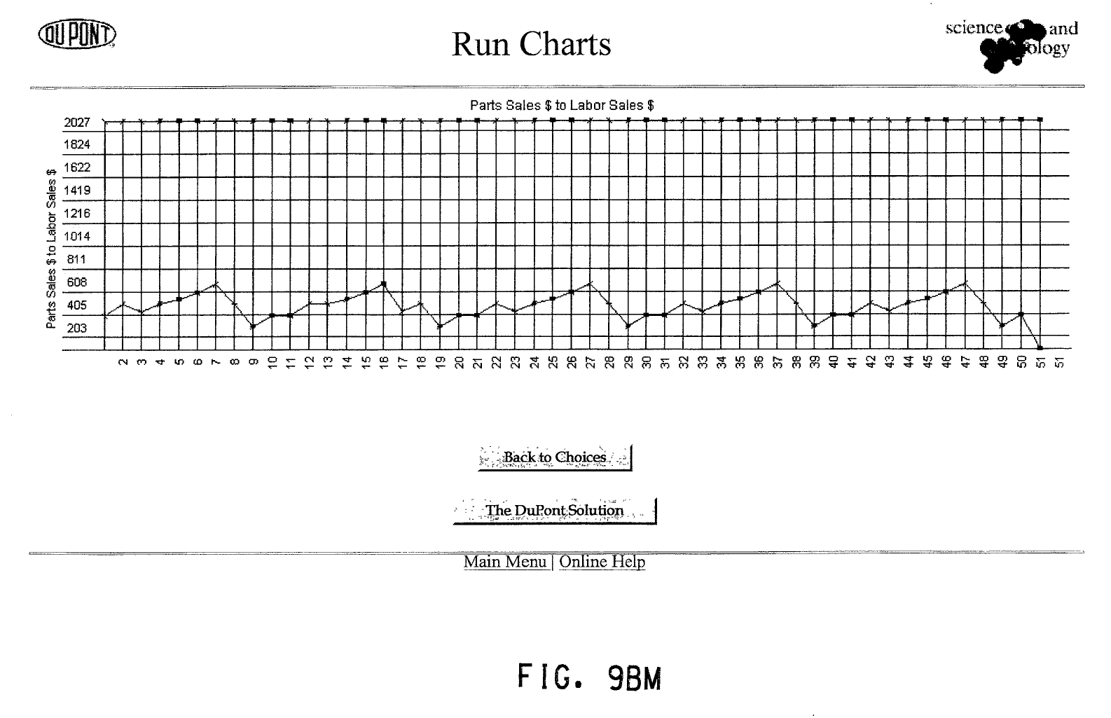

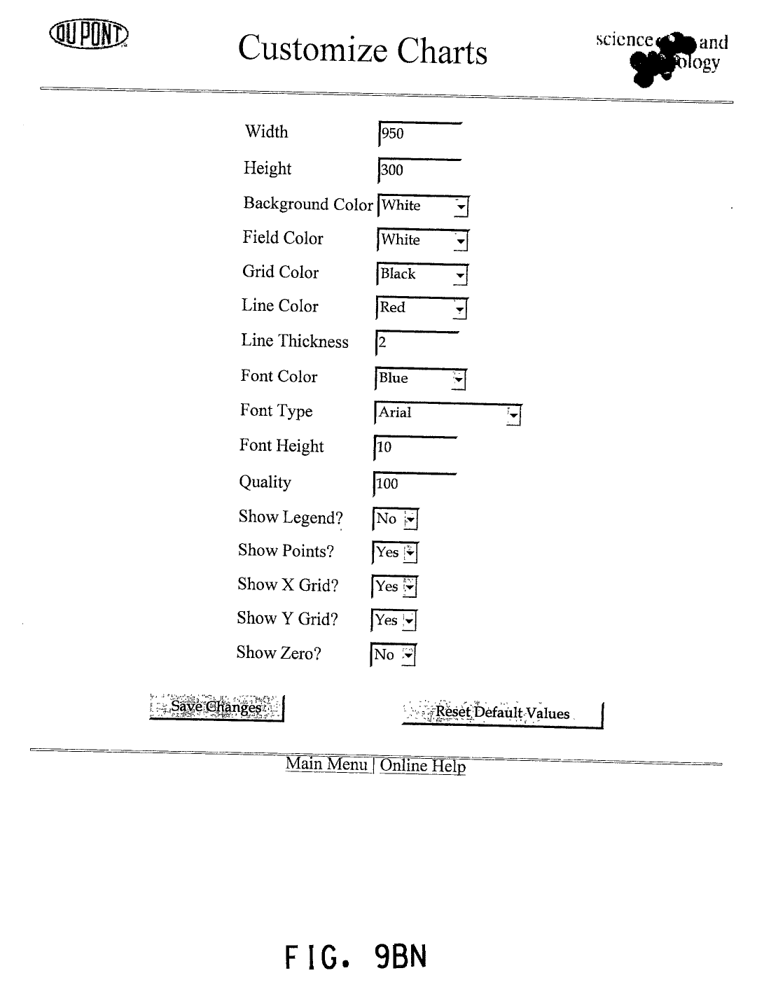

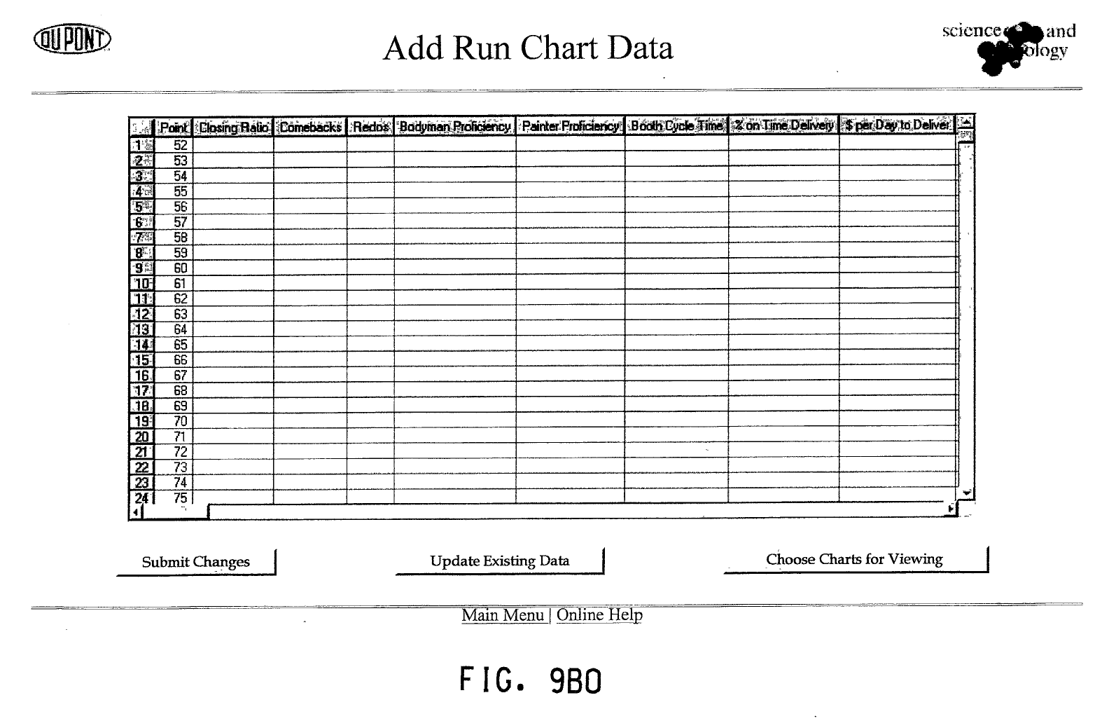

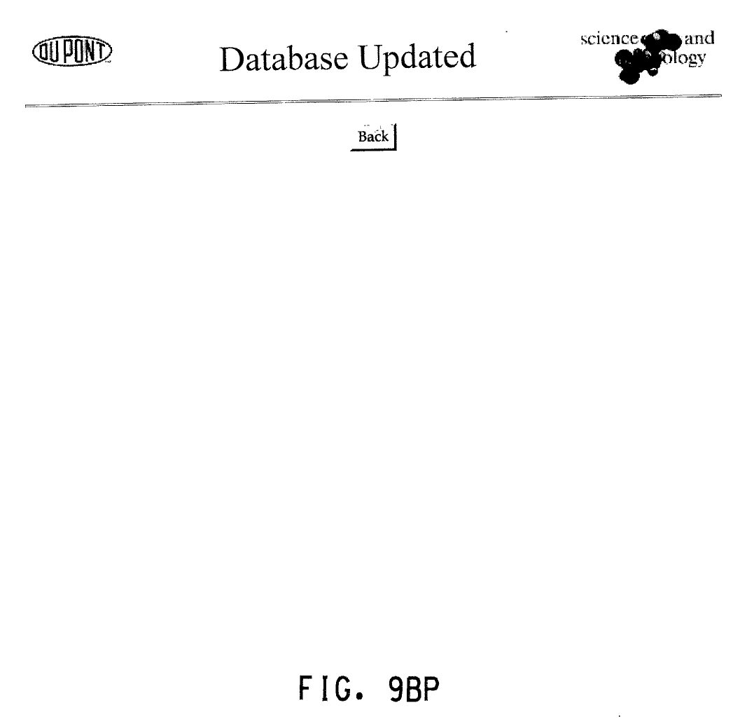

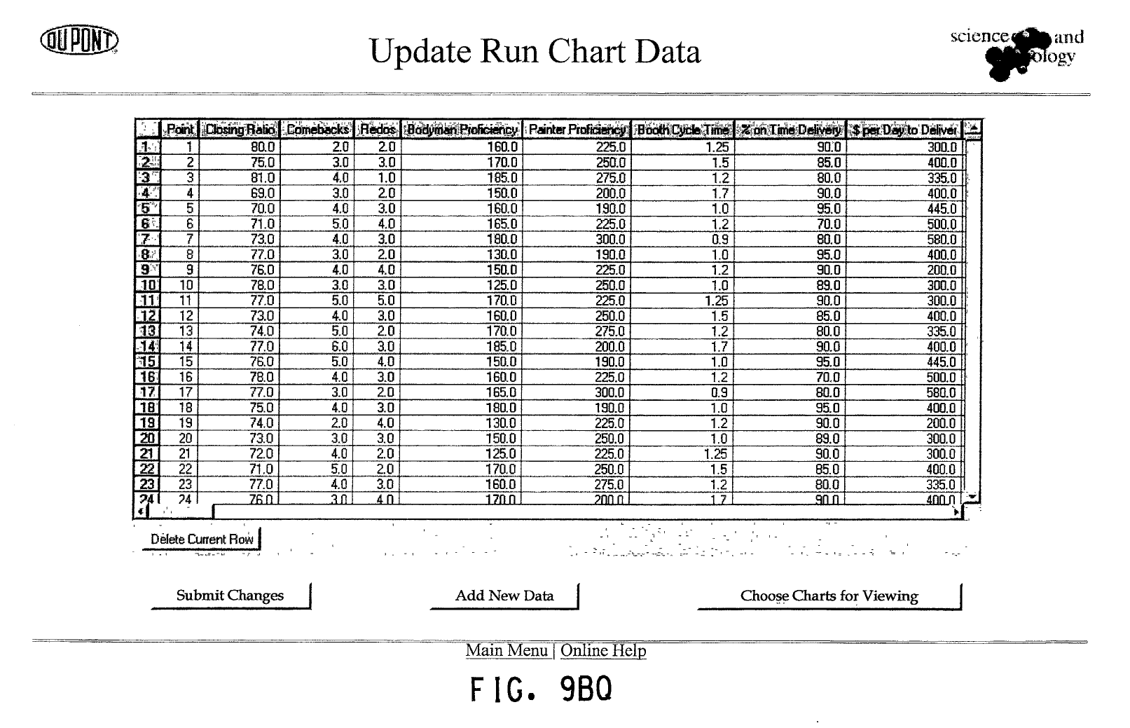

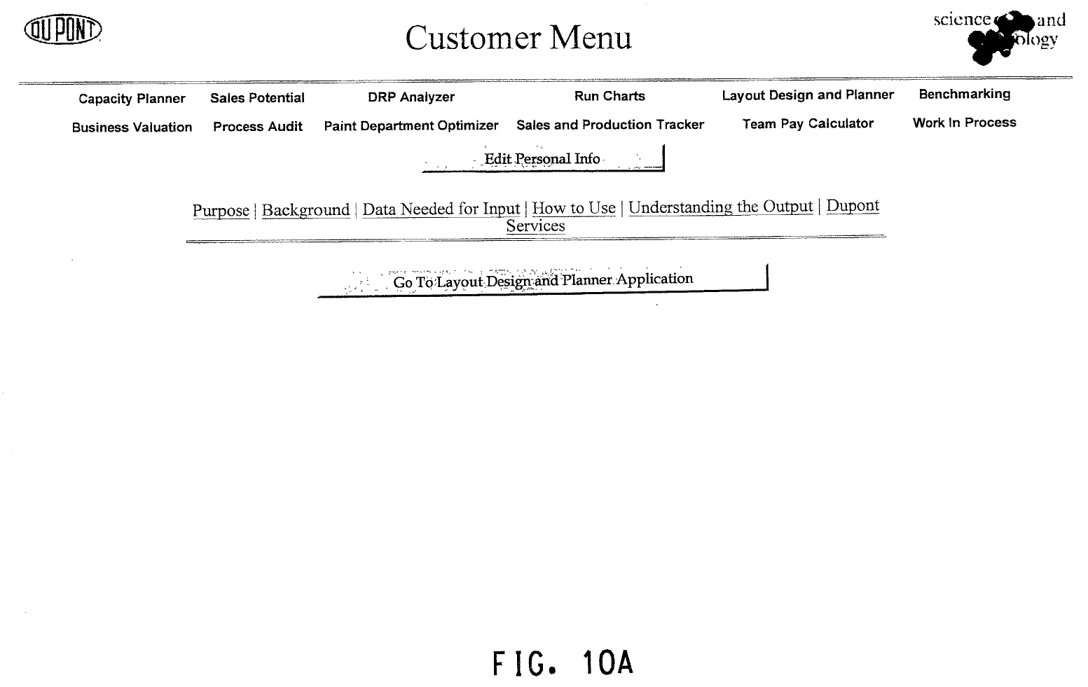

If customer computer 2 in step 132 selects a run charts business tool 1308 from menu 129, host computer 4 through step 134 then directs customer computer 2 to tool 1308. FIG. 9A shows screen shots of run charts business tool 1308 and provide instructions for using the chosen business tool.

The following instructions are provided in FIG. 9A for run charts business tool 1308, which is used to track key process variables that can impact the profitability of business.

### “Purpose

The run chart business tool is set up to allow you to track key process measures that impact the profitability of your business. The operable word is “Process” vs. “Financial”.

### Background

The financial measure of your business is the ultimate score card used to determine how successful you are in running your business. These measurements are typically made on a monthly basis and provide a historical perspective of how the process performed. The run chart business tool is focussed on process measures that you look at frequently, daily or on a car-by-car basis. Tracking the key process measurements that impact the final financial results will allow you to prevent financial disasters from occurring or to put in place corrective actions at or before the onset of the problem to mitigate its impact.

### Data Needed for Input

A log needs to be kept for each process measurement you want to graph. Note the proper units used to enter the data.
Closing ratio per week
Number of comebacks per week
Number of redos per week
Bodyman percent efficiency per week
Painter percent efficiency per week
Booth cycle time-hour/car per week
Percent on-time delivery per week
Cost per day to deliver each car
Gross profit/Technician clock Hour per month
Average # of P-Page items per estimate per week
Customer Service Index (CSI) per month
Parts sales cost/Labor sales cost per month

### How to Use

Check off the variables you want to track.

Select “add new data” if you want to enter a new data or select “update existing data” if you want to modify the data you had already entered.

Once the data is submitted you can then view the run charts.

### Understanding the Output

The value of charting these process measures lies in allowing you to appreciate current and future trends in the data. One trend chart is worth a thousand tables.

The following is a description of the key process measures and why they are important to your business:

Closing Ratio—This is the percentage of jobs that come into the shop that are actually sold. It should not include DRP's since no selling is required.

Comebacks—Number of jobs per week that a client took home and had to bring back for some corrective action. This is critical to your business because it represents external failure. The customer could complain to many of his friends about the problem he had with your shop. As a result, your future business could suffer

Redo's—Number of jobs per week that had you had to redo the work a second or third time to get it correct. This is an internal failure and is very expensive but not as expensive as an external failure.

Body & Paint efficiencies—The number of flag hours divided by the number of clock hours. This ratio represents the ability of your people to produce the revenue for your business to survive. The following issues typically impact these values:
How complete is the estimate?
How skilled are the technicians?
How efficient are your management systems?
How prompt and competent are your suppliers?
How productive are the paint products you use?
Finally, do you have enough customers arriving at the door to keep you busy?

Percent on time delivery—The percentage of cars delivered on the day you promised. Every missed delivery is an external failure with all the consequences it represents.

Cost per day to deliver—The average daily sales divided by the average number of days it took to deliver those cars. For example, if you deliver $20,000 on a day representing 10 cars and each car took 4 days to complete then your dollars per day to deliver would be $20000/(10×4)=$500. This measure is an indication of the shop productivity.

Gross profit per technician clock hour—This is a measure of the ability of the shop to generate profit from the labor force. Use this measure to determine if other changes are impacting the profitability of the shop. For example, if you use a replace strategy for parts versus a repair strategy your gross profit per car would go down but you gross profit per hour would go up because it takes less time and skill to replace than it does to repair.

Average number of P-Page items per estimate—This unique measure is critical to helping your estimators focus on including all the add-on's allowed by the insurance company. These P-page estimates can be obtained, for example, from Mitchell International, San Diego, Calif. It could add several hundred dollars to each estimate. You must, of course, perform the work if you included these add-ons in your estimate.

Customer satisfaction index (CSI)—This is a measure of how well your shop is meeting the customers' expectations. There are many factors, which impact this value such as:
Salesmanship
Communications
Shop capacity
Process monitoring
Backlog
Customer expectations
Repair quality
Ratio of parts sales cost to labor sales cost—This ratio is correlated with the gross profit per technician clock hour. The more parts you sell per job, the higher will be the gross profit per clock hour”

Step 150 for run charts business tool 1308 includes the following steps:

entering into a database per period one or more process measurements to produce run charts for said process measurements. The run charts process measurement tools provides a running track of how a process variable varies over a measurement period, which can be for a day, a week, a month or a year. Typically the period is for a month. Typical process measurements made in run charts business tool 1308 include one or more of the following:
1. Percentage closing ratio,
2. Percentage of returns,
3. Percentage of redos,
4. Body man percent efficiency,
5. Painter percent efficiency,
6. Booth cycle time,
7. Percentage of on-time delivery.

The business solution for run charts business tool 1308 includes tracking the run charts to observe trends in each of the process measurements listed above.

FIG. 9BA shows the screen shot of various process measurements that can be monitored though the run charts business tool 1308. It is contemplated that depending upon the nature of the business being monitored, modifications or addition to the process measurements listed in FIG. 9BA are well within the scope of the process of the present invention. FIGS. 9BB, 9BC, 9BD, 9BE, 9BF, 9BG, 9BH, 9BI, 9BJ, 9BK, 9BL, 9BM show the screen shots of various process measurements being monitored. For example, FIG. 9BB shows the screen shot of the process measurement known as “closing ratio”. FIG. 9BN shows the screen shot of means to customize the run charts, which can be done by modifying, for example, the width, height of the resulting run chart. FIG. 9BO shows the screen shot of a table used to submitting changes to the run chart data. Once the data are updated, FIG. 9BP shows the screen shot of a confirmation of the updates and FIG. 9BQ shows the screen shot of the tabulated updated run chart data.

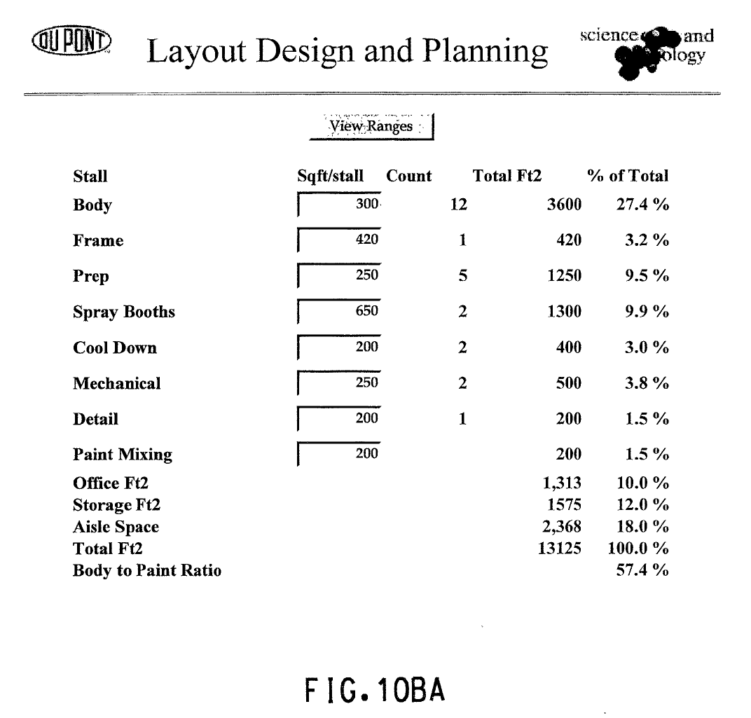

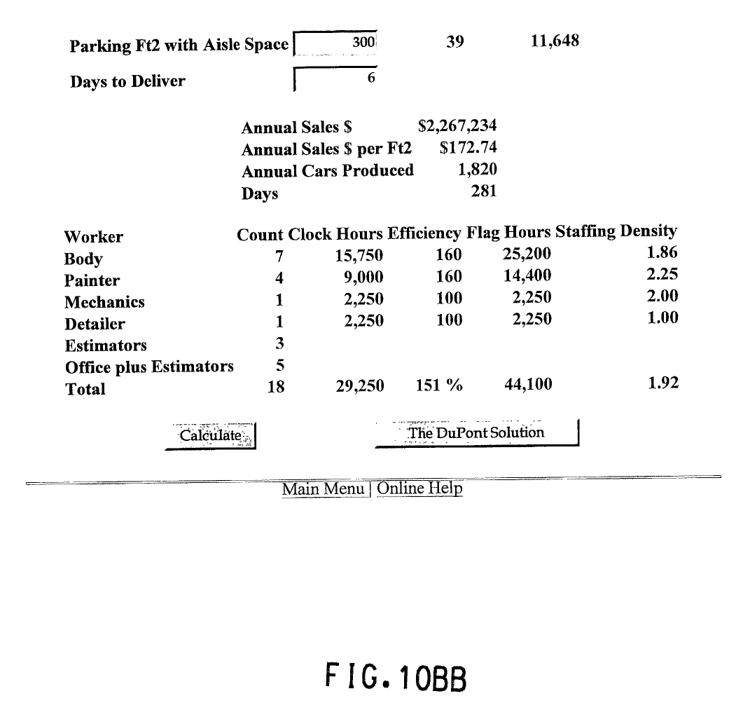

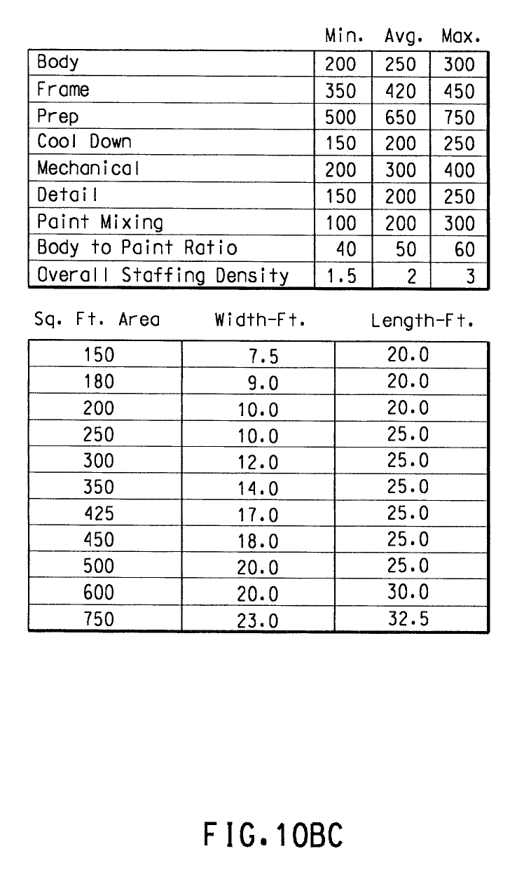

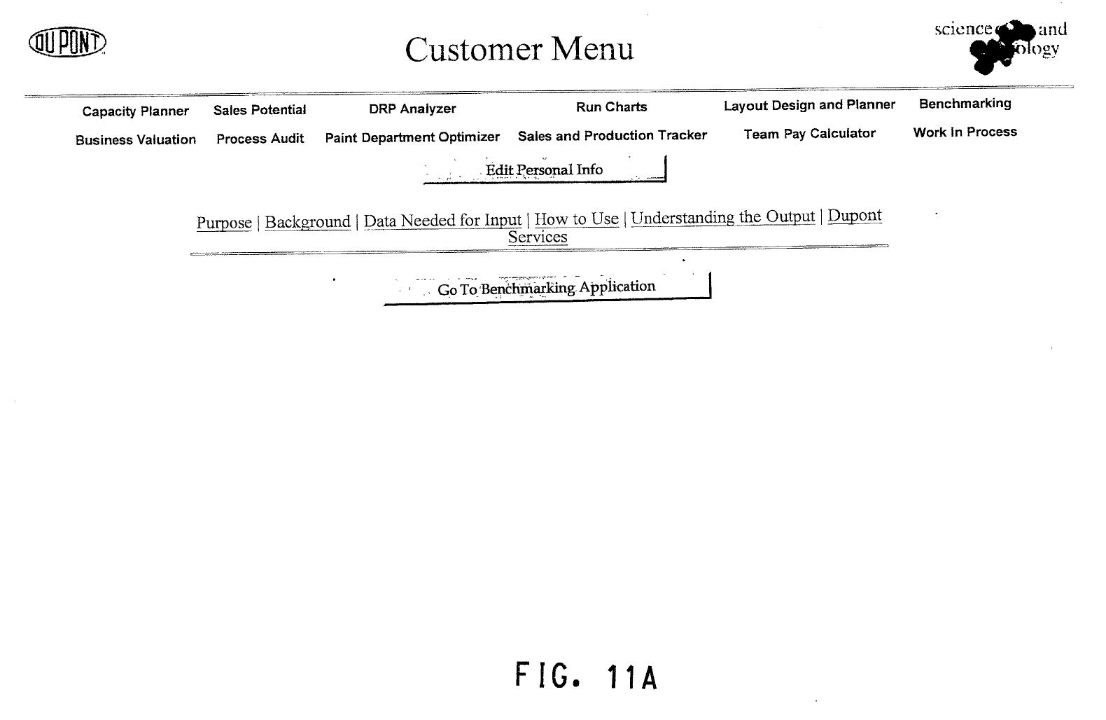

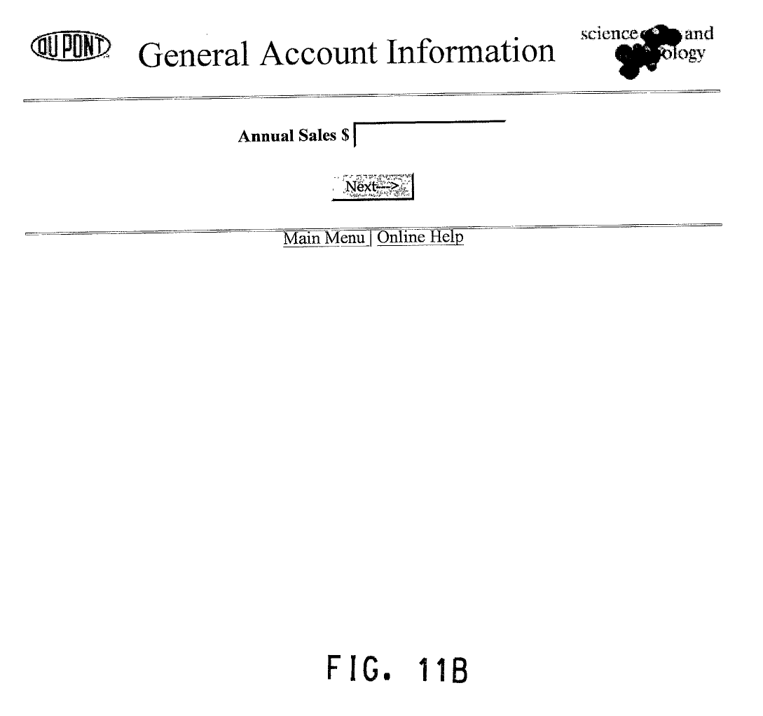

If customer computer 2 in step 132 selects a plant layout business tool 1310 from menu 129, host computer 4 through step 134 then directs customer computer 2 to tool 1310. FIG. 10A shows screen shots of plant layout business tool 1310 and provides instructions for using the chosen business tool.

The following instructions are provided in FIG. 10A for plant layout business tool 1310 when used for optimizing a plant layout for maximizing production in the smallest plant area:

### “Purpose

The Plant layout business tool helps you improve your plant floor capacity used for conducting various operational activities.

### Background

The key to efficient body shop plant layouts is generally based on adhering to the following principles:

1. Full utilization of the productive work area.

2. Optimal ratios of the body stall areas to spray booth areas.

3. Appropriate refinish equipment and a plant area necessary to efficiently use the refinish equipment.

4. Correct positioning of shop equipment to achieve a smooth uninterrupted workflow.

The plant layout for a body shop has many requirements that need to be considered:

1. Product mix.

2. Shop processes.

3. Sales per year.

4. Efficiency and skills of the plant personnel.

5. Local environmental regulations in effect.

6. Assignment of shop floor to various process equipment, which is a key issue.

7. Office & Storage needs.

8. Construction Design.

9. Choice of plant area configuration selected such as, “L” shaped or “U” shaped plant configuration, and plant with center Aisle and back-to-back configuration.

10. Plant location setting, i.e., is it an urban, suburban or a rural setting.

The plant layout business tool along with the capacity planner business tool provides key pieces of information to a plant designer.

### Data Needed for Input

The following data are needed to complete the input forms for the plant layout business tool:

1. Enter the desired stall sizes based on suggested values.

2. Enter the percentage of the total area allocated to storage.

3. Enter the percentage of the total area allocated to office.

4. Enter the size of outside parking spaces including the aisle.

5. Enter the number of days you will have the vehicle at plant site during repair.

### How to Use

Plant layout business tool should not be used until you have obtained data from a capacity planner business tool. Once you have entered the data in the capacity planner business tool, you can modify the shop components to give you the desired capacity for the new shop. Press the “calculate” button on screen to determine the area needed for all shop components.

### Understanding the Output

Capacity planner business tool can tell you the amount of equipment you need and the most efficient positioning of the equipment in standard plant configurations, such as L-shaped or U-shaped configurations. Remember the analysis is just a guide to get you started. Generally you want to look at the staffing density number which should be at least 1.5 stalls per person. You also need to determine if the ratio between body stall and spray booth is reasonable, i.e., it should be in the range of 40% to 60%. A desired goal would be about 60%, if you are repairing parts and 40% if you are replacing parts used in repairing vehicles.”

Step 150 for plant layout business tool 1310 includes the following steps:

determining total floor area of an automobile repair plant in square meters, determining parking area in square meters of the plant and determining staffing density for any area, wherein the total floor area is calculated by adding the following layout components:

1. Body stall area in square meters×number of body stalls in the plant,

2. Frame stall area in square meters×number of frame stalls in the plant,

3. Prep stall area in square meters×number of prep stalls in the plant,

4. Spray booth stall area in square meters×number of spray booth stalls in the plant,

5. Cool down stall area in square meters×number of cool down stalls in the plant,

6. Mechanical stall area in square meters×number of mechanical stalls in the plant,

7. Paint mixing stall area in square meters,

8. Office area in square meters,

9. Storage area in square meters, and

10. Aisle area in square meters, wherein, the office area in square meters is 10 percent of the area of the layout components 1, 2, 3, 4, 5 and 6 added together; the storage area in square meters is 12 percent of the area of the layout components 1, 2, 3, 4, 5 and 6 added together; the aisle area in square meters is calculated by using the following formula:

(an empirical factor)×(total number of the stalls in the layout components 1, 2, 3, 4, 5, 6 and 7)−[(the stall area in square meters ×number of body stalls in the plant) +(the frame stall area in square meters ×number of frame stalls in the plant) +(the prep stall area in square meters ×number of prep stalls in the plant) +(the spray booth stall area in square meters ×number of spray booth stalls in the plant) +(the cool down stall area in square meters ×number of cool down stalls in the plant) +(the mechanical stall area in square meters ×number of mechanical stalls in the plant) +the Paint missing stall area in square meters +the office area in square meters +the storage area in square meters]; (xiii)

the parking area in square meters is calculated by using the following formula:

(Total number of parking stalls) ×(area in square meters of the parking stall +area in square meters of the aisle area allotted to each the parking stall); (xviii)

wherein the total number of parking stalls are calculated by using the following formula:

(Number of days required to repair an automobile) ×(Number of automobiles repaired per day) (xix); and

the staffing density for any area of any one of the layout components 1, 2, 3, 4, 5, 6, 7, 8, 9 and 10 is calculated by using the following formula:

$$\frac{number of stalls for that area}{number of employees working in that area} . \qquad ( xx )$$

The empirical factor generally varies from 45 to 60 when various areas in the foregoing formulas are calculated in square meters, the preferred empirical factor being 48.8. The empirical factor generally varies from 480 to 645 when various areas in the foregoing formulas are calculated in square feet, the preferred empirical factor being 525.

The business solution in step 150 for plant layout business tool 1310 includes developing an improved layout of the automobile repair plant based on the total floor area, parking area and the staffing densities that is more efficient than conventional plant layouts.

FIGS. 10BA and 10BB show the screen shots with data entry in accordance with the aforedescribed plant layout business tool 1310. To assist the customer in configuring a plant layout, FIG. 10BC shows the screen shot of standardized ranges in areas and sizes typically used in collision repair shop. It is understood that these ranges vary from one industry to another and it is within the contemplation of the present process to suitably modify these ranges in accordance with the type of business being analyzed.

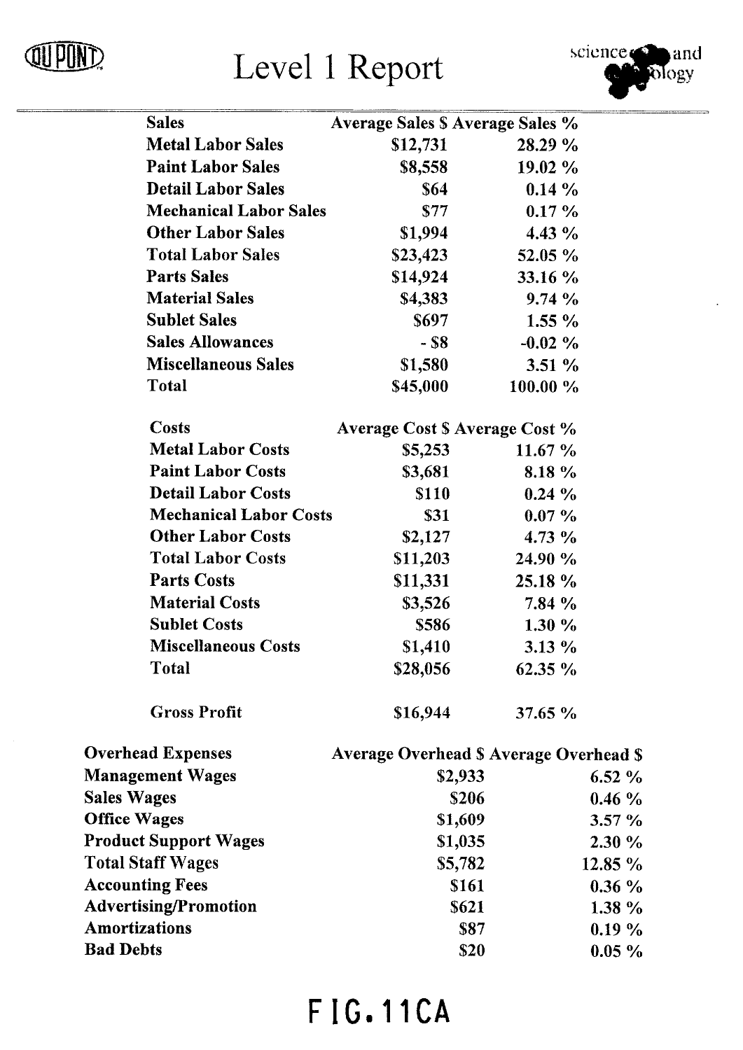

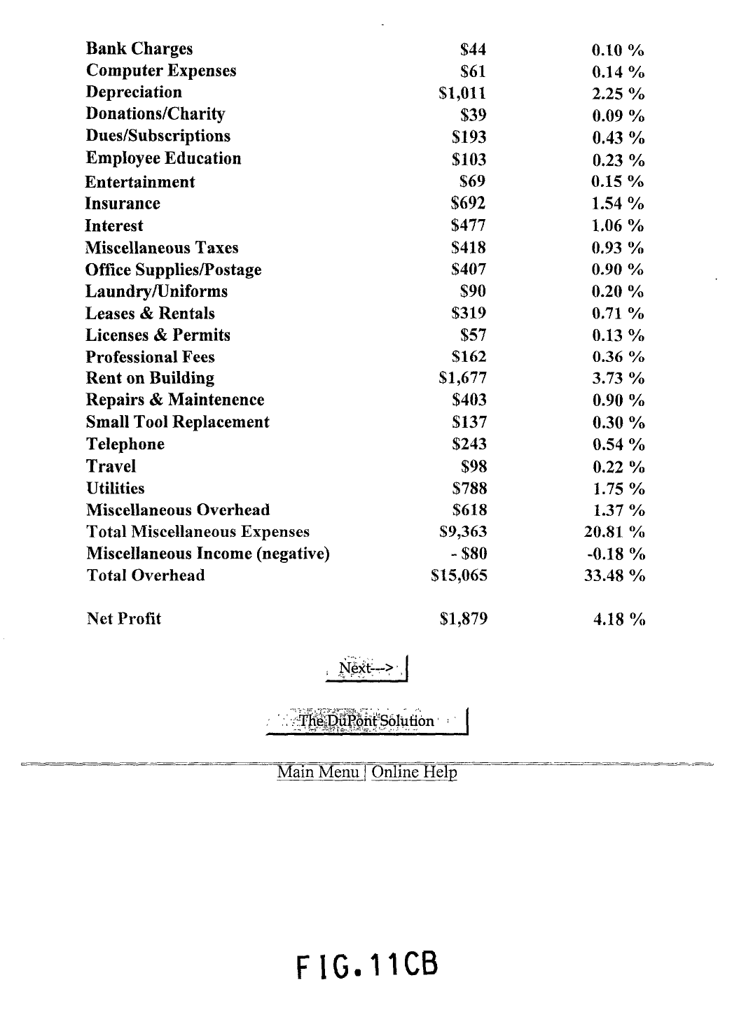

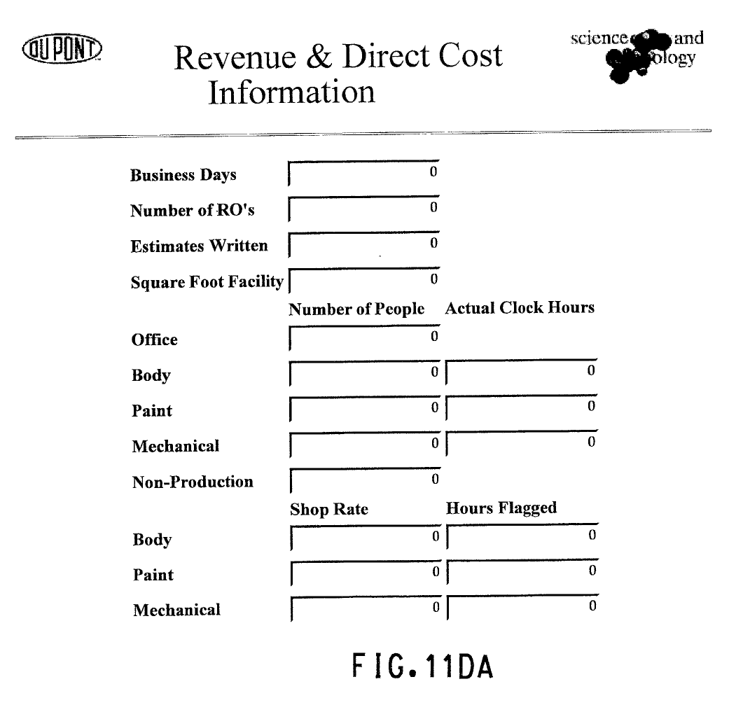

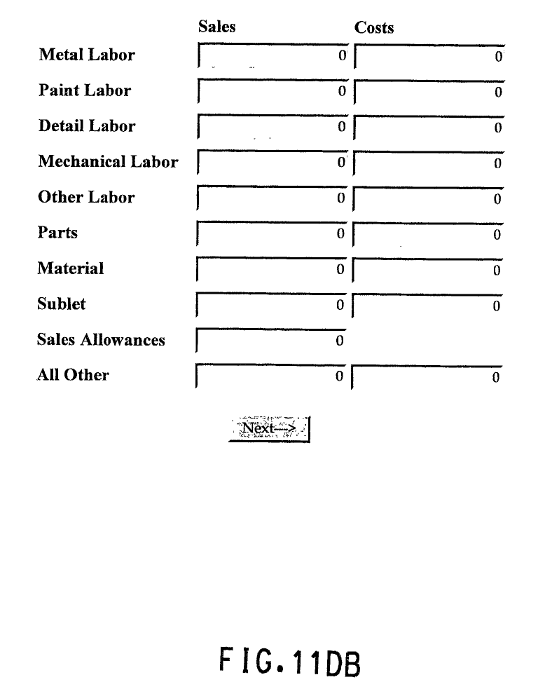

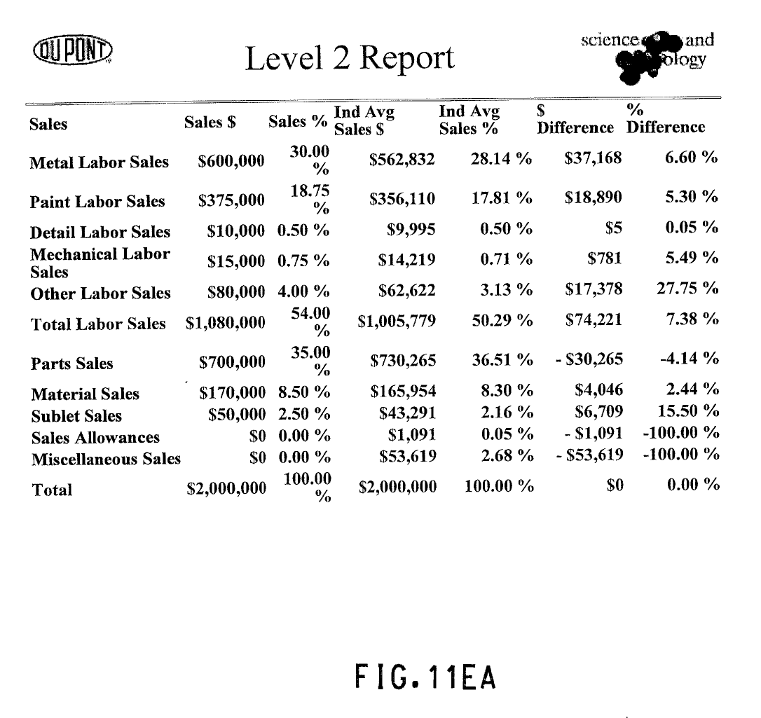

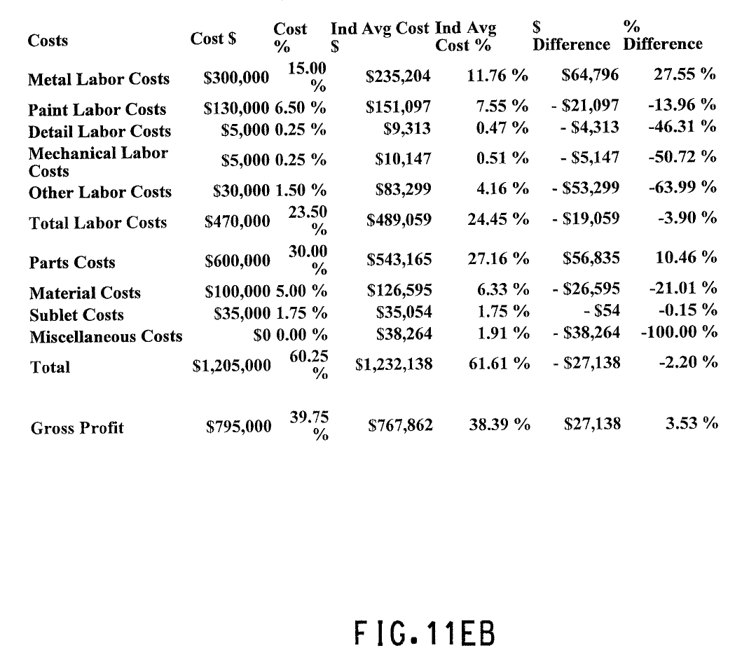

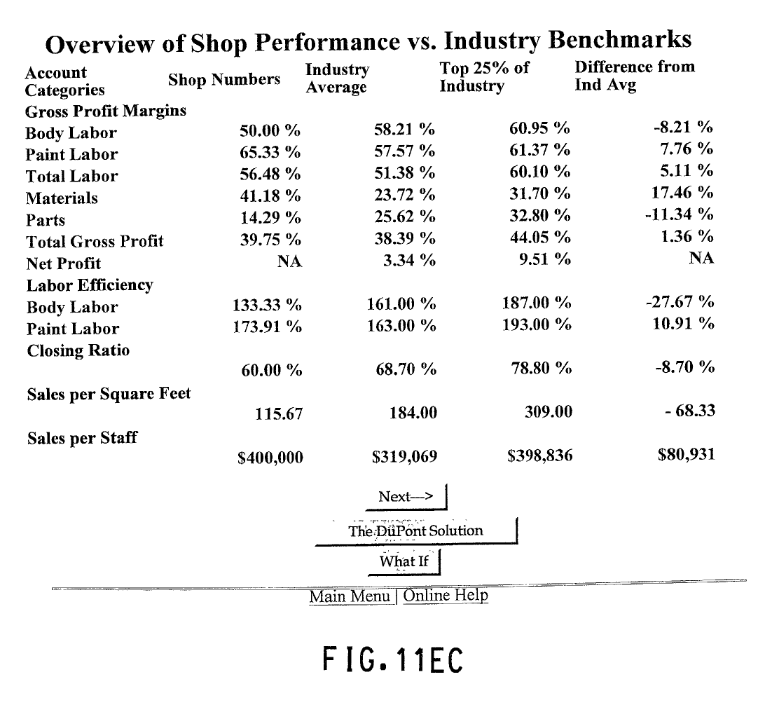

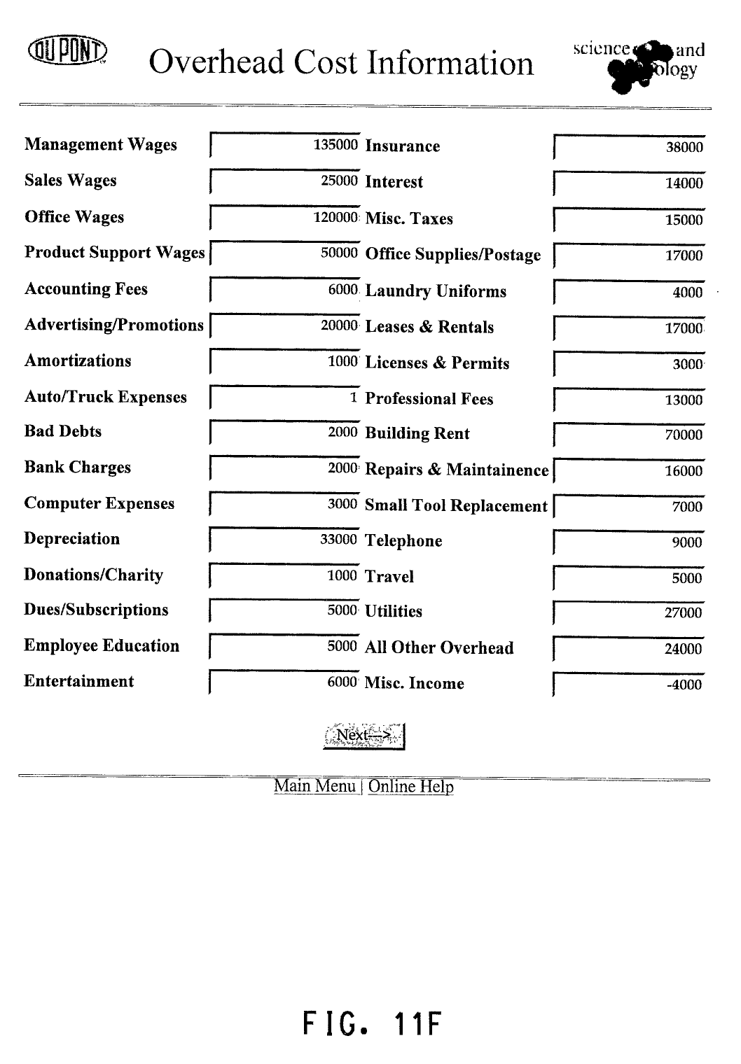

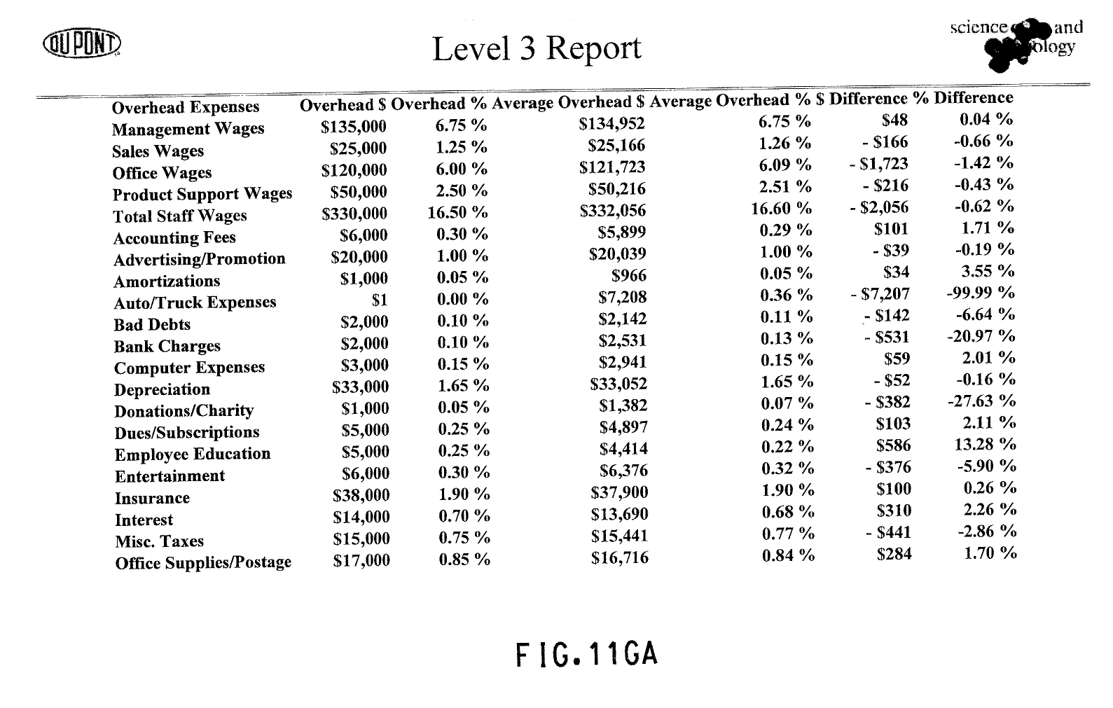

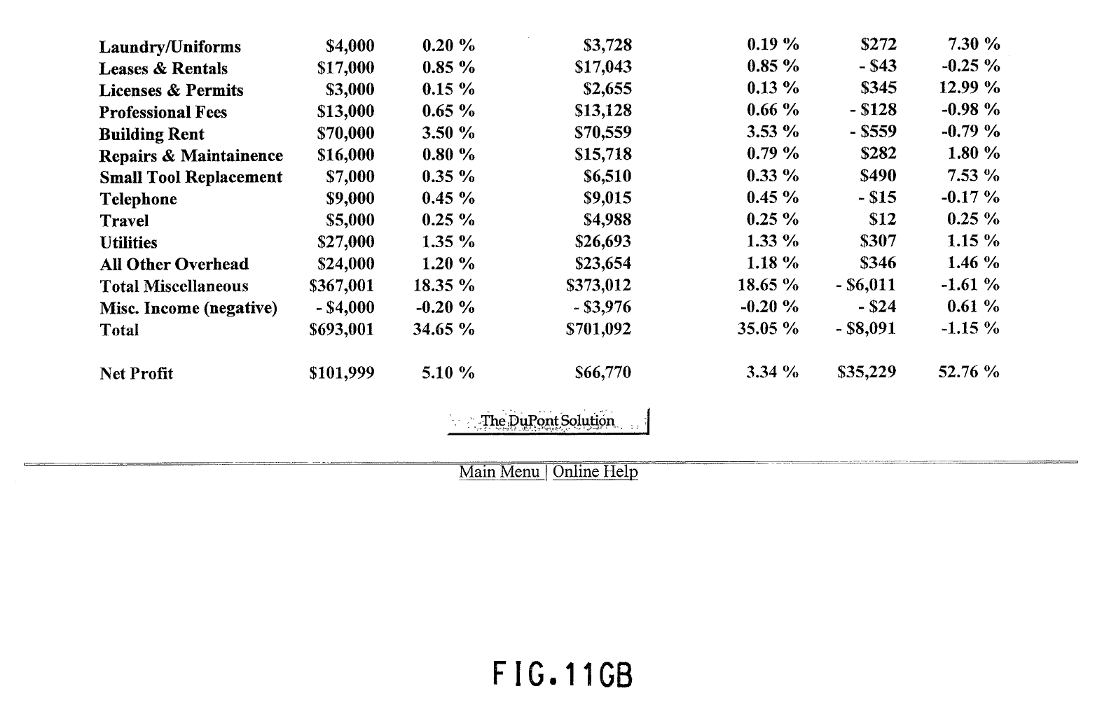

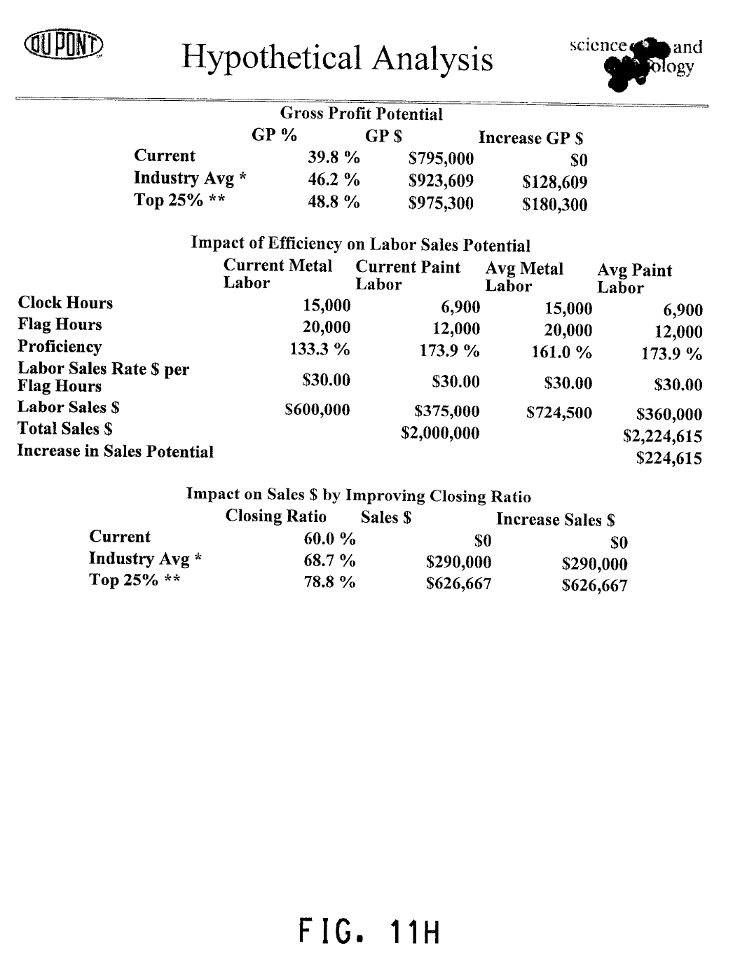

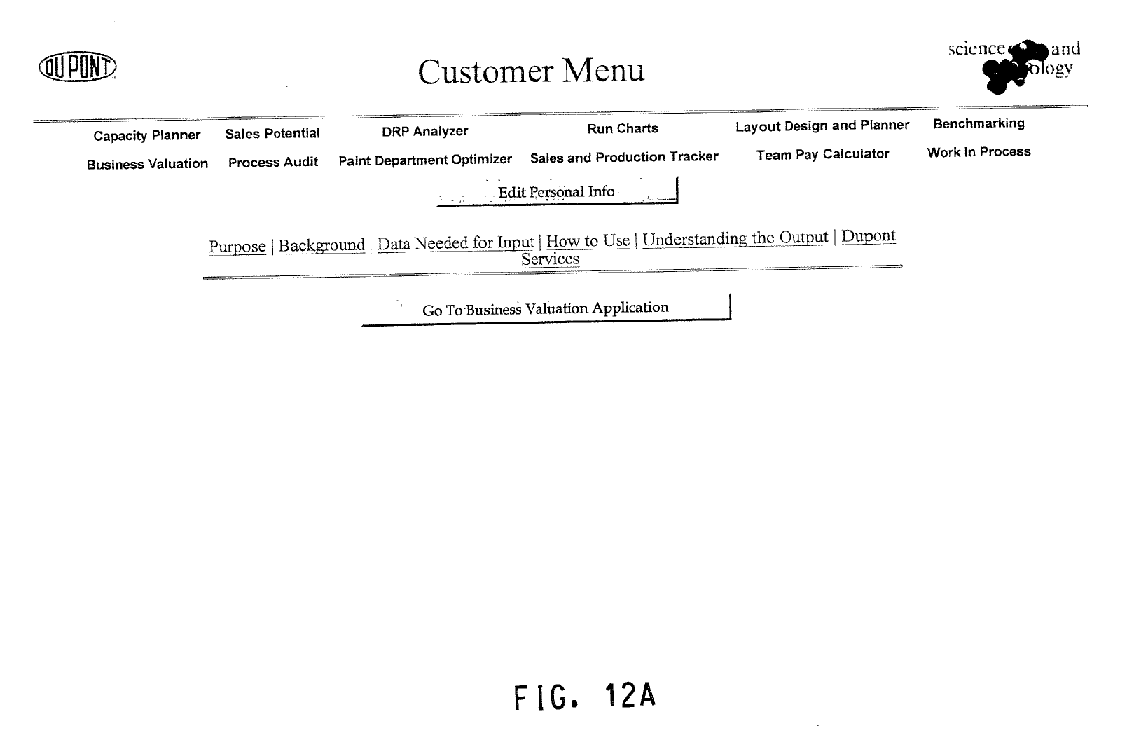

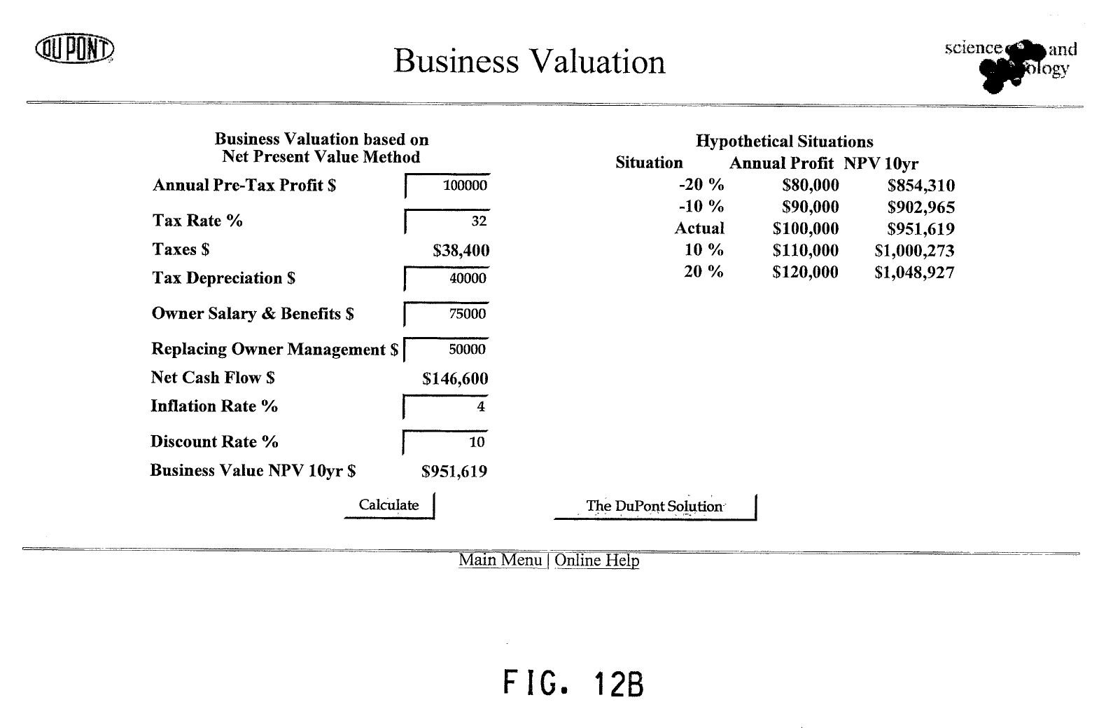

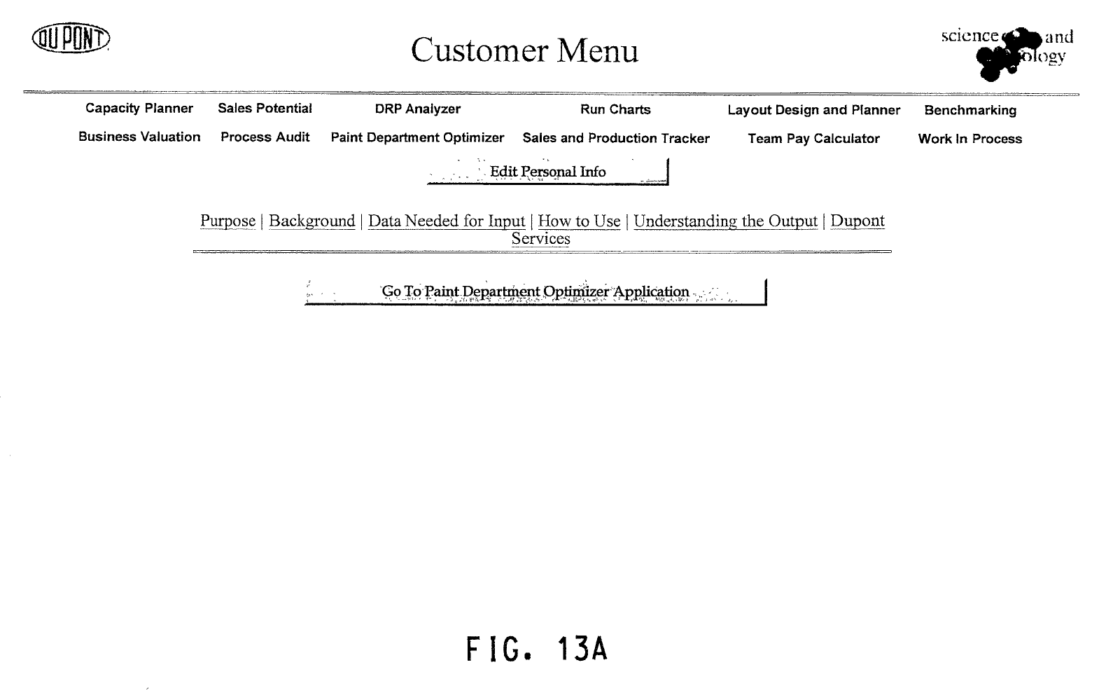

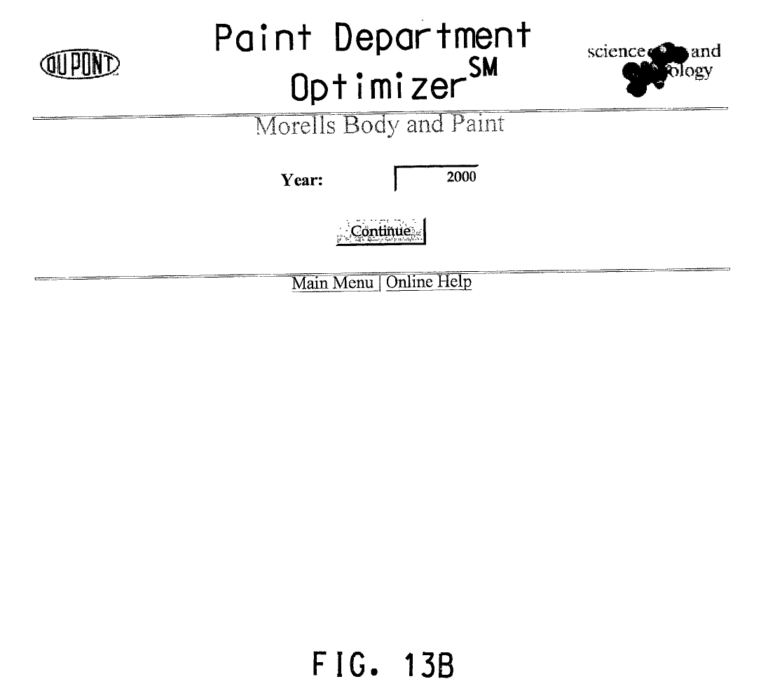

If customer computer 2 in step 132 selects a benchmarking business tool 1312 from menu 129, host computer 4 through step 134 then directs customer computer 2 to tool 1312. FIG. 11A shows screen shots of benchmarking business tool 1312 and provides instructions for using the chosen business tool.

The following instructions are provided in FIG. 11A for bench marking business tool 1312 which is used to track key process variables that can impact the profitability of business:

### “Purpose

Benchmarking tool is used for identifying areas, which require improvements in your business. The web page will help establish a benchmark for evaluating your future business performance.

### Background

Benchmarking is a widely used and valuable process to your business. Your can compare the financial performance of your business with the best shops in the business and identify what can possibly be achieved. It helps you in finding which processes in your shop are performing well and which ones are in need of improvements.

### Data Needed for Input

Level 1 analysis requires you to enter your annual sales only. By entering this value your shop is compared to shops of similar size. Level 2 requires analysis to enter the following data:

1. Sales and cost data by department.

2. Flag hours and clock hours by department.

3. Plant floor area.

4. Number of personnel working in each department.

5. Days of operation per week, per month or per year.

6. Number of cars repaired per year.

7. Number of estimates written per day, week, month or year.

Level 3 analysis requires a detailed breakdown of overhead expenses.

### How to Use

When you enter your annual sales, the tool will compare your performance against an industry average of a business having annual sales of similar size. Generally, there are five size categories built into the program, ranging from under $500,000 to over $2,000,000 in yearly sales. This is an important key to the benchmark because they vary with sales volume. You will notice there are three levels of analysis. Level 1 analysis needs to be completed first, then Level 2 analysis, and lastly Level 3 analysis, if required data are available.

First enter your annual shop sales revenue at Level 1.

Level 2 analysis relates to the revenue and direct cost side of the business and can also provide actual gross profit margins based on the shop's data entered during the level 2 analysis.

Level 3 analysis requires more account specific information, such as overhead costs. After completing the data entry, you can look at the benchmark summary table to determine how your shop compares by department in profitability to the industry average and to the top 25^{th} percentile industry average. You can also compare manpower efficiencies, closing ratios, sales per meter plant area and sales per staff. These comparisons should be used to identify areas that need improvement.

### Understanding the Output

Level 1 analysis indicates to you that given your sales, here is a breakdown of shop financials for the average shop across the country.

With level 2 analysis you can get a line-by-line comparison of your shop with the average shop. This difference is highlighted by the dollar difference column and the percentage difference column. Focus on the major differences and not on the minor differences.

Level 3 analysis allows you to compare your overhead expenses to the average shop. This is generally difficult because of variations in the way you would categorize a particular expense. This area however is very important because a large percentage of your costs are in the overhead account. To become really successful you need to manage and control these expenses.”As shown in screen shot in FIG. 11B, step 150 for benchmarking business tool 1312 for conducting a level one analysis of a business under review includes entering annual sales of the business in a standardized performance database.

The business solution for benchmarking business tool 1312 in step 156 for the level one analysis includes displaying an industry average of a breakdown of financial performance of a comparable business accessed from the standardized performance database. A number of such standardized performance databases are known in the industry, such as one provided by AutocheX of San Mateo, Calif. FIGS. 11CA and 11CB show the screen shots of business solution for conducting the level one analysis.

Step 150 for benchmarking business tool 1312 for conducting a level two analysis of a business includes one or more of the following steps:

determining a percentage of total annual sales of a department in the business by using the following formula:

$$100 \times \frac{Annual sales by said department}{Total annual sales of said business} ; \qquad ( xxi )$$

determining a percentage of annual gross profits of the department in the business by using the following formula:

$$100 \times \frac{Annual gross profit by said department}{Annual sales by said department} \qquad ( xxii )$$

wherein the gross profit by the department is detained by subtracting annual cost incurred by the department from annual sales by the department;

determining a percentage of annual labor efficiency of the business by using the following formula:

$$100 \times \frac{Total annual clock hours}{Total annual flag hours} ; \qquad ( xxiii )$$

determining a percentage of annual closing ratio of the business by using the following formula:

$$100 \times \frac{Annual estimates sold}{Annual estimates made} ; \qquad ( xxiv )$$

determining annual sales per square meter of the business by using the following formula:

$$\frac{Total annual sales of said business}{\begin{matrix}Total plant area of a said business \\ in square meter\end{matrix}} ; and \qquad ( xxv )$$

determining annual sales per employee the business by using the following formula:

$$\frac{Total annual sales of said business}{Number of employees working in that area} . \qquad ( xxvi )$$

FIGS. 11DA and 11DB show the screen shots of data entry during the aforedescribed level two analysis.

The business solution for benchmarking business tool 1312 in step 156 for the level two analysis includes:

forecasting for the department of the business what new annual percentage of gross profit would be by subtracting industry standard percentage of costs accessed from the standardized performance database from the percentage of total annual sales;

forecasting for new annual total sales for the business would be if the annual percentage of labor efficiency is raised to industry standard percentage of costs accessed from the standardized performance database from the percentage of total annual sales;

forecasting for the department of the business what new annual percentage of labor efficiency would be by subtracting industry standard percentage of costs accessed from the standardized performance database from the percentage of total annual sales; and

forecasting for new annual total sales for the business would be if the annual closing ratio is raised to industry standard percentage accessed from the standardized performance database.

The comparable business is typically selected from the top 25^{th} percentile of comparable businesses listed in the standardized performance database. However, it should be noted that such a selection for comparison is arbitrary and the business manager can select other comparable groups as a standard for comparison, such as the top 10^{th} percentile, or even the bottom 25^{th}, or 10^{th} percentile of the comparable businesses listed in the standardized performance database. FIGS. 11EA and 11EB show the screen shots of the business solution resulting from the level two analysis. FIG. 11EC shows the screen shot of the level two analysis comparing the present business against the industry average and the top 25^{th} percentile industry average. The percent differences between the present business and the industry average are also provided to allow the customer to get a better understanding of the business areas that need improvements.

FIGS. 11F shows the screen shots of the data entered during the level three analysis. FIGS. 11GA and 11GB show the details of the level 3 report. FIG. 11H shows the hypothetical analysis of “what if” scenarios on gross profit margins when labor efficiencies and sales increases are factored in.

If customer computer 2 in step 132 selects a business valuation business tool 1314 from menu 129, host computer 4 through step 134 then directs customer computer 2 to tool 1314. FIG. 12A shows screen shot of business valuation business tool 1314 and provides instructions for using the chosen business tool.

The following instructions are provided in FIG. 12 A for business valuation business tool 1314, which is used to determine the value of the business based on its projected cash flow:

### “Purpose

This tool determines the value of your business based on it's projected cash flow.

### Background

Professional appraisers will generally use as a valuation technique the income approach, the asset approach, or the market approach. The use of each of these techniques requires a significant amount of data and experience. Many times, two or three methods are used, although one cannot simply average the results of each method. Certain types of businesses lend themselves more to a particular technique, while other businesses are very general and can utilize two or even three methods of valuation. If your business is a service business, if inventory is not a material part of the balance sheet, or if the production of cash does not require a significant investment in fixed assets, then the income approach will generally be the best indicator. A very simple technique can be used to develop a discounted cash flow model. A discounted cash flow model does not have to be complicated, arcane, and only for the mathematically gifted. You simply have to develop and identify the cash flow of the business. A simple place to start is with the income statement or the income section of the tax return (regardless of what type of business entity you have). Once you find taxable income from your tax return, you then must make certain adjustments to develop the adjusted cash flow.

Data Needed for Input

1. Annual pre-tax profits per year from year end balance sheet.

2. Tax percentage rates from tax forms.

3. Tax depreciation per year from tax forms.

4. Owner salary & benefits per year from tax returns.

5. Replacing owner and management salaries per year with industry average management salary.

6. Inflation rate, assume 3 percent.

7. Discount rate percentage. Ask your accountant. It should be between 12% to 20% depending on your borrowing power.

### How to Use

Just enter the above data into the web page and hit “calculate”.

### Understanding the output

The discounted cash flow model gives the value of your business based on a ten-year net present value calculation at a specified inflation rate and cost of money [Discount Rate]. The larger the net cash flow, the more valuable your business.

DuPont Solutions can help you to institute a value creation program based on measuring key performance factors, identifying process improvement areas and beginning a continuous improvement program for your shop.”

FIG. 12B shows the screen shot business evaluation tool when used to determine the net present value of the business depending on various projected annual profits.

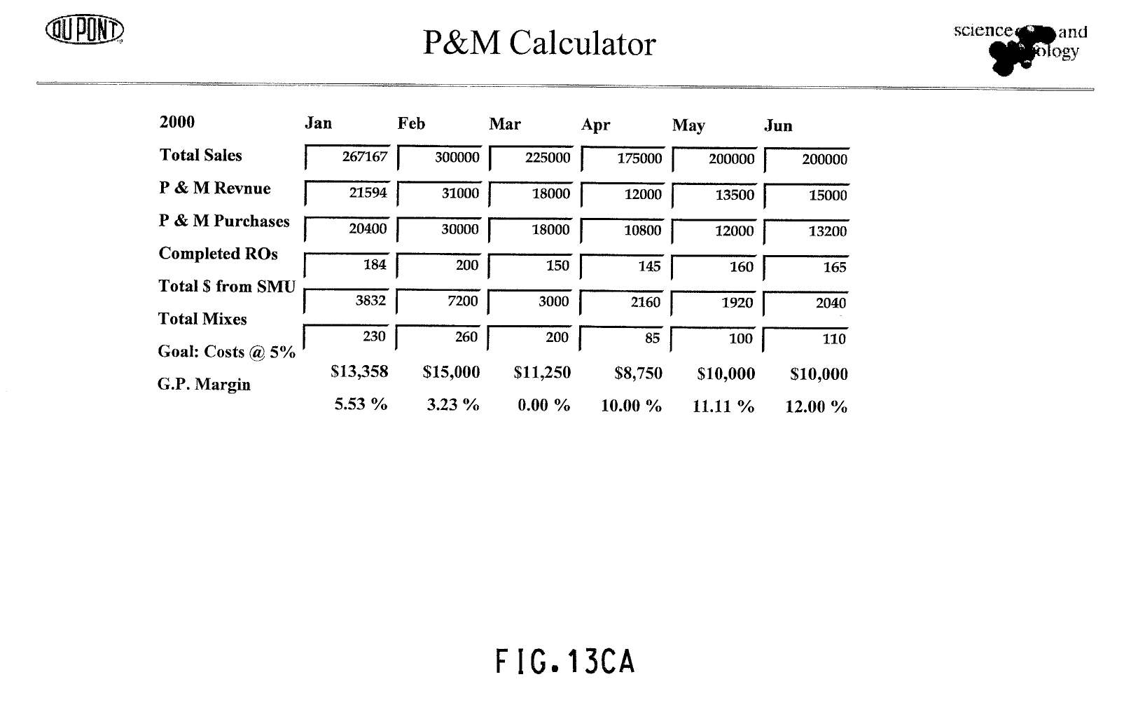

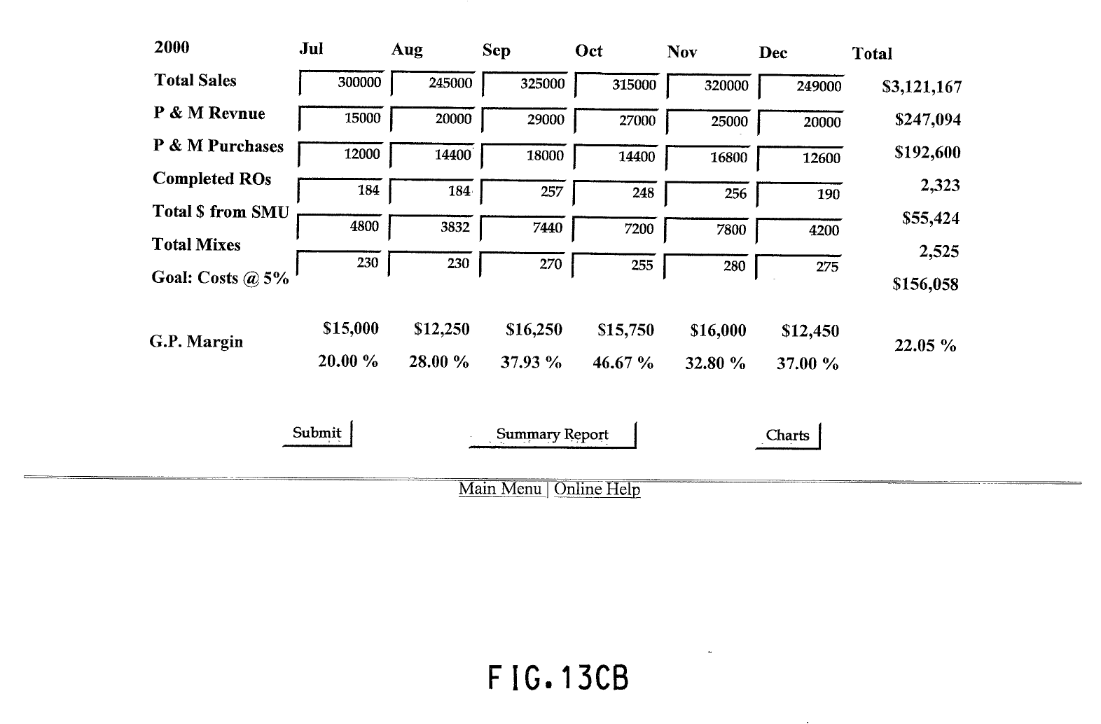

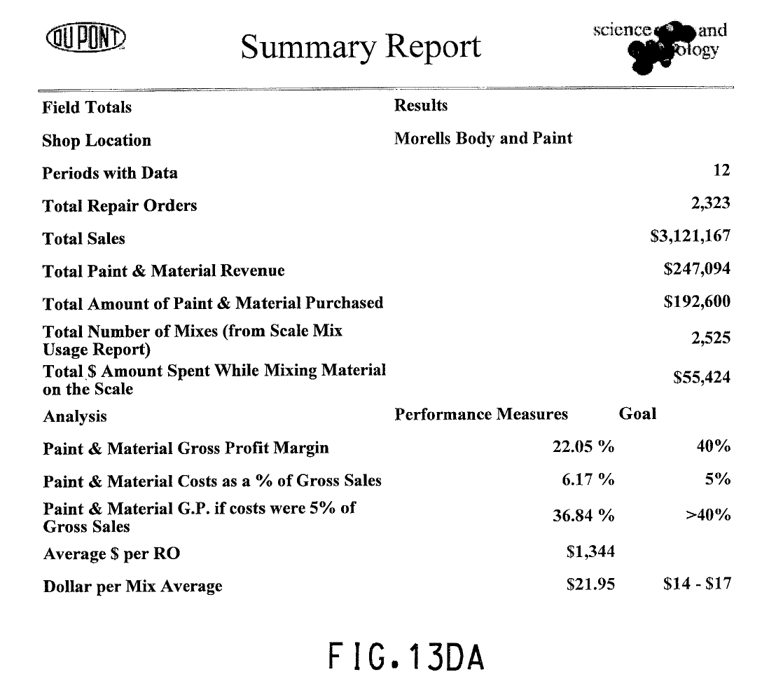

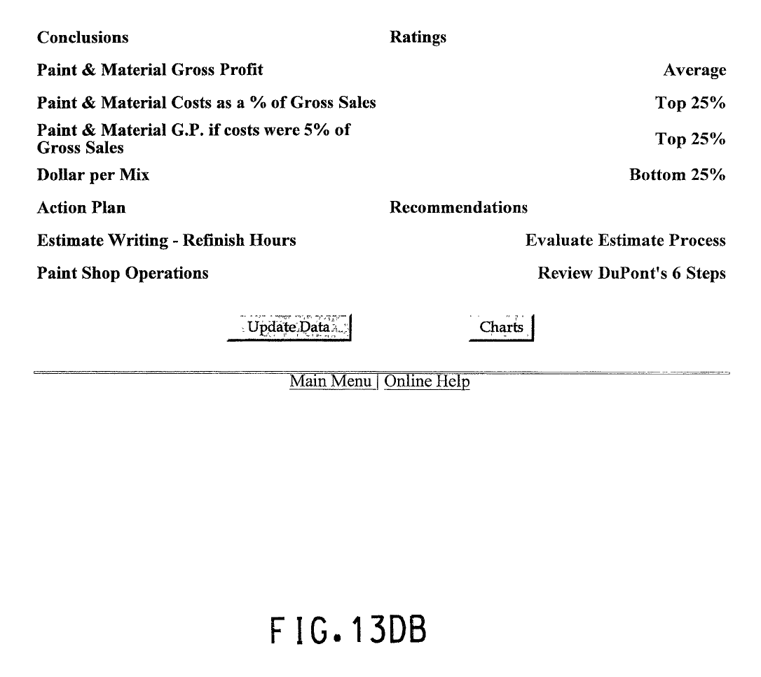

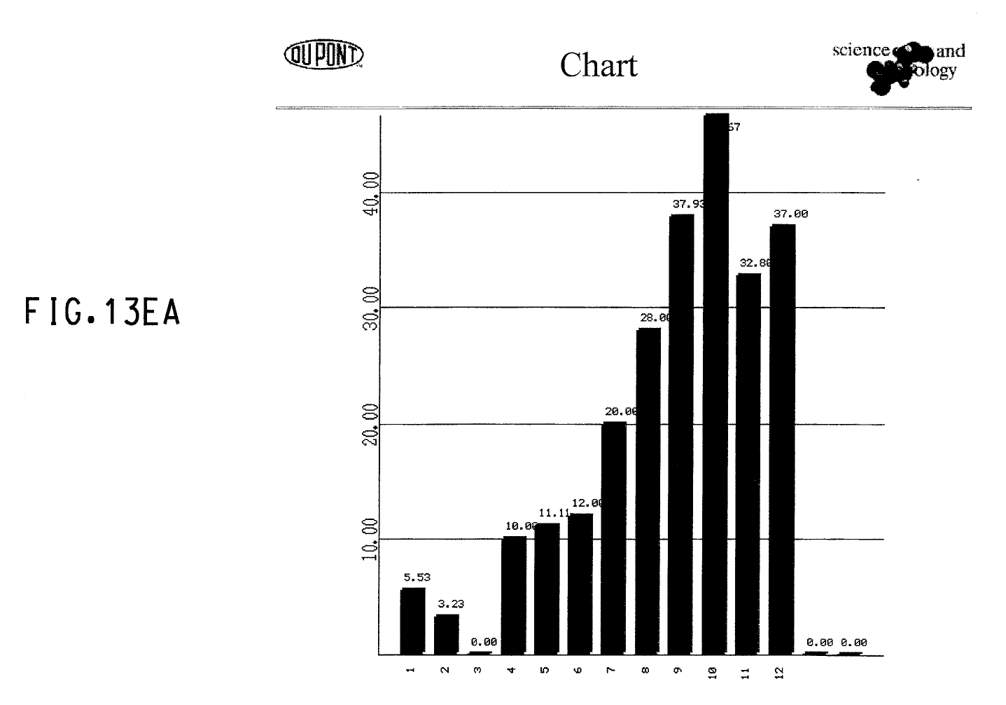

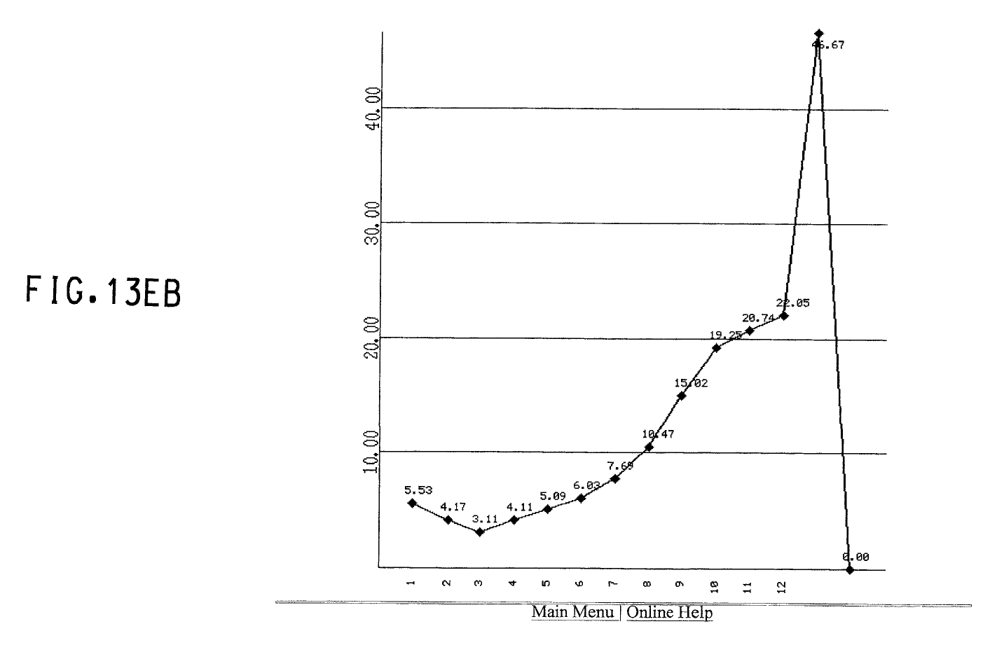

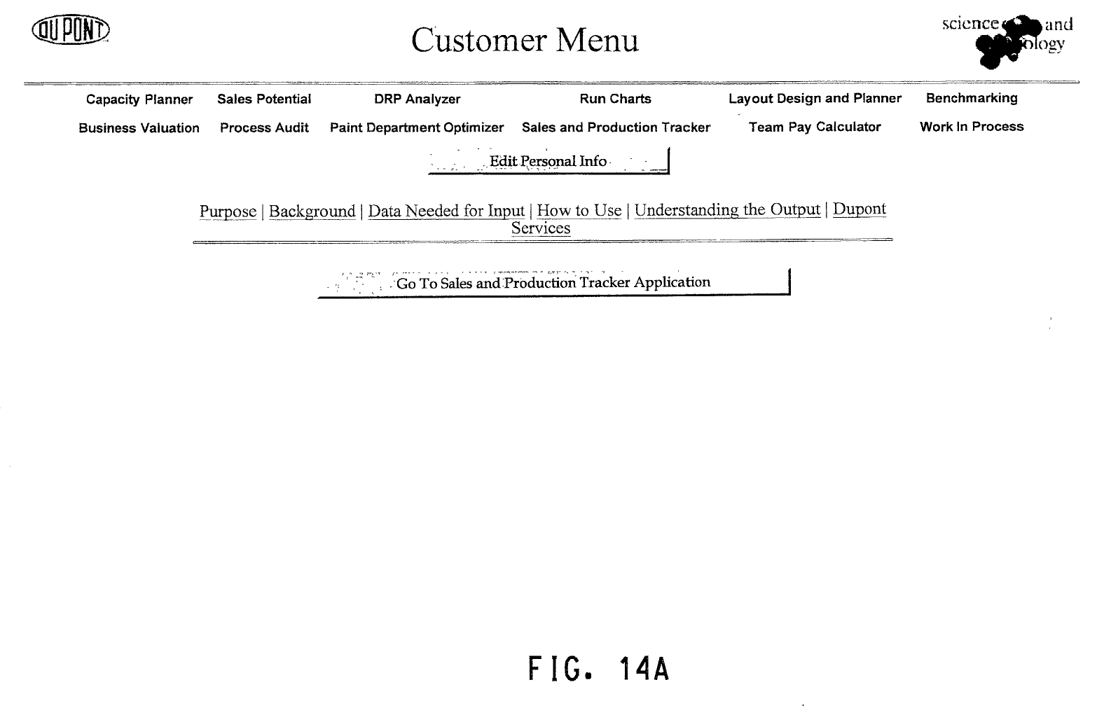

If customer computer 2 in step 132 selects a Paint Department Optimizers^{SM} business tool 1316 from menu 129, host computer 4 through step 134 then directs customer computer 2 to tool 1316. FIG. 13A shows screen shots of Paint Department Optimizers^{SM} business tool 1316 and provides instructions for using the chosen business tool.

The following instructions are provided in FIG. 13A for Paint Department Optimizers^{SM} business tool 1316, which is used to track performance of the paint department over a desired period, such as a month:

### “Purpose

The Paint Department Optimizers^{SM} is a tool used to track the performance of the paint department.

### Background

In order to improve the paint department profitability you need to be tracking your performance, typically on a monthly basis.

### Data Needed for Input

You need the following data from the paint department:

1. Total sales.

2. Paint & material (P & M) revenue.

3. P & M purchases.

4. Completed repair orders.

5. Total revenue from SMU.

6. Total number of mixes.

### How to Use

Enter the paint department data each month.

### Understanding the Output

After entering the current month's data in the Paint Department Optimizers^{SM}, business tool, the tool calculates the summary information by totaling each row and also calculating the goal costs and the percent gross profit for the month and year to date. You can then request a summary report by clicking on the “summary report” button. This report analyzes the data and suggests a future course of action. Finally you can get a graphical representation of the percent gross profit data.”

The screen shots of FIGS. 13B, 13CA and 13CB are used to enter the data. Step 150 for Paint Department Optimizer^{SM} includes the following one or more steps:

tabulating monthly total sales, paint & materials revenues, paint & materials purchase cost, number of paint mixes made, average cost per paint mix, number of completed repair orders, average cost per the repair order, wherein the average cost per paint mix is calculated by using the following formula:

$$\frac{Total sales}{Number of completed repair orders} \qquad ( xxvii )$$

wherein the average cost per paint mix is calculated by using the following formula:

$$\frac{Paint \& materials purchase cost }{Number of Mixes} ; and \qquad ( xxviii )$$

determining percent gross profit on paint & materials by using the following formula:

$$100 \times \frac{\begin{matrix}Paint \& materials revenues - \\ Paint \& materials purchase cost\end{matrix}}{Paint \& materials revenues} ; \qquad ( xxix )$$

determining percent cost for paint & materials as percentage of the total sales by using the following formula:

$$100 \times \frac{Paint \& materials purchase cos}{Total sales } ; \qquad ( xxx )$$

determining goal cost for paint & materials purchase as a percentage of the total sales by using the following formula:

$$Desired perentage rate \times \frac{Total sale}{100} ; and \qquad ( xxxi )$$

determining percent goal gross profit on paint & materials by using the following formula:

$$100 \times \frac{\begin{matrix}Paint \& materials revenues - Said goal cost \\ for paint \& materials purchase\end{matrix}}{Paint \& materials revenues} . \qquad ( xxxii )$$

As shown in the screen shot of FIGS. 13DA and 13DB the business solution for Paint Department Optimizer^{SM} business tool 1316 in the step 156 includes tracking current performance of a paint department of the business against a performance goal by:

comparing the percent gross profit on paint & materials on a monthly and annual basis against a percent industry standard gross profit for paint & materials for a comparable business accessed from a standardized performance database;

comparing the percent cost for paint & materials as percentage of the total sales on a monthly and annual basis against the percent goal cost for paint & materials as percentage of the total sales; and

comparing the number of paint mixes made, average cost per paint mix, number of completed repair orders and average cost per the repair order on a monthly and annual basis against industry standards of a comparable business accessed from a standardized performance database.

FIGS. 13EA and 13EB show the rendition of the data in FIGS. 13DA and 13DB in a graphical format.

The desired percent rate in the foregoing steps typically ranges from 0. 1% to 5%.

In the forgoing steps the number of paint mixes made, average cost per paint mix, number of completed repair orders and average cost per the repair order are compared against the upper 25^{th} percentile of comparable businesses accessed from the standardized performance database. However, it should be noted that such a selection for comparison is arbitrary and the business manager can select other comparable group as a standard for comparison, such as the top 10^{th} percentile, or even the bottom 25^{th} , or 10^{th} percentile of the comparable businesses listed in the standardized performance database.

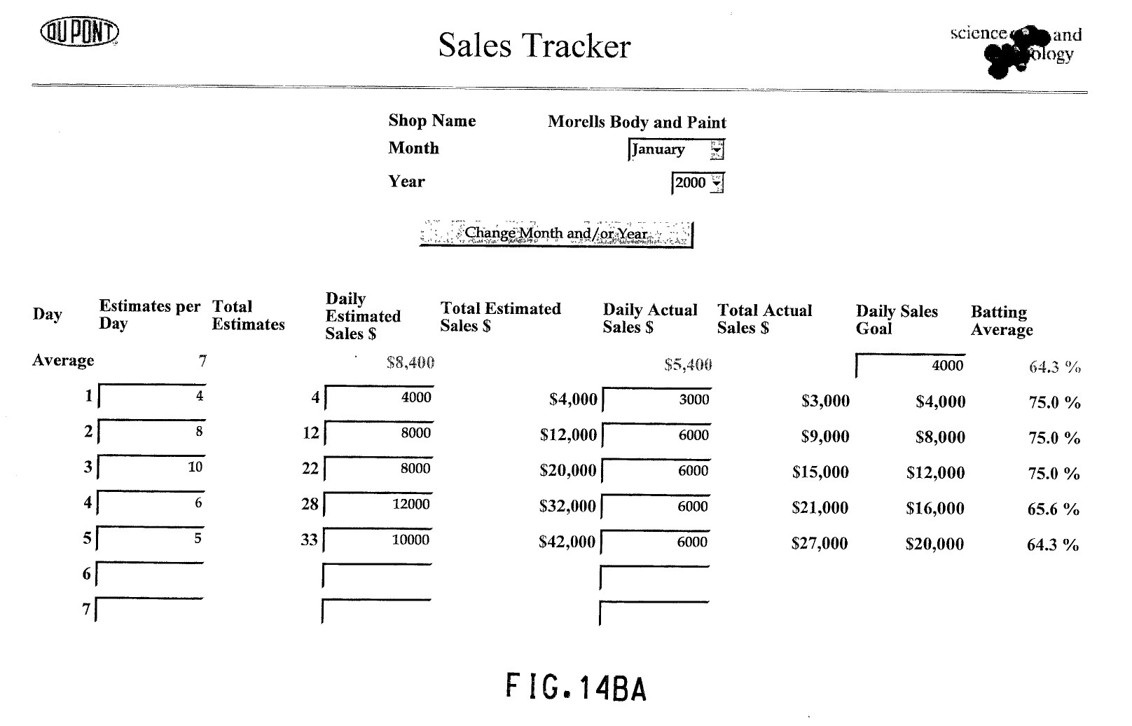

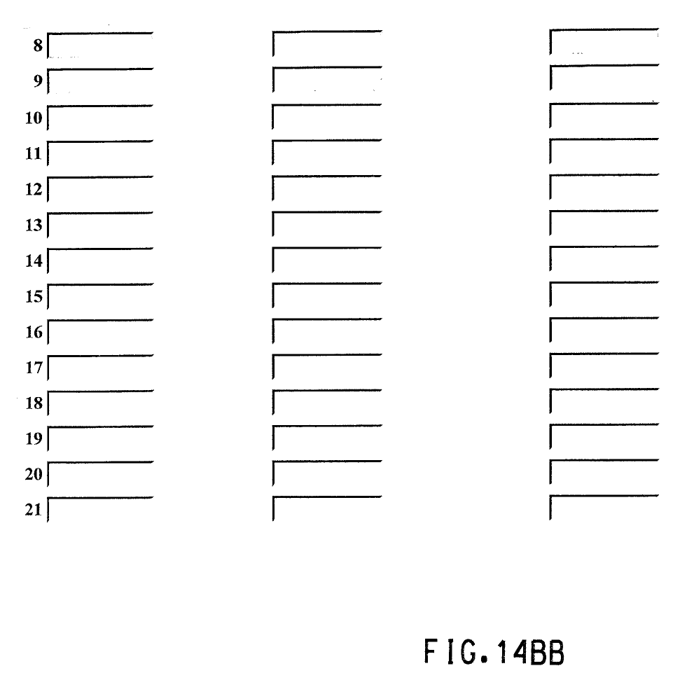

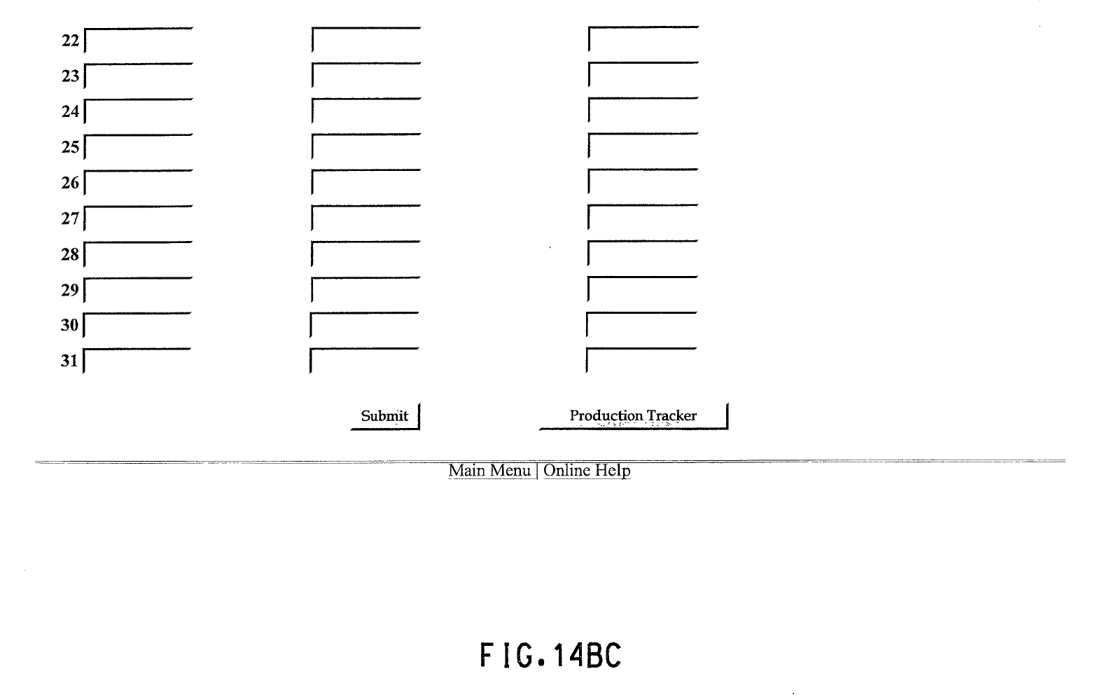

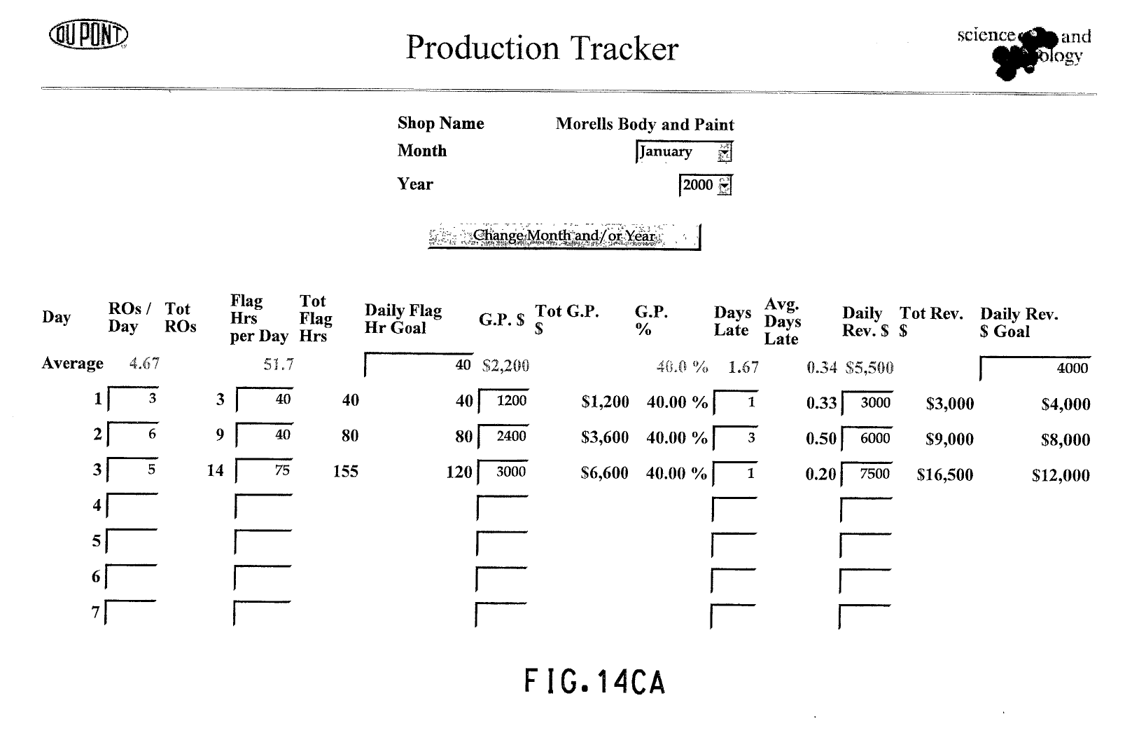

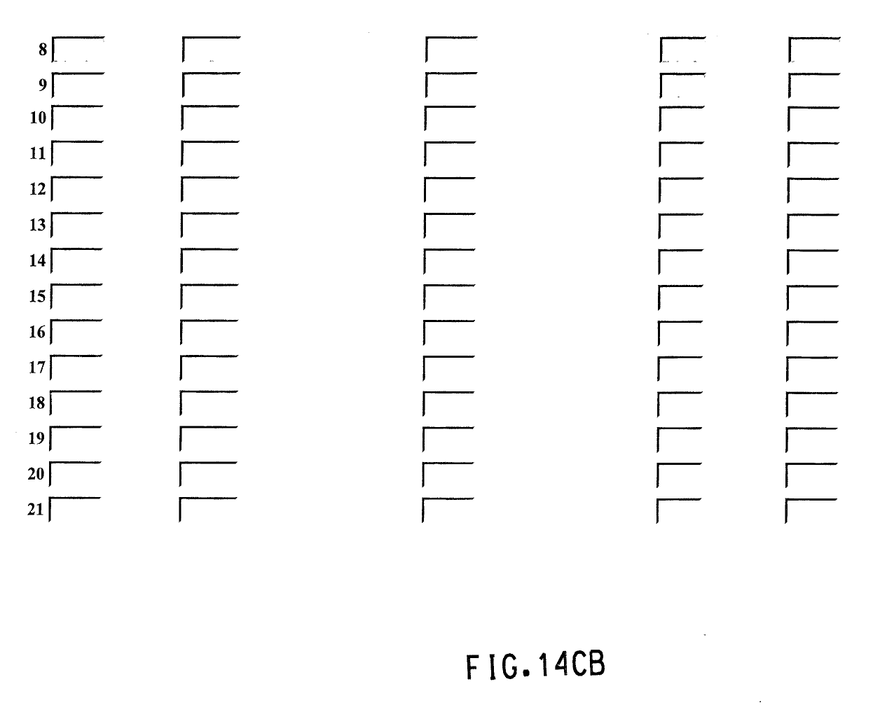

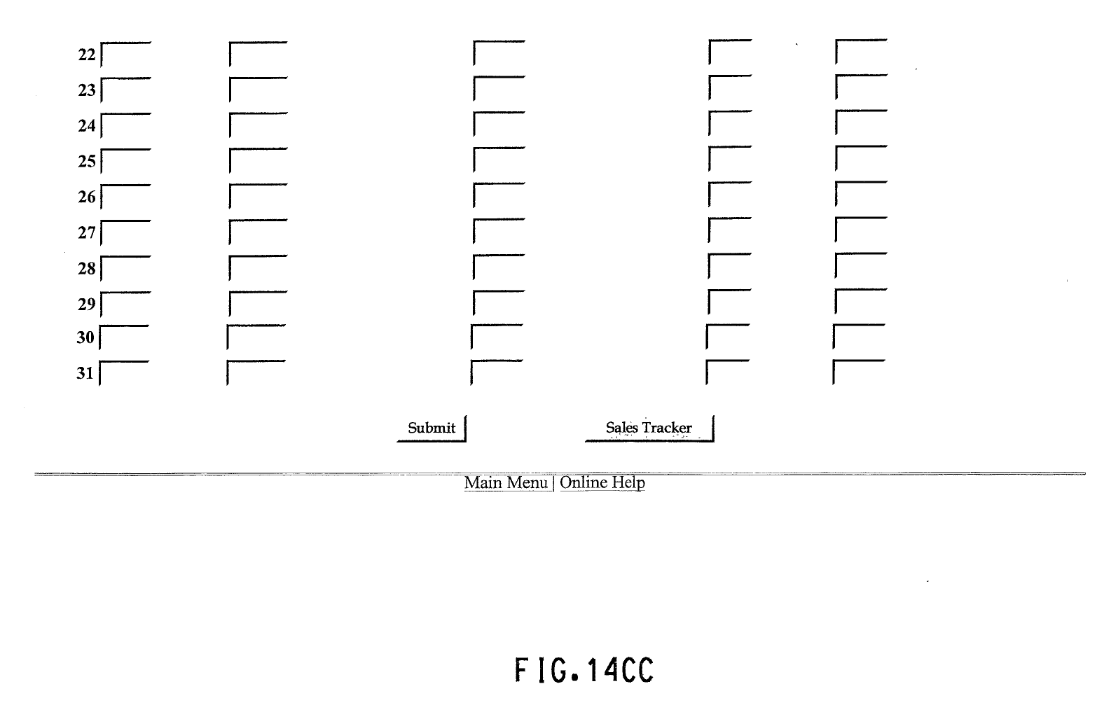

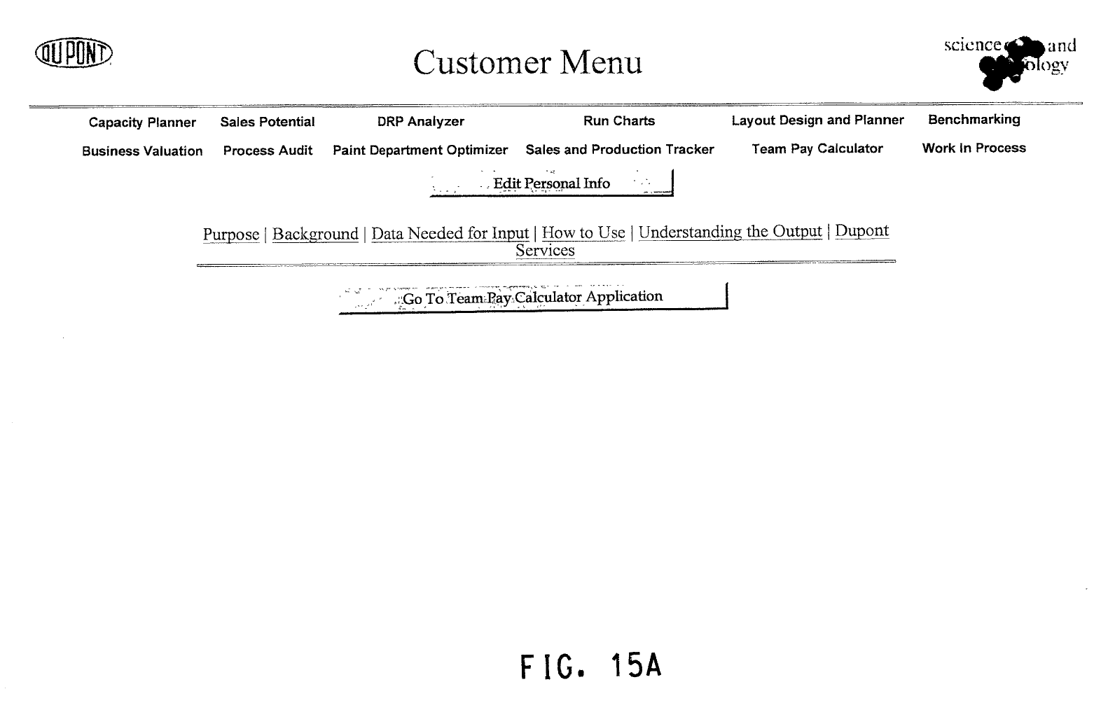

If customer computer 2 in step 132 selects a sales & production tracker business tool 1318 from menu 129, host computer 4 through step 134 then directs customer computer 2 to tool 1318. FIG. 14A shows screen shots of sales & production tracker business tool 1318 and provides instructions for using the chosen business tool.

The following instructions are provided in FIG. 14A for sales & production tracker business tool 1318, which is used to keep a close watch on key processes the track performance of the paint department over a desired period, such as a month:

### “Purpose

The sales & production tracker business tool is designed to follow key processes on the sales and production side of the business, generally on a daily basis. If sales or production starts to lag, you can then work out a plan to generate more sales or repair more cars.

### Background

Due to the pressure from everyday activity, it is easy to lose site of how sales and production are performing in relationship to your projections or forecasts. You don't want to wait until the end of the month to address a shortfall in either the sales or production process. The sales & production tracker shows you, typically on a daily basis, how you are doing versus your plans. If you are selling more than you are producing then you know you are going to have to make some adjustments on the production side to enable you to process the additional business. If you are lagging on the sales side then you know you need to do what is possible to get more business. This critical balance needs to be monitored frequently to prevent problems at the end of the month.

### Data Needed for Input

You need the following data for the sales process for the period:

1. Total number of estimates prepared.

2. Monetary value of the estimates prepared.

3. Monetary value of the actual sales closed.

4. Sales forecasted for the review period.

You need the following data for the production process for the review period:

1. Number of repair orders (RO) completed.

2. Number of flag hours completed on these ROs.

3. Flag hours completed forecast.

4. Gross profit.

5. Total days late for RO's completed.

6. Revenue generated.

7. Revenue forecasted.

### How to Use

Enter the sales and production data each morning from the previous day. Ideally your department personnel can bring their part of the data to the morning meetings. Check how you are performing vs. your forecast and then make plans appropriately to ensure you meet your month-end projections.

### Understanding the Output

Sales Process: If your batting average is low then you want to focus on what your estimator needs to do to close more sales. Maybe he needs training maybe it is a personality issue or he just does not ask for the sale. If you get a lot of jobs that exceed your projections then you may need to add resources to production to meet reasonable goal dates.

Production Process: If you flag hours are low, then there could be some process problems in the shop. If you are consistently late in your delivery performance, you may need to provide more resources to meet the target dates. If you are not meeting daily revenue targets even though you are producing the targeted flag hours, you may not be focussing on getting enough parts business. The main issue is not to wait until the end of the month and be surprised.”

Step 150 for sales & production tracker business tool 1318 includes the following steps:

calculating average number of estimates prepared per day by using the following formula:

$$\frac{\begin{matrix}Total estimates prepared \\ during the review period\end{matrix} }{\begin{matrix}Number of days in the \\ review period\end{matrix}} \qquad ( xxxiii )$$

calculating percent estimating efficiency by using the following formula:

$$100 \times \frac{Daily sales completed}{Daily sales estimated} \qquad ( xxxiv )$$

calculating average number of days late per day by using the following formula:

$$\frac{Total days late to date}{Number of jobs completed to date} ; and \qquad ( xxxv )$$

tabulating daily the average number of estimates, the percent estimating efficiency, the average number of days late per day, year to date number of estimates prepared and year to date number of estimates completed.

The business solution for sales & production tracker business tool 1318 in step 156 includes tracking daily current performance of the business against a performance goal by adjusting production conditions to increase the percent estimating efficiency as close as possible to a goal estimating efficiency. FIGS. 14BA, 14BB, 14BC, 14CA, 14CB and 14CC show the screen shots of the tracking of sales and production done in accordance with sales & production tracker business tool 1318.

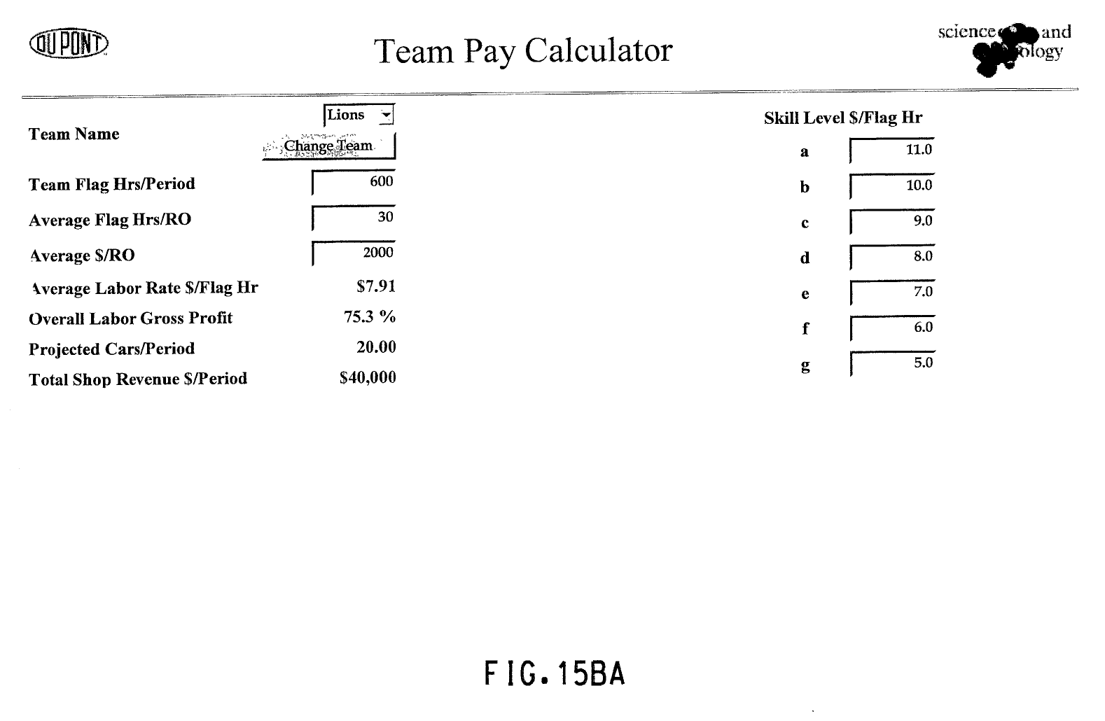

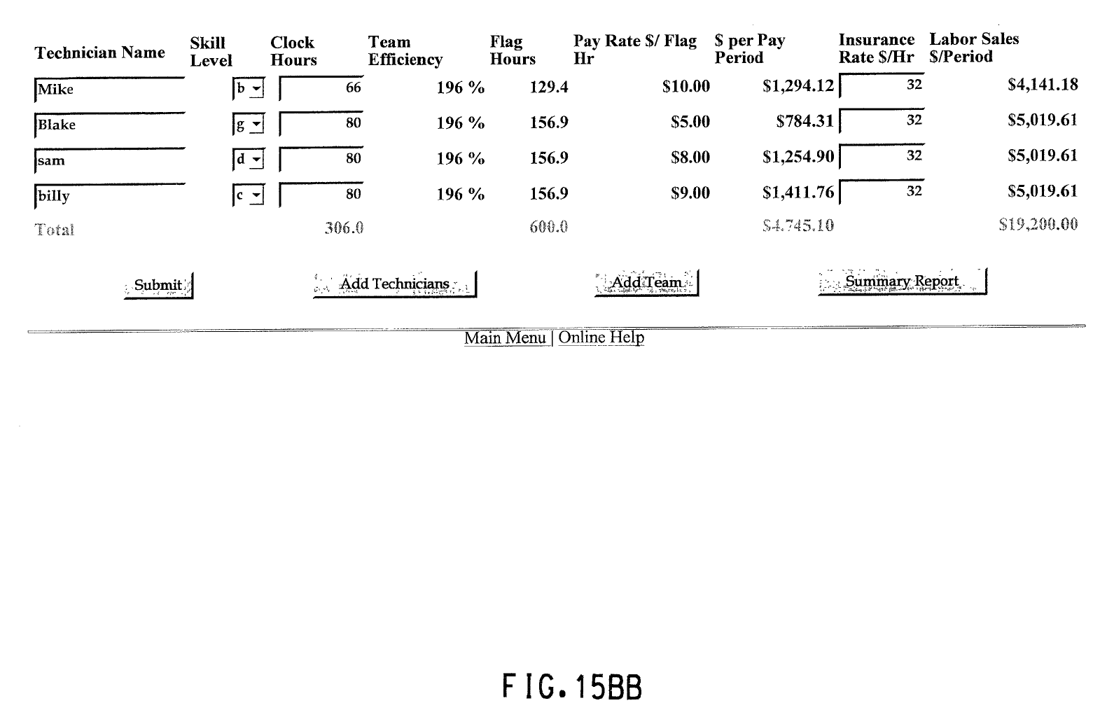

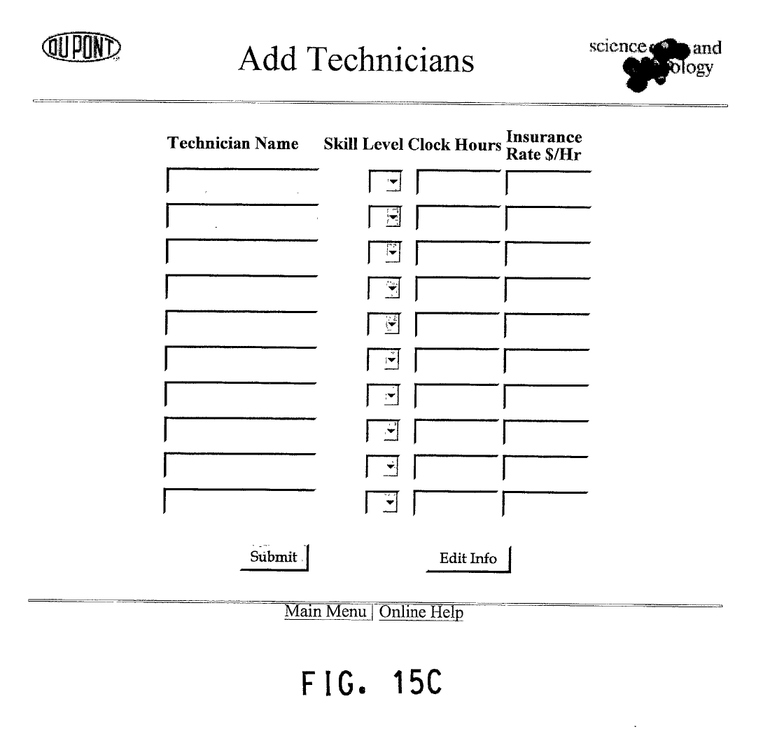

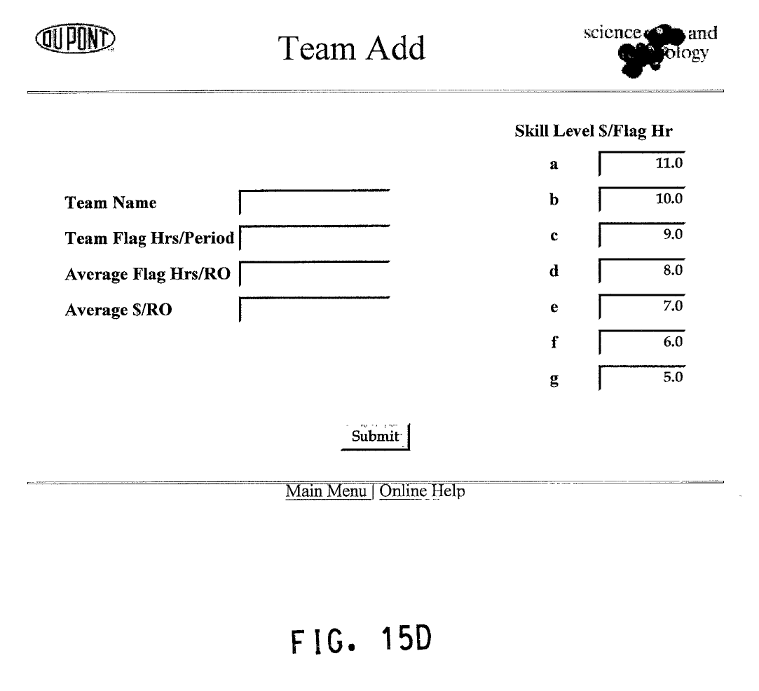

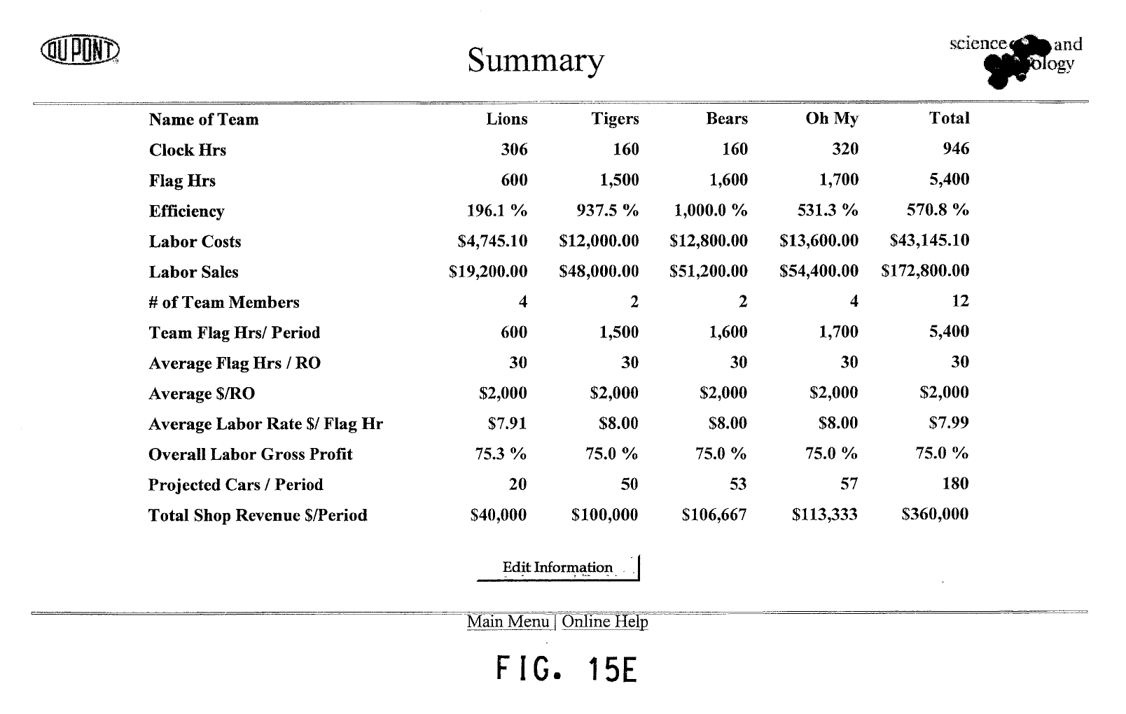

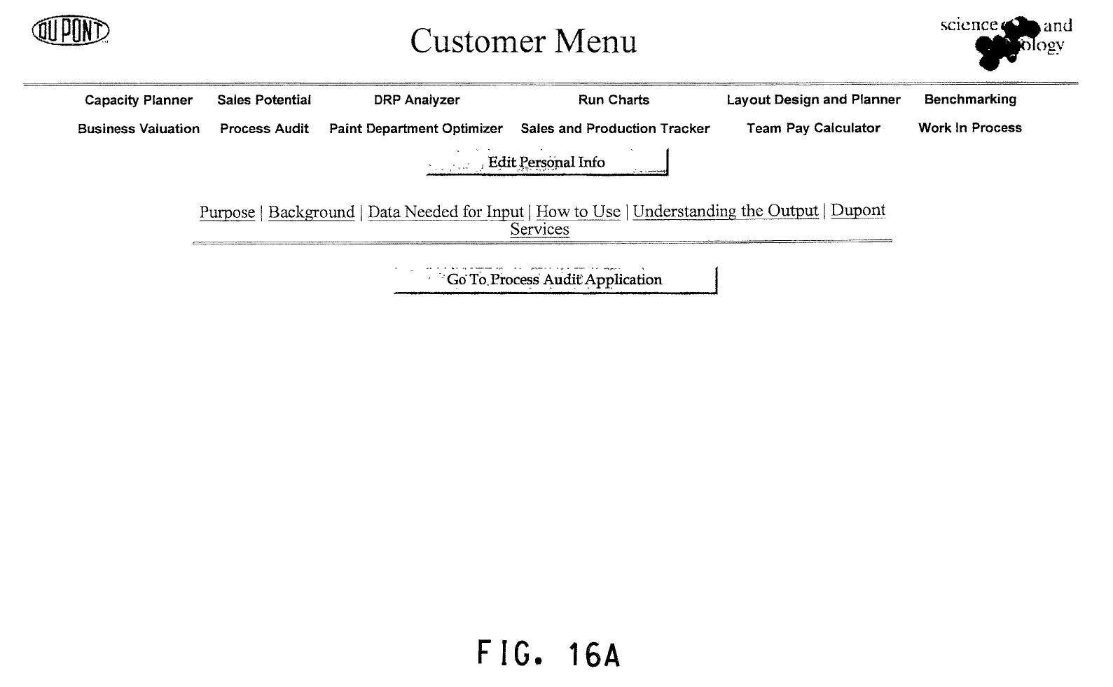

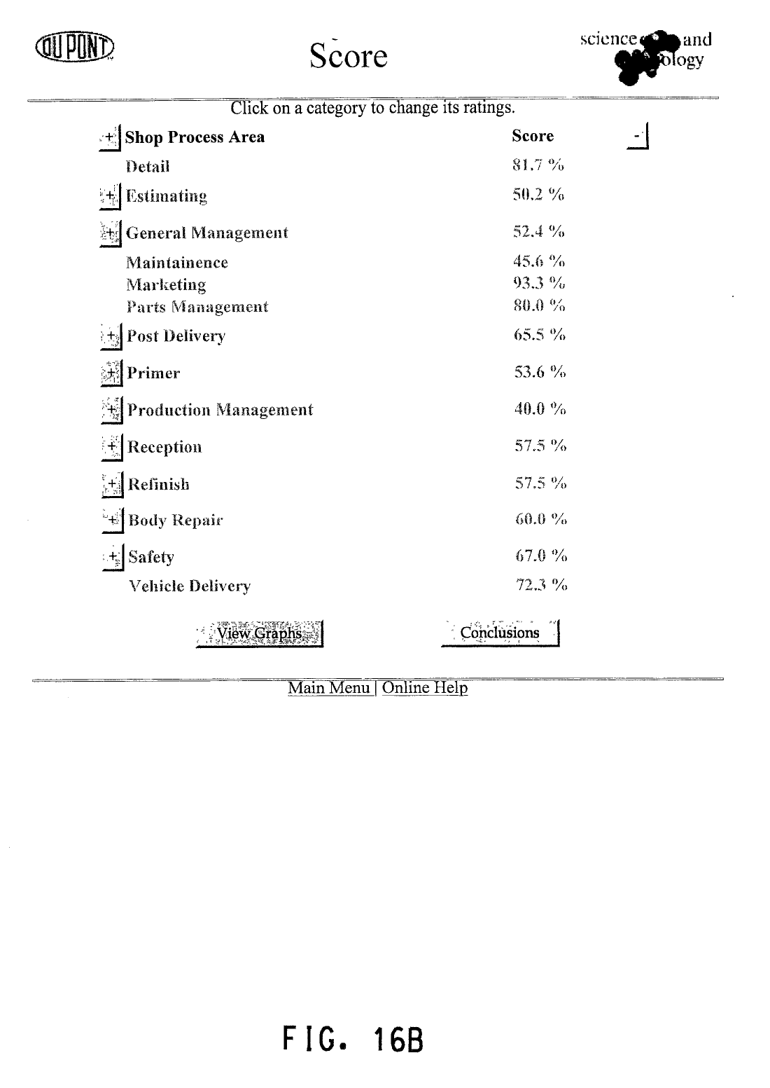

If customer computer 2 in step 132 selects a team pay calculator business tool 1320 from menu 129, host computer 4 through step 134 then directs customer computer 2 to tool 1320. FIG. 15A shows screen shots of team pay calculator business tool 1320 and provides instructions for using the chosen business tool.

The following instructions are provided in FIG. 15A for team pay calculator business tool 1320, which is used for optimizing your pay structure to get the maximum gross profit while paying your more skilled employees enough pay to retain them over the long term:

### “Purpose

The team pay calculator allows you to optimize your pay structure to get the maximum gross profit while paying your more skilled employees enough to retain them over the long term.

### Background

There are many ways to pay technicians in your shop, such as by providing incentives to increase their output. A team system is one way to maximize productivity and cooperation among technicians. This system requires good management skills to successfully implement it. Basically each technician is paid a flag hour rate based on his skill level but all the members of the team are posted with the same number of flag hours. As a result, everyone benefits from the productivity factor but your more skilled technicians earn more based on their higher flag hour rate.

### Data Needed for Input

You need the following data for each team:

1. Flag hour per period.

2. Average flag hour per repair order.

3. Average charge per repair order.

4. Pay rates for each team member.

5. Hours worked by each team member in the period.

6. The flag hour rate paid by the insurance company for each member on the team.

### How to Use

The following information is entered at the appropriate fields on the screen for the tool:

1. Name a team.

2. Enter the names of all the technicians on the team.

3. Enter the hourly pay rate per flag hour.

4. Enter average flag hour per RO.

5. Enter average repair order charge.

6. Enter the team flag hours for the period worked.

7. Enter the clock hours worked by each technician.

### Understanding the Output

You can try different pay structures and rates to see the impact on the overall gross profit. The idea is to pay the more skilled personnel higher wages and the less skilled personnel lower wages but give all of them a way to progress over time. You should be able to adjust your rates to increase your overall gross profit while creating a team environment where people benefit from helping each other.”

The screen shots of FIGS. 15BA and 15BB are used to enter the data. Step 150 for team pay calculator business tool 1320 includes the following steps:

calculating a team labor efficiency in a period by using the following formula:

$$\frac{Team flag hours in the period}{Team clock hours in the period} \qquad ( xxxvi )$$

calculating a team member salary in the period by using the following formula:

(Team labor efficiency)×(Team member hourly pay)×(The team clock hours in the period) (xxxvii);

calculating average team employee pay rate in the period by using the following formula for:

$$\frac{Team labor cost in the period}{Total team clock hours in the period} ; \qquad ( xxxviii )$$

calculating percent gross profit derived from the labor cost in the period by using the following formula:

$$100 \times \frac{\begin{matrix}Team labor sales - Team labor cost \\ in the period\end{matrix}}{Team labor sales} ; and \qquad ( xxxix )$$

calculating projected cars repaired in the period by using the following formula:

$$\frac{Team flag hours per period}{Team flag hours per car} . \qquad ( xxxx )$$

The business solution for team pay calculator business tool 1320 in step 156 includes:

optimizing percent labor gross profit of the business by adjusting the team member hourly pay of the member in the team. Thus, as shown in the screen shots in FIGS. 15C and 15D, one can add or subtract teams or technicians on a team. Then, team pay calculator business tool 1320 can provide a summary of the “what if” results, as shown in the screen shot of FIG. 15E.

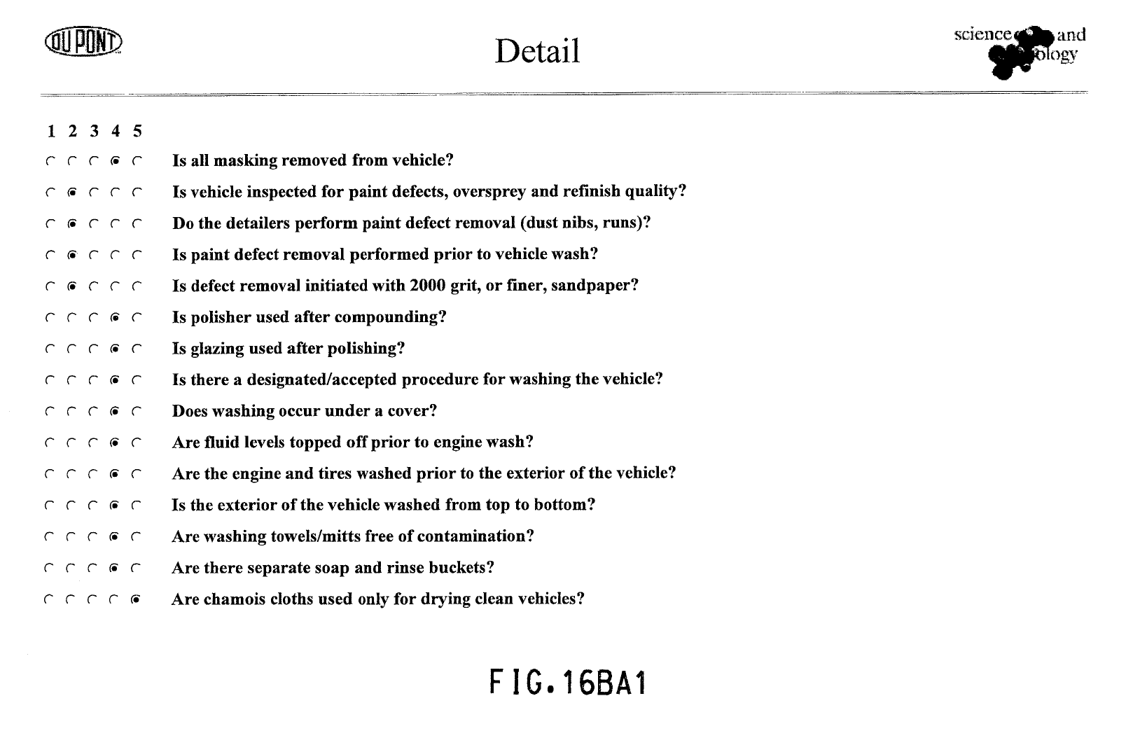

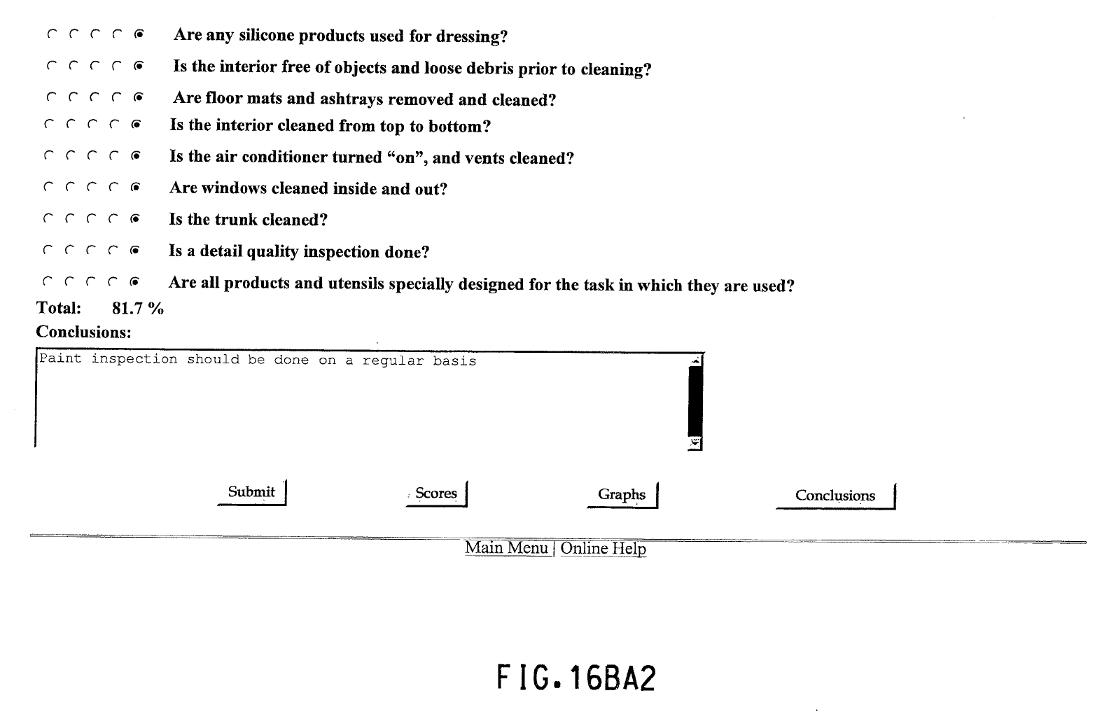

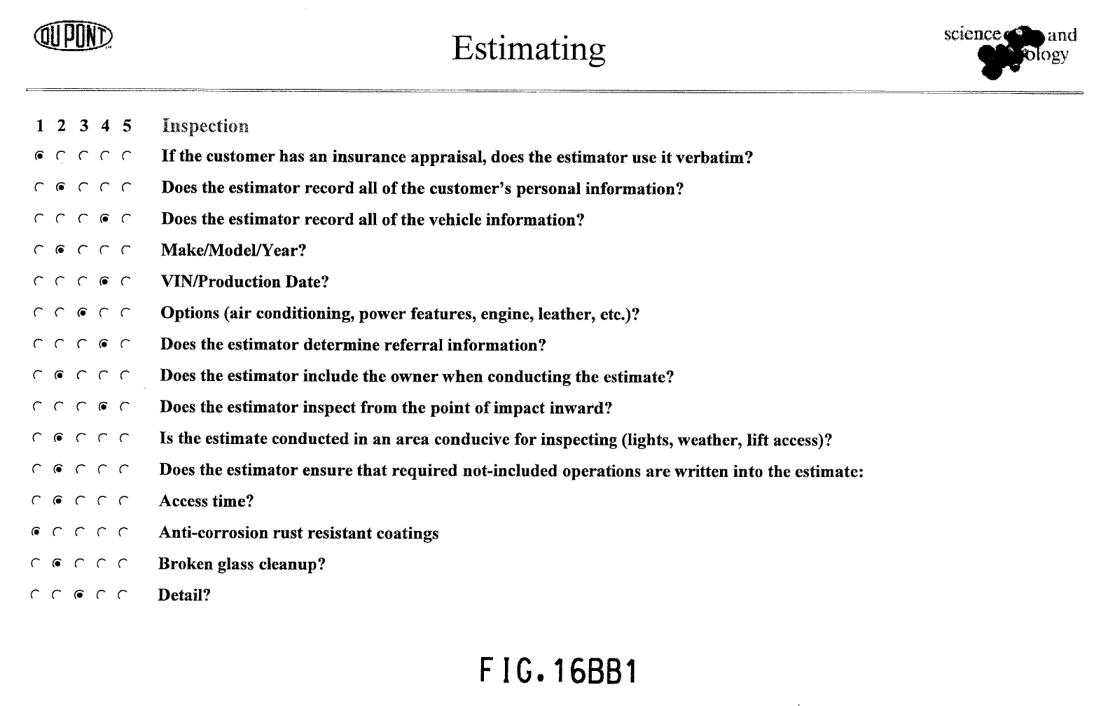

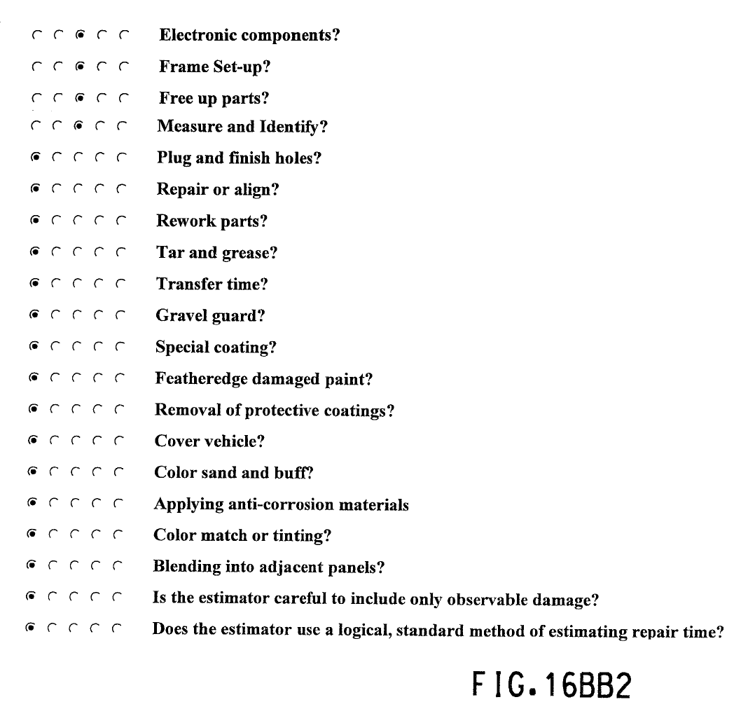

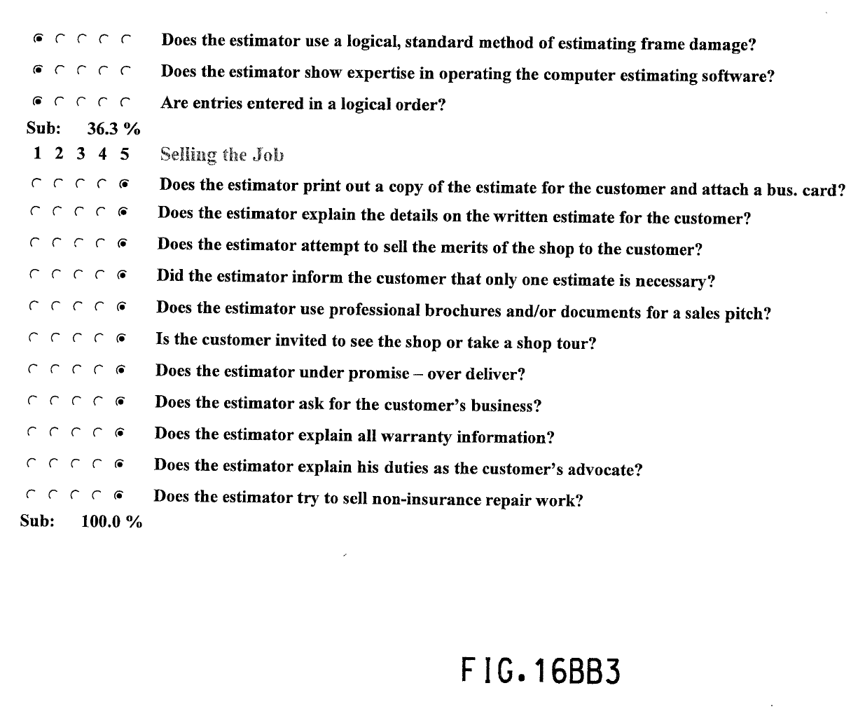

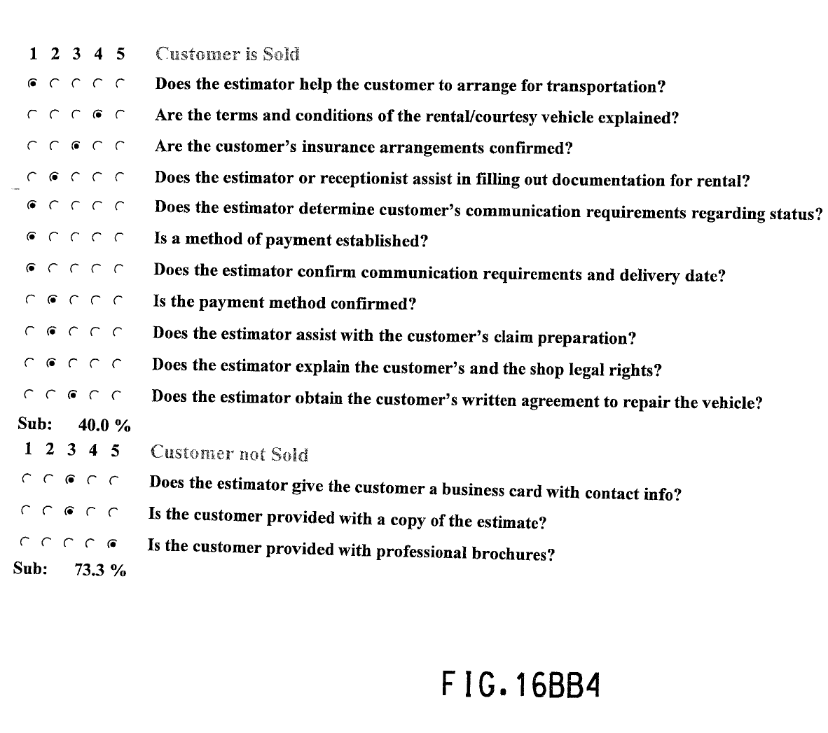

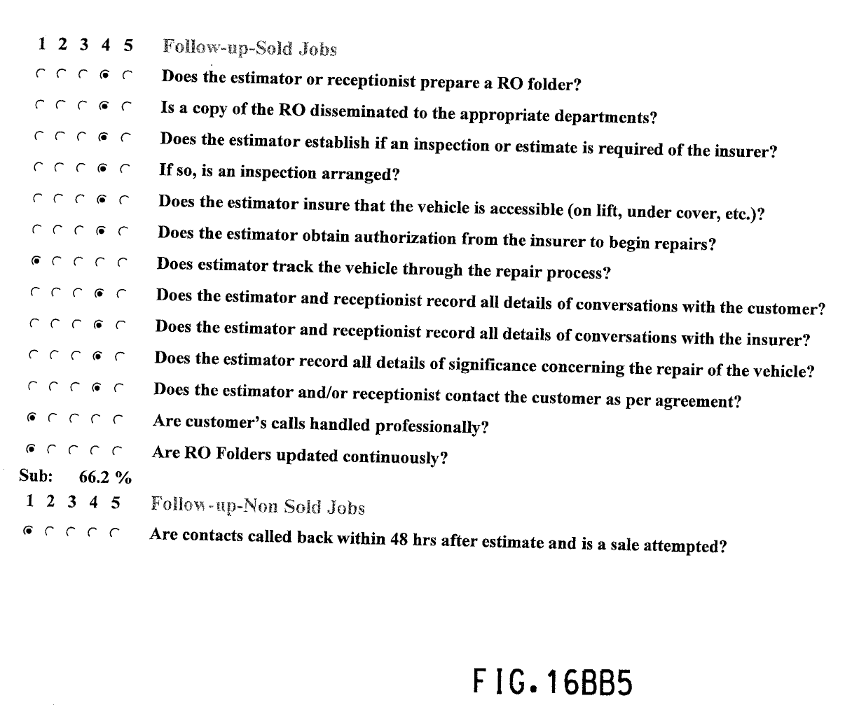

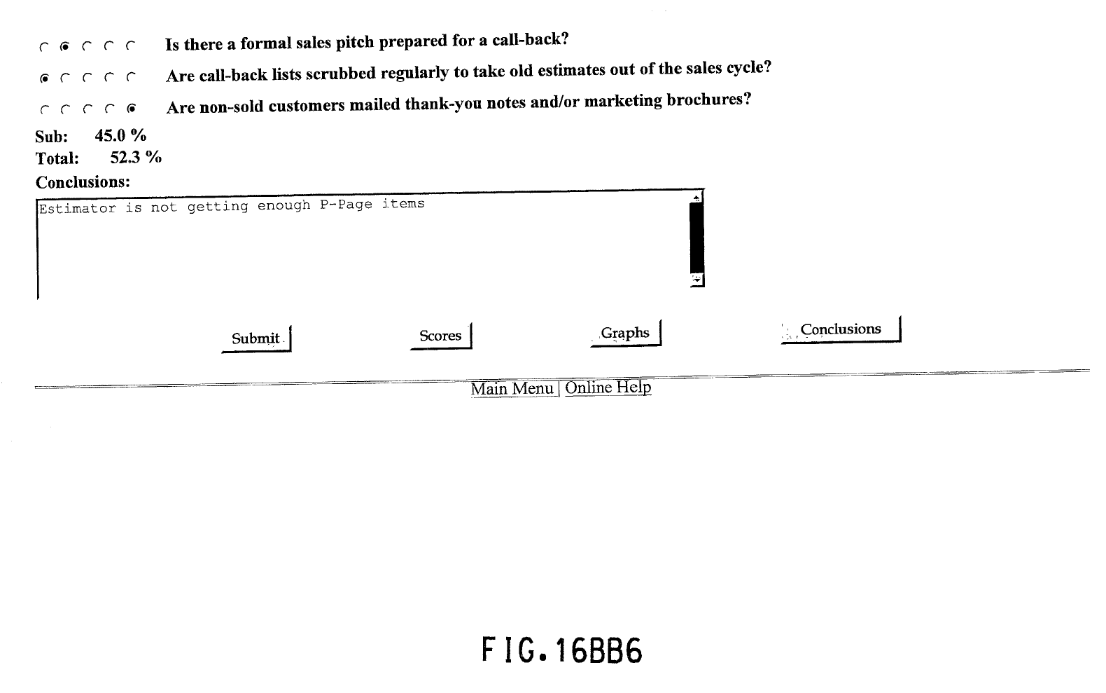

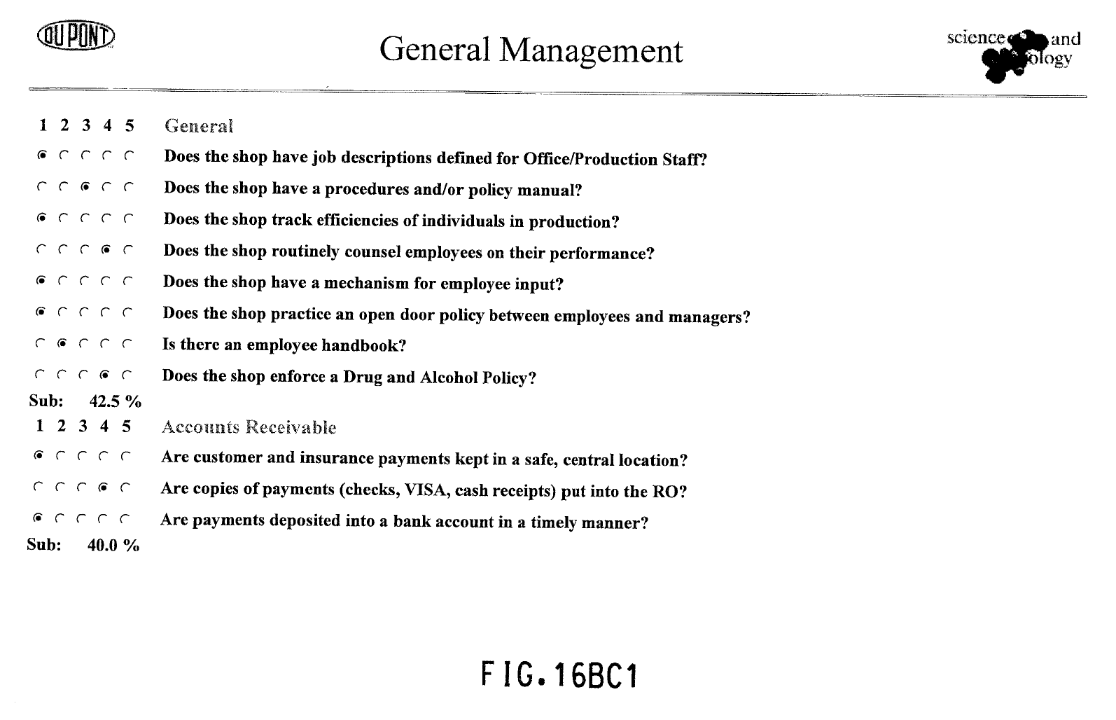

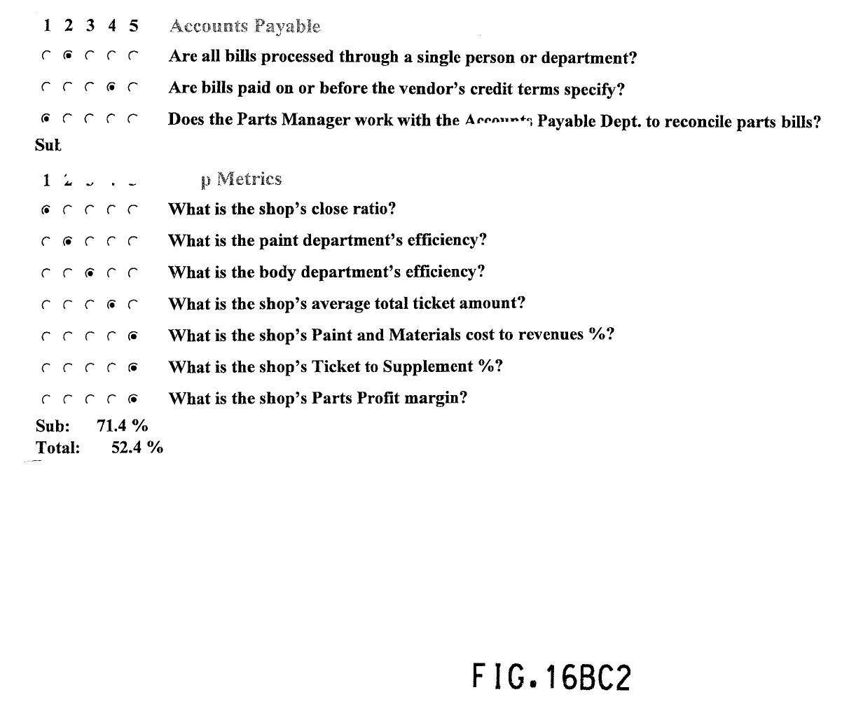

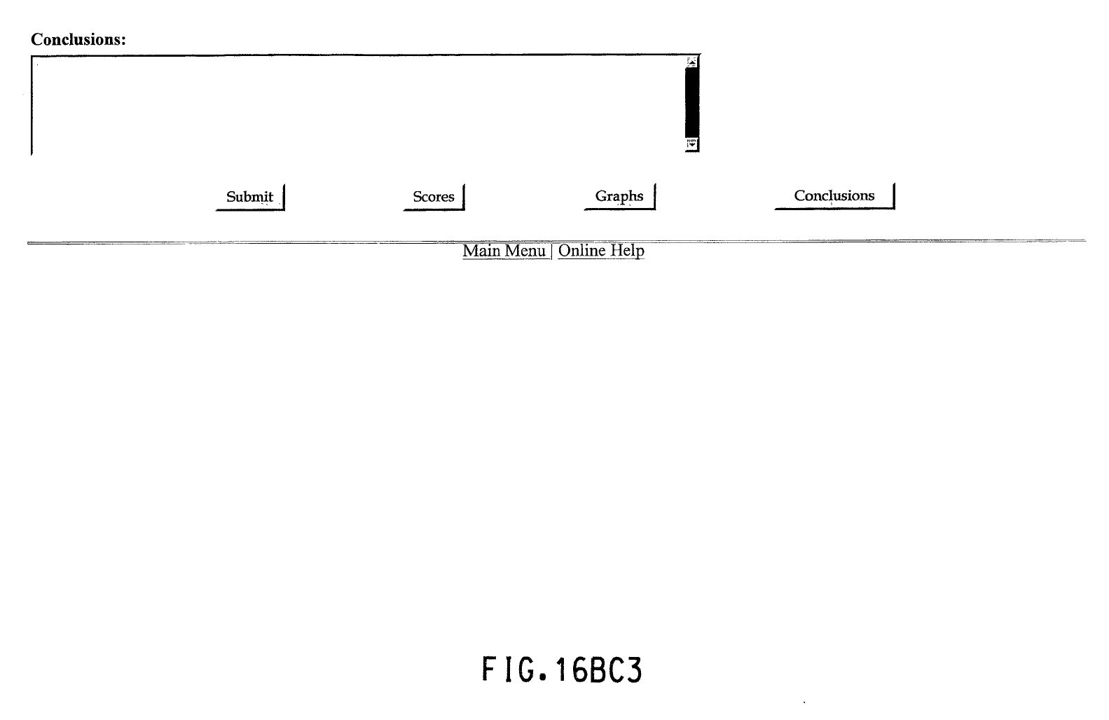

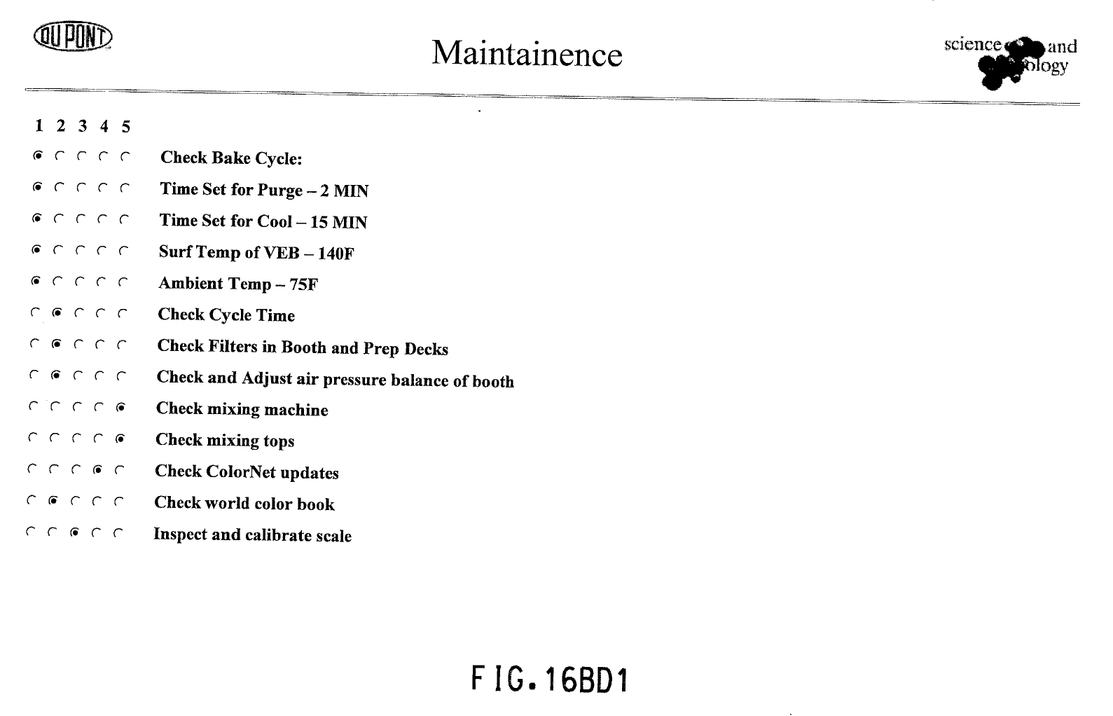

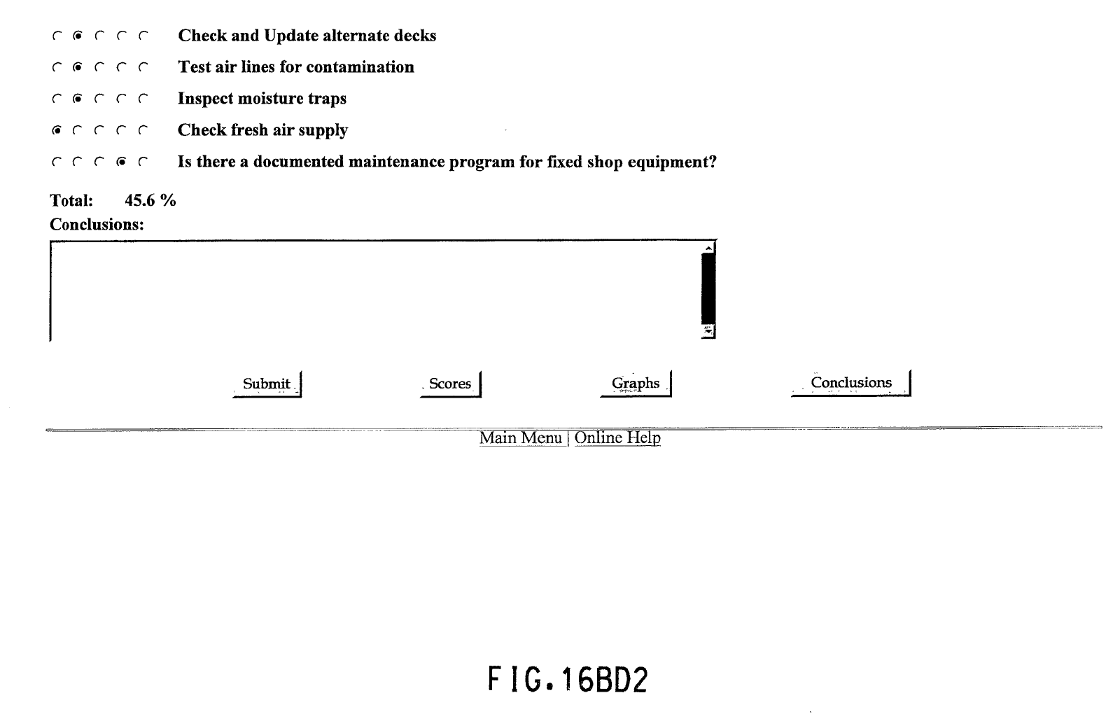

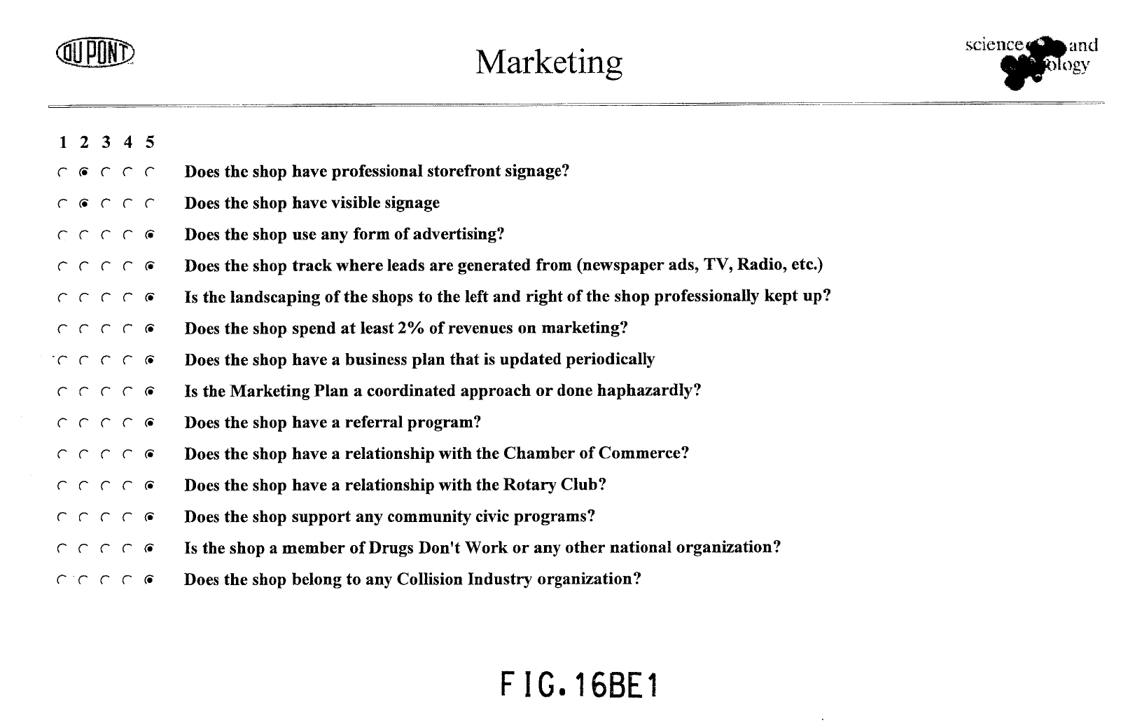

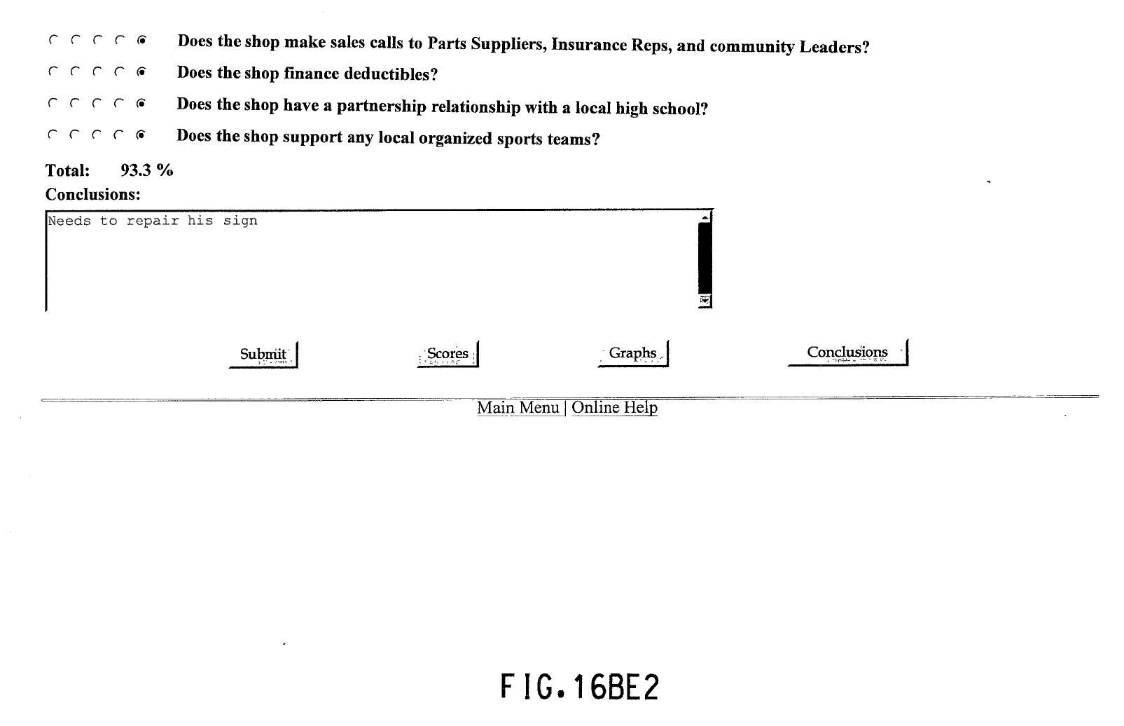

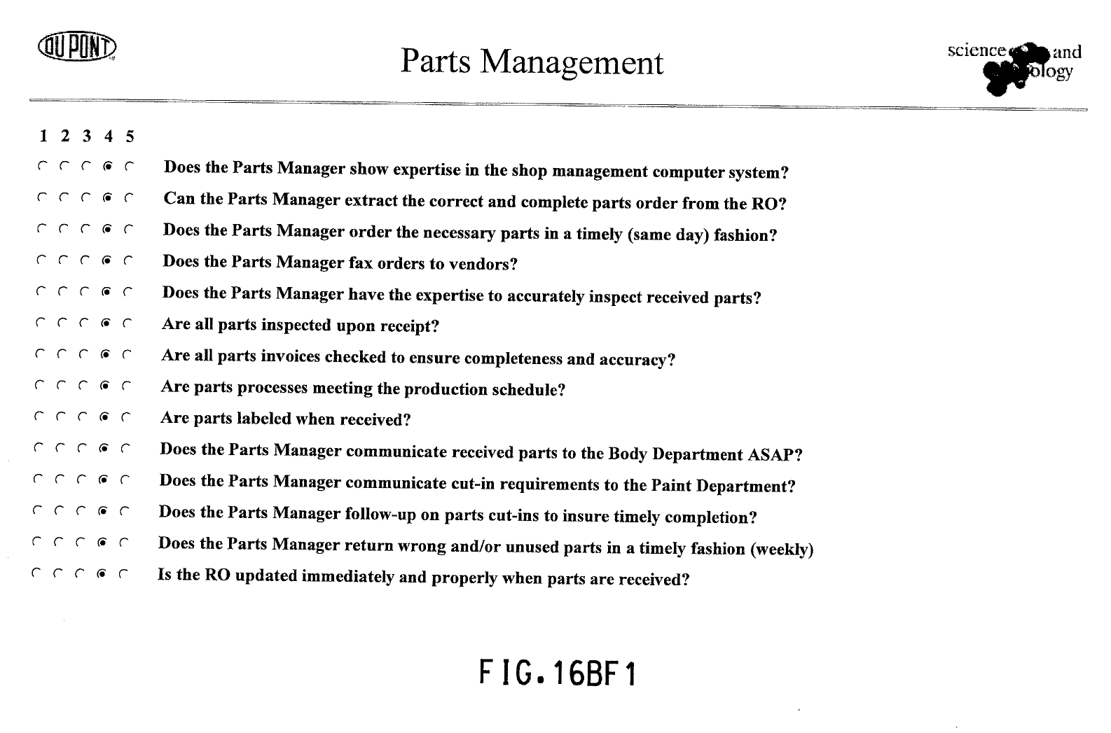

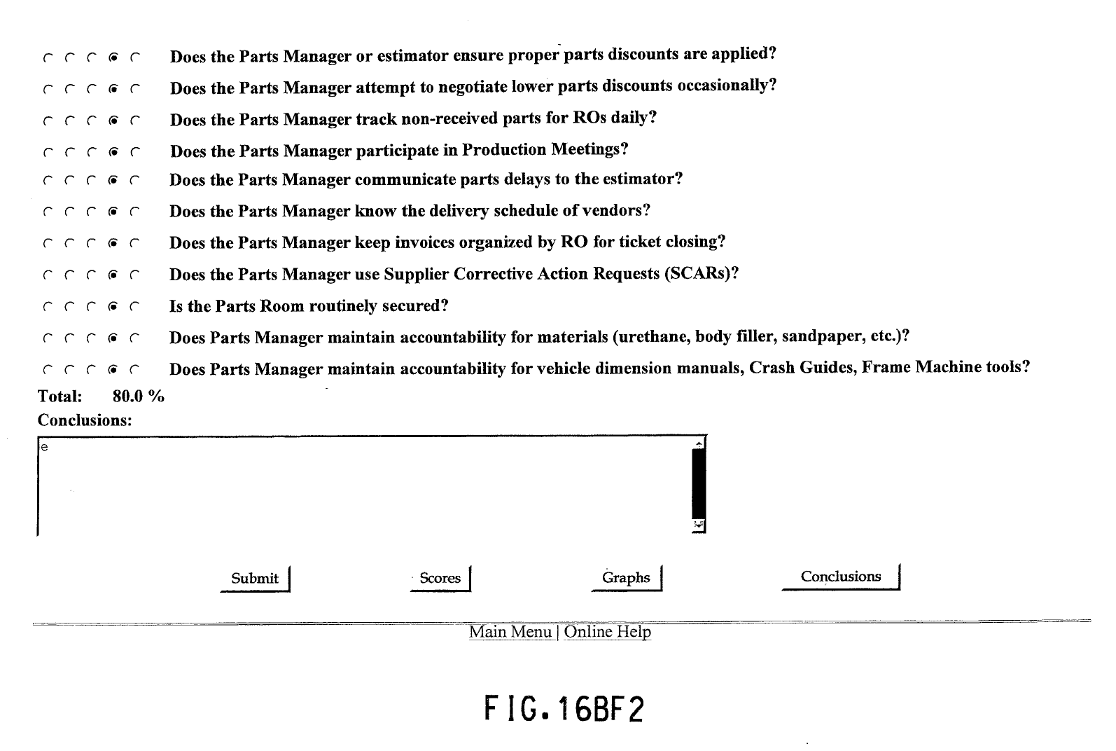

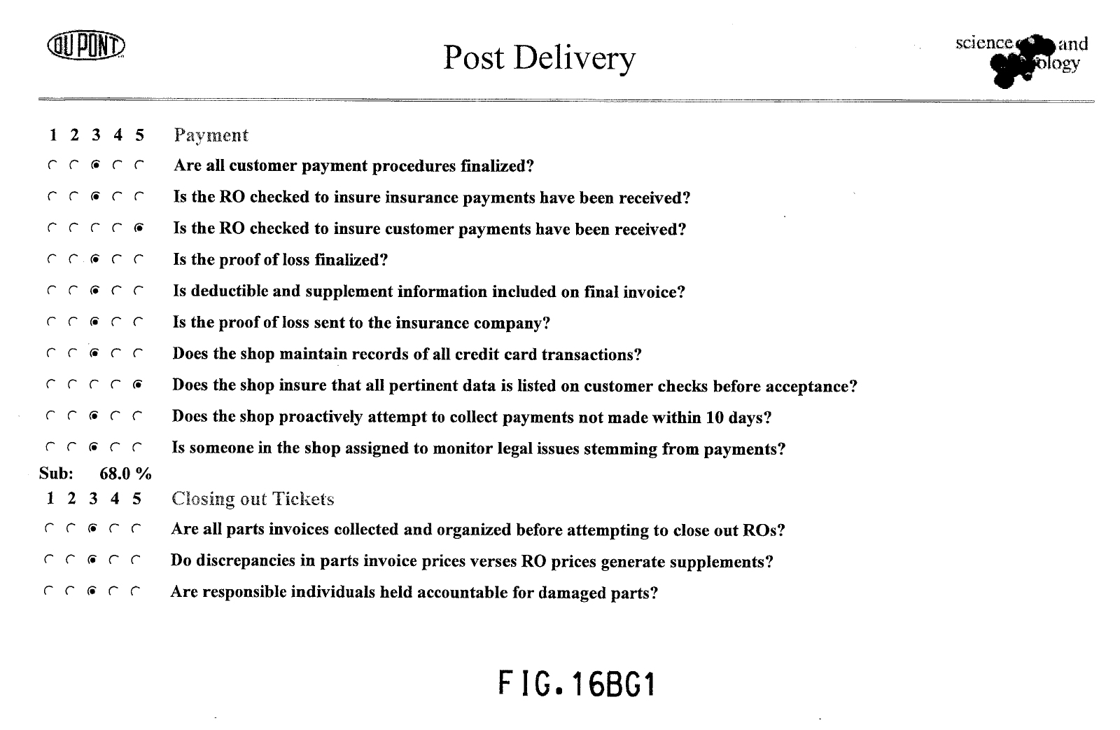

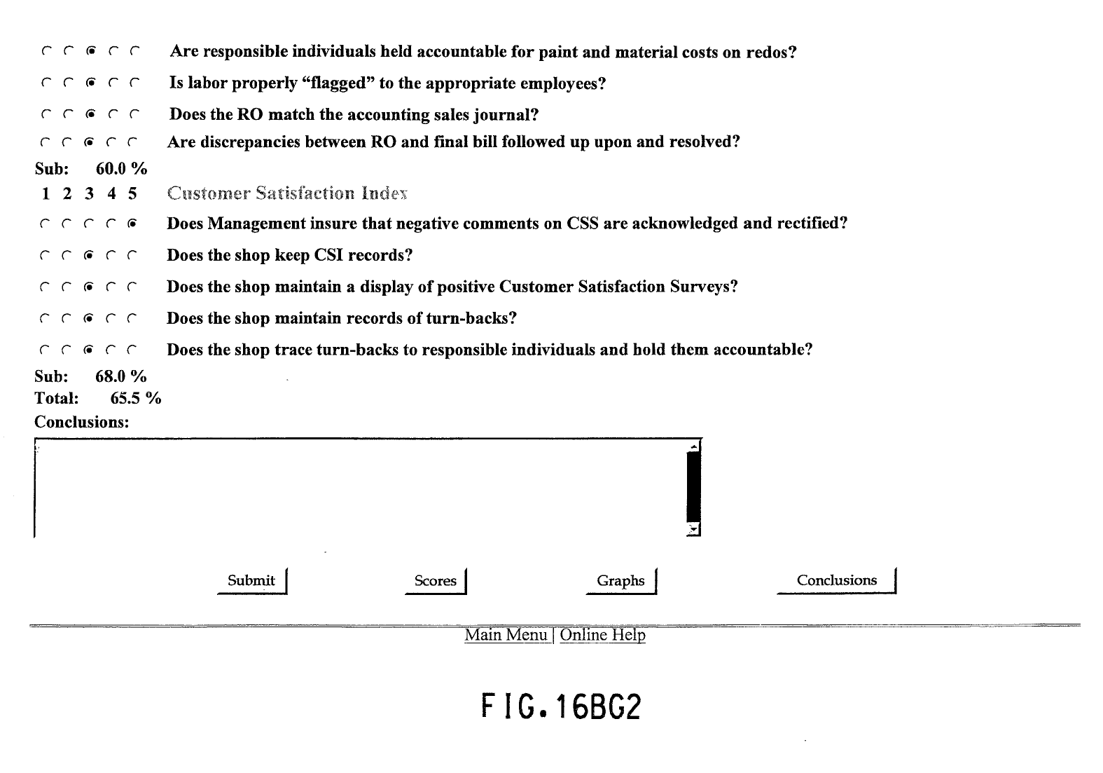

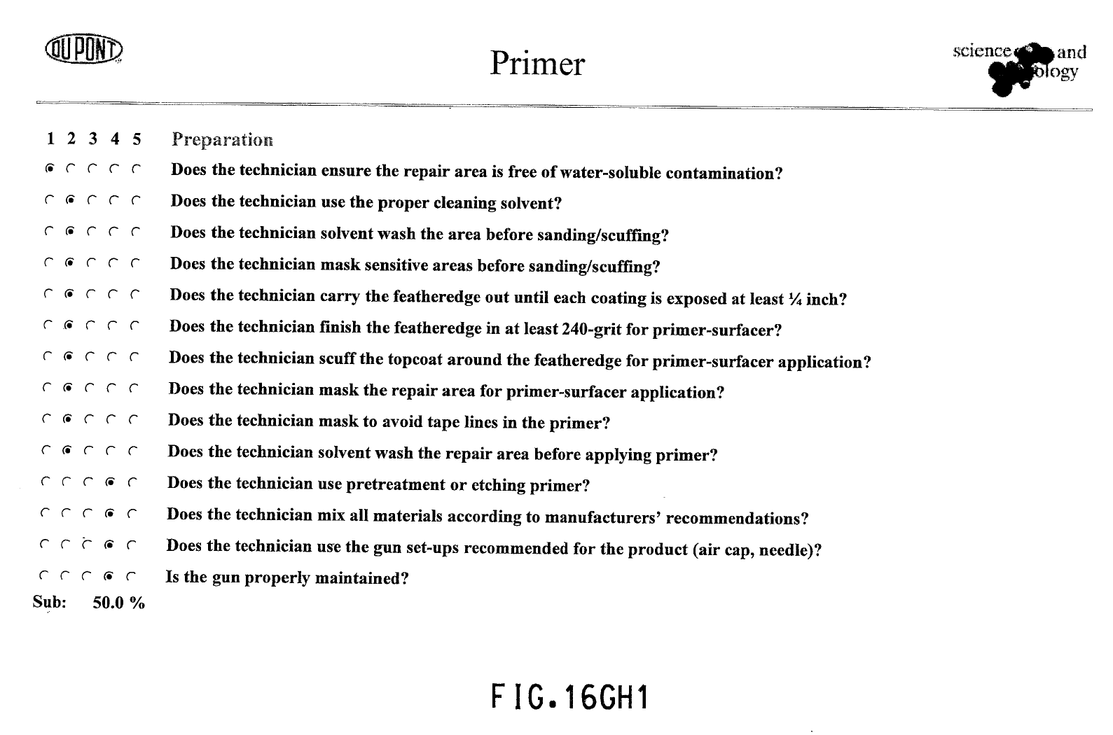

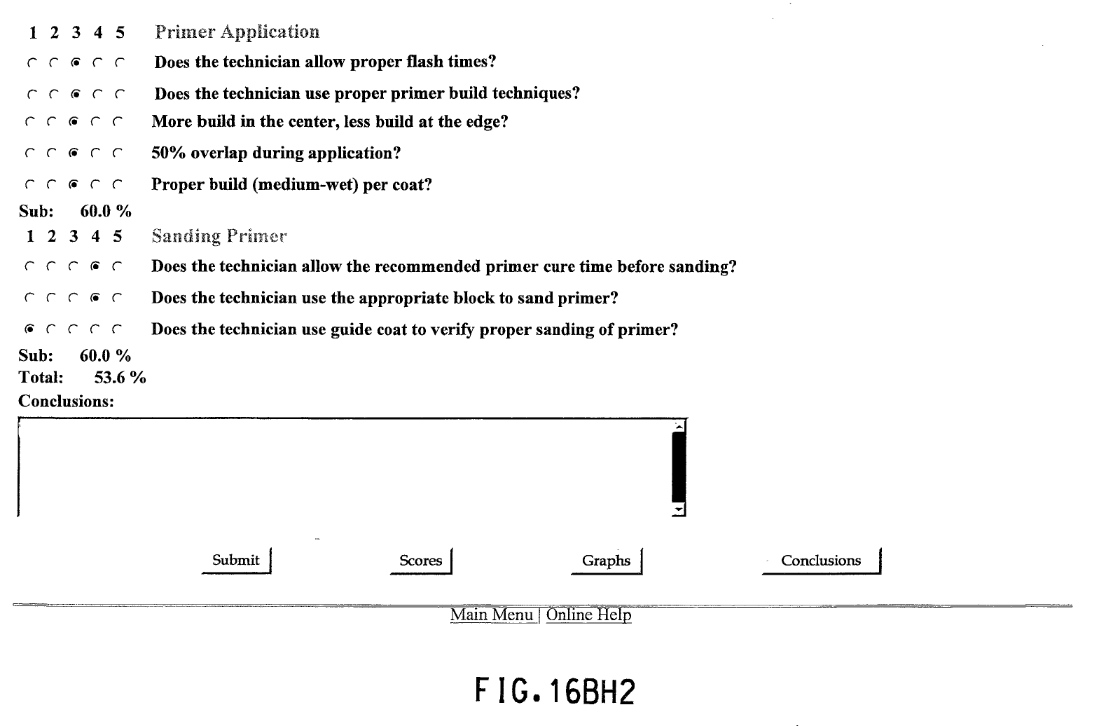

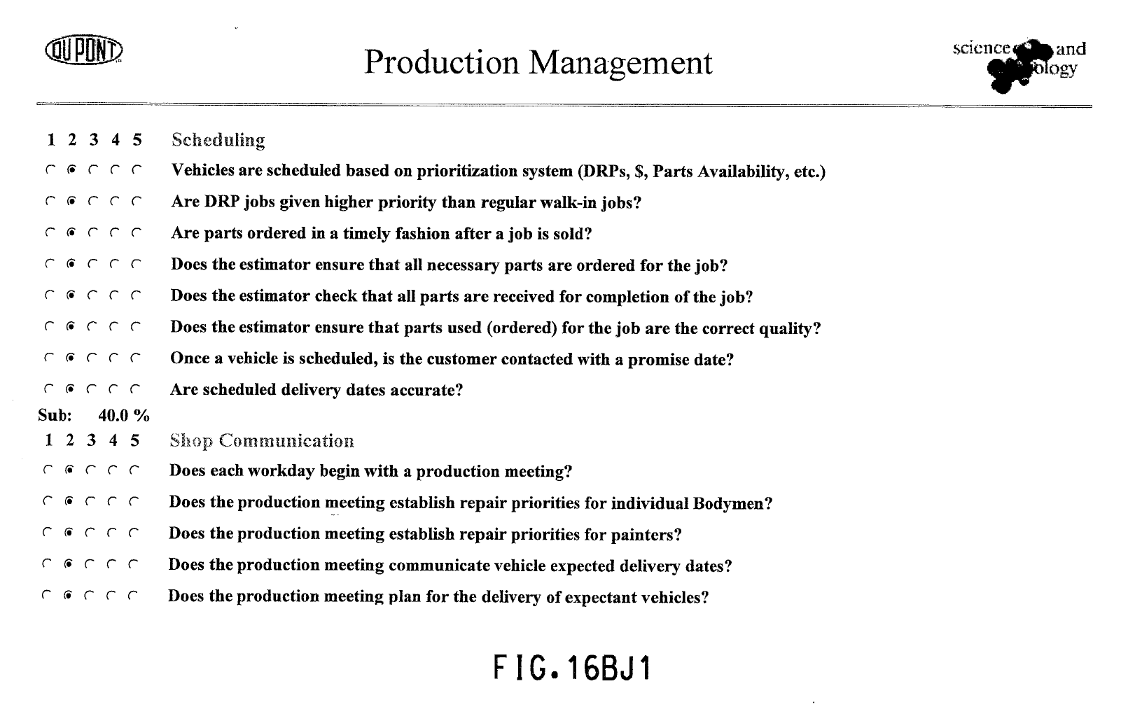

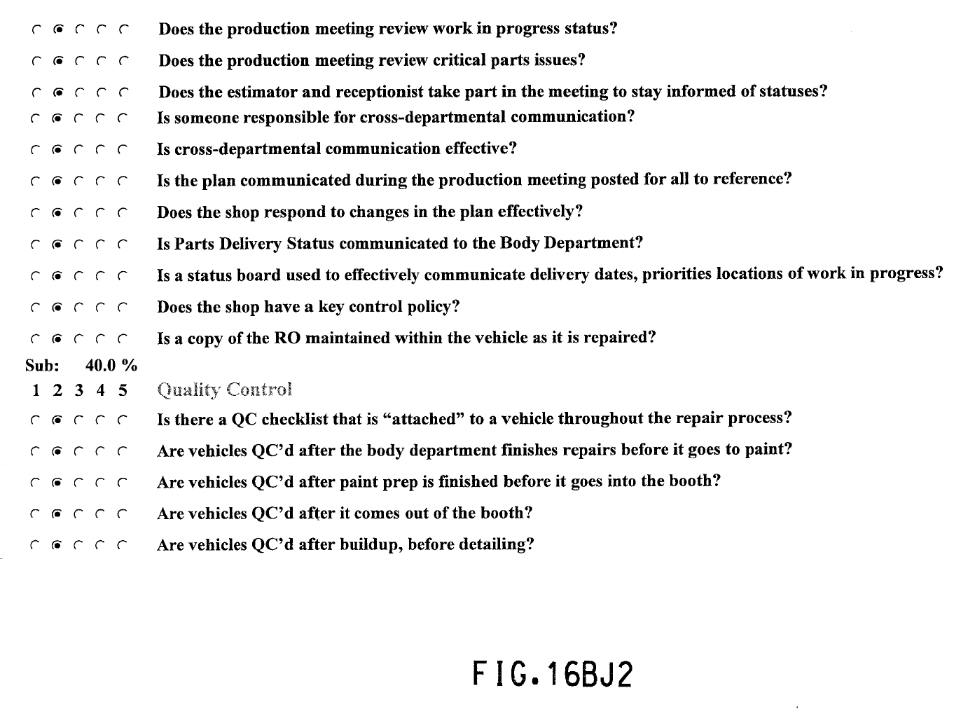

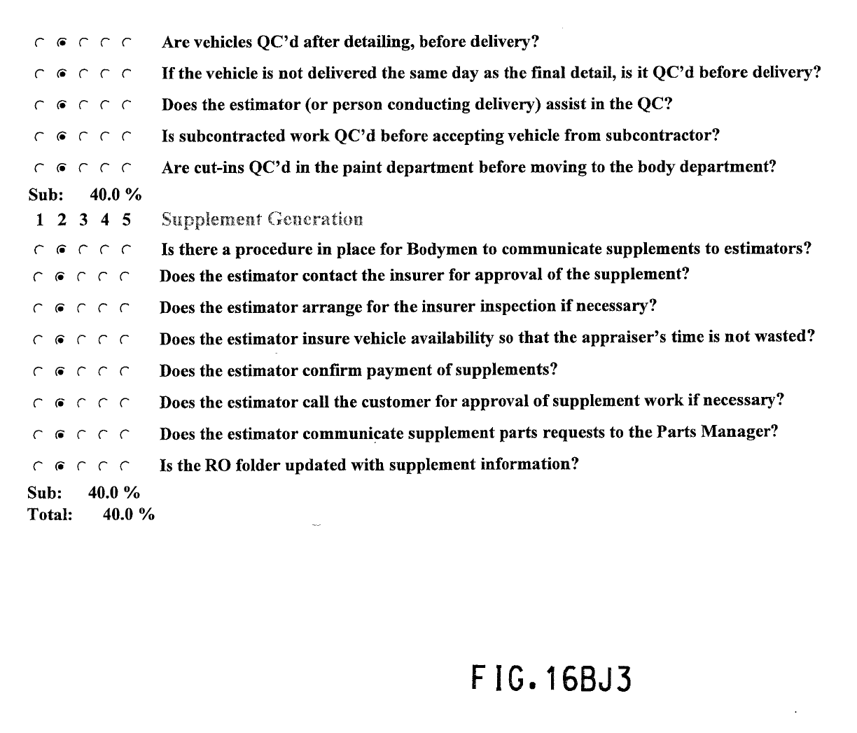

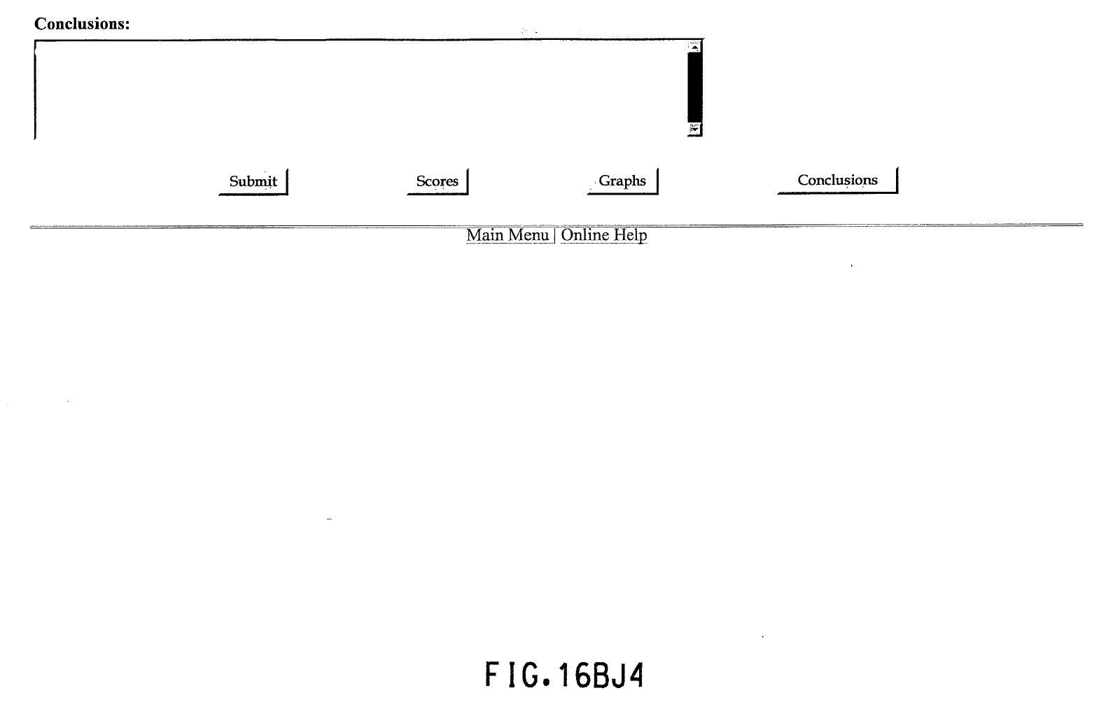

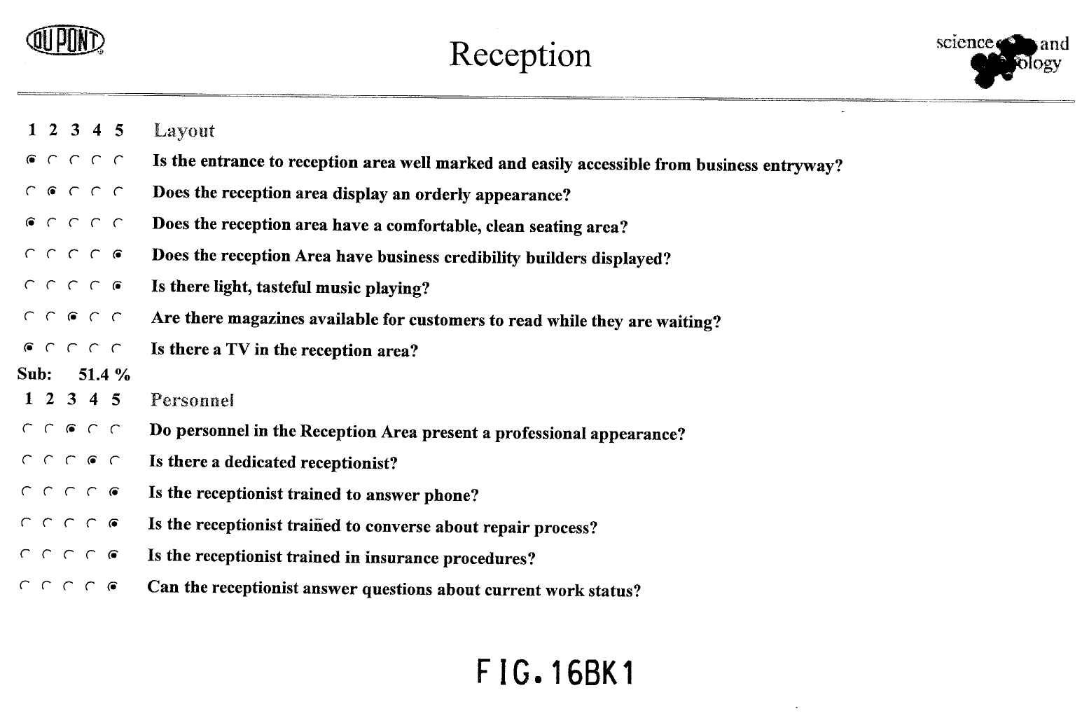

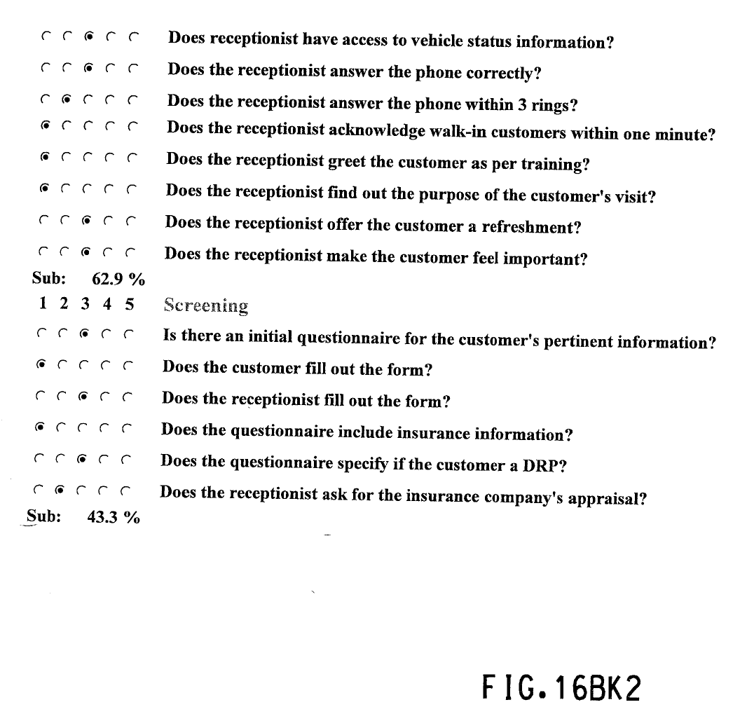

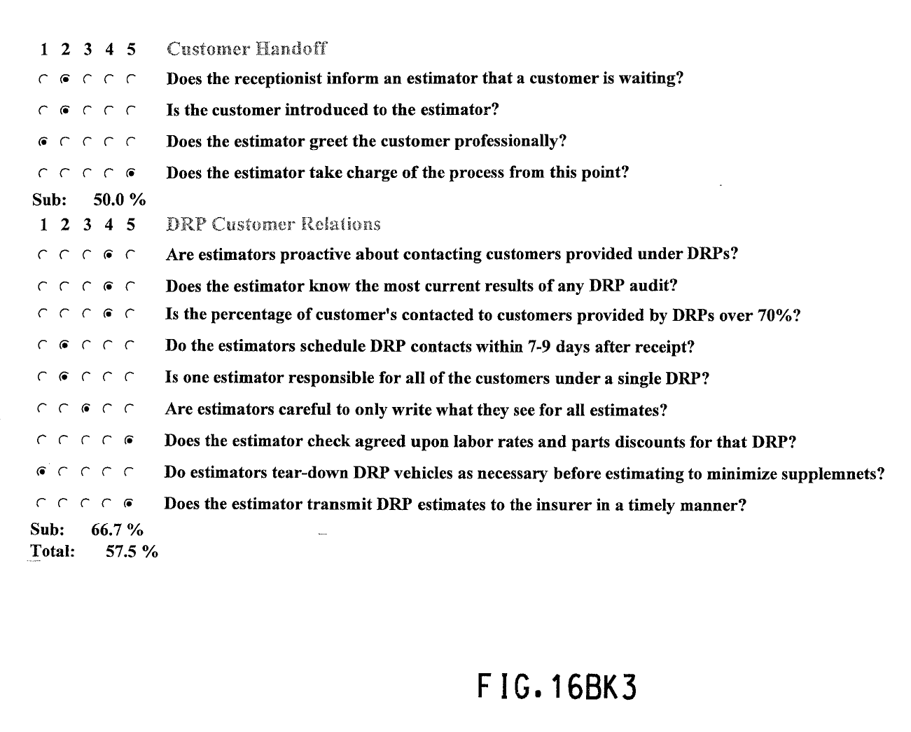

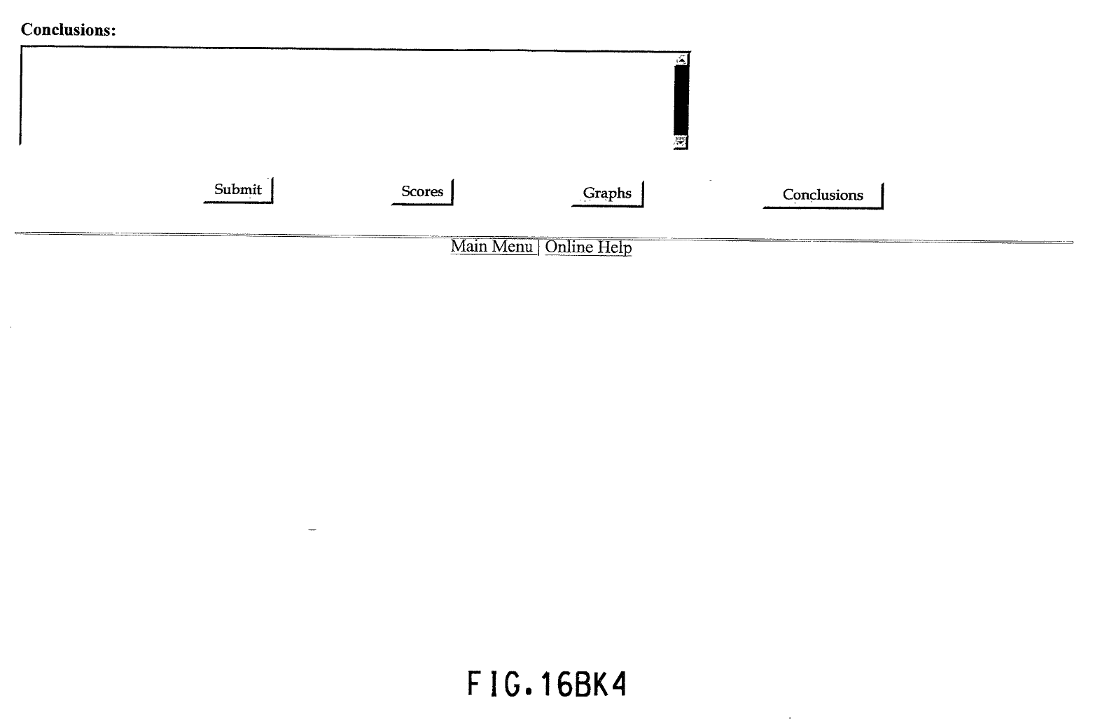

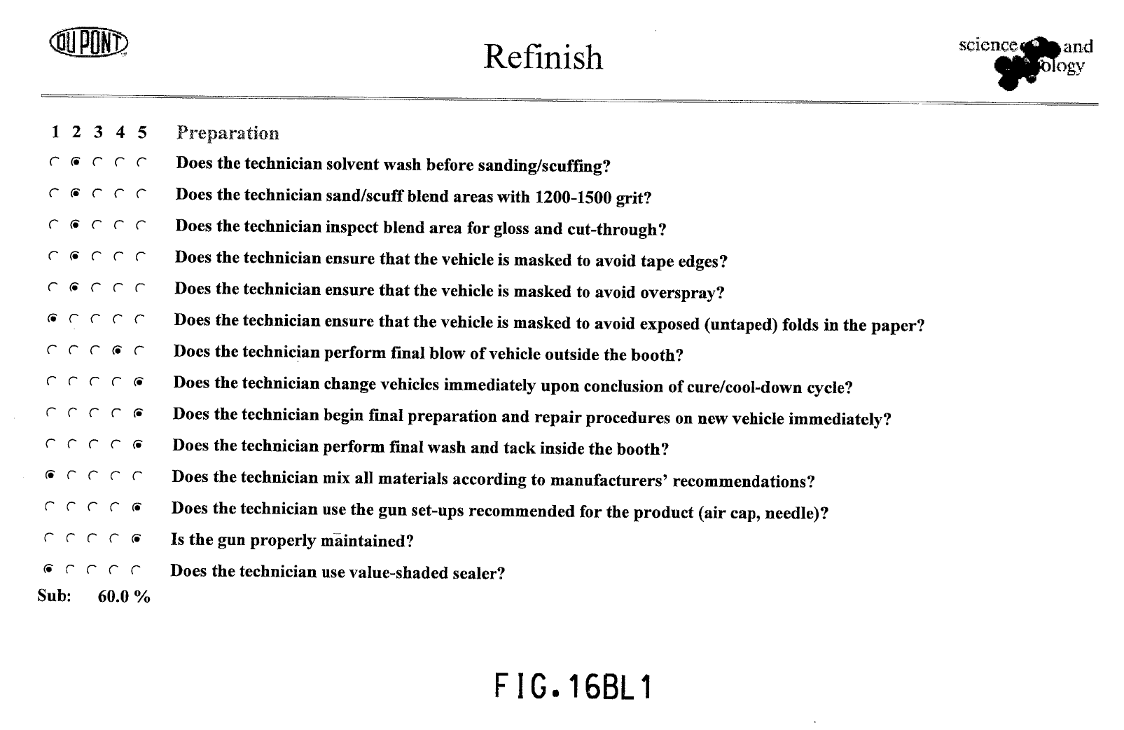

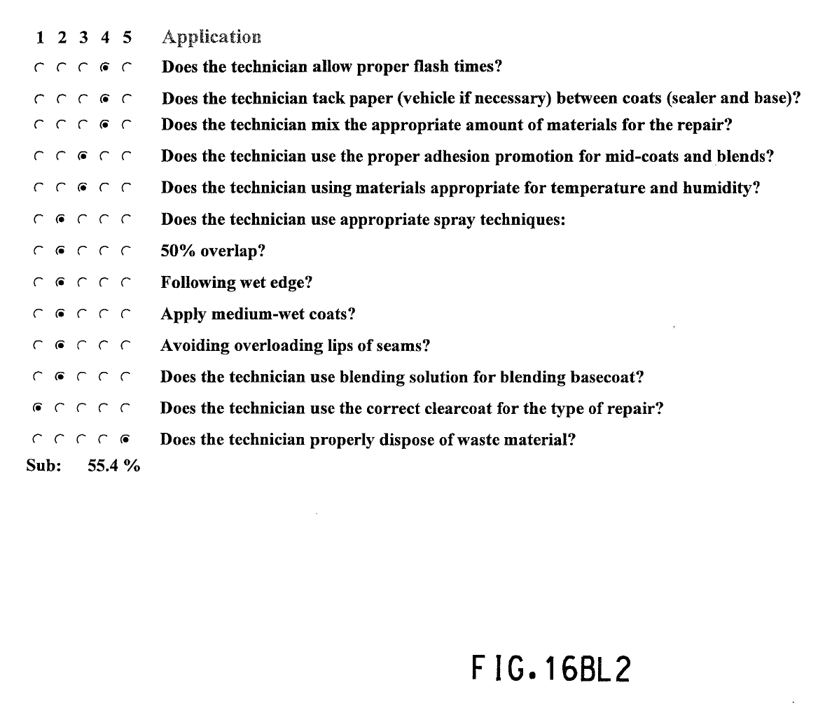

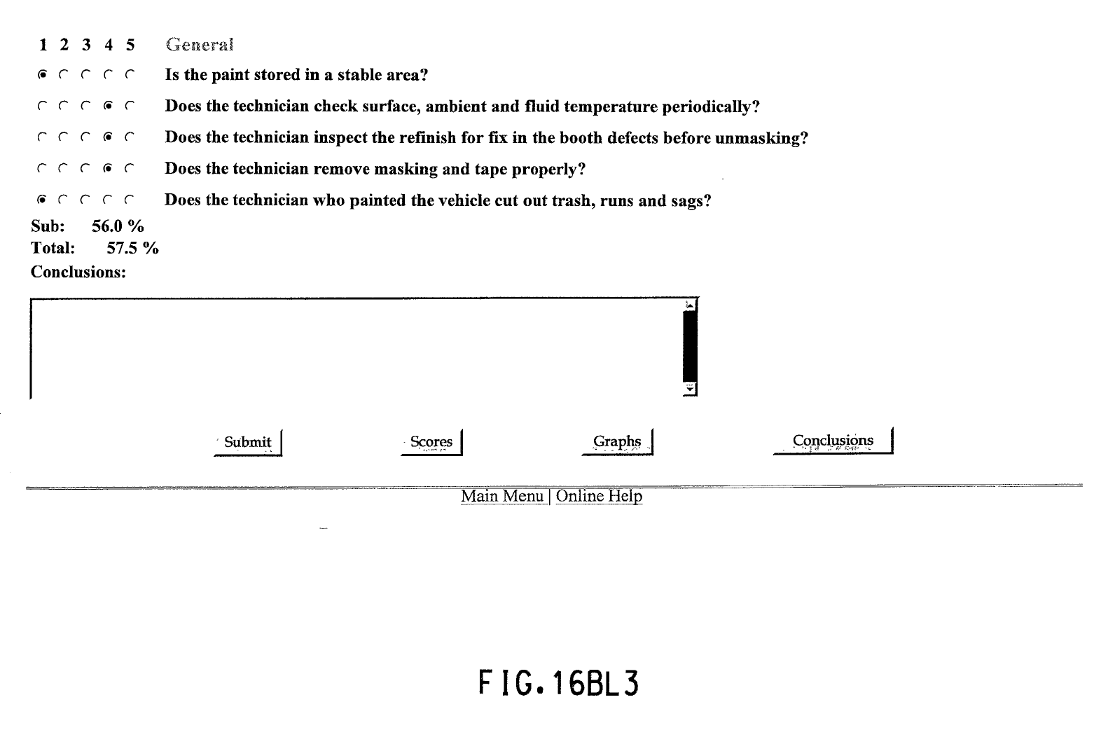

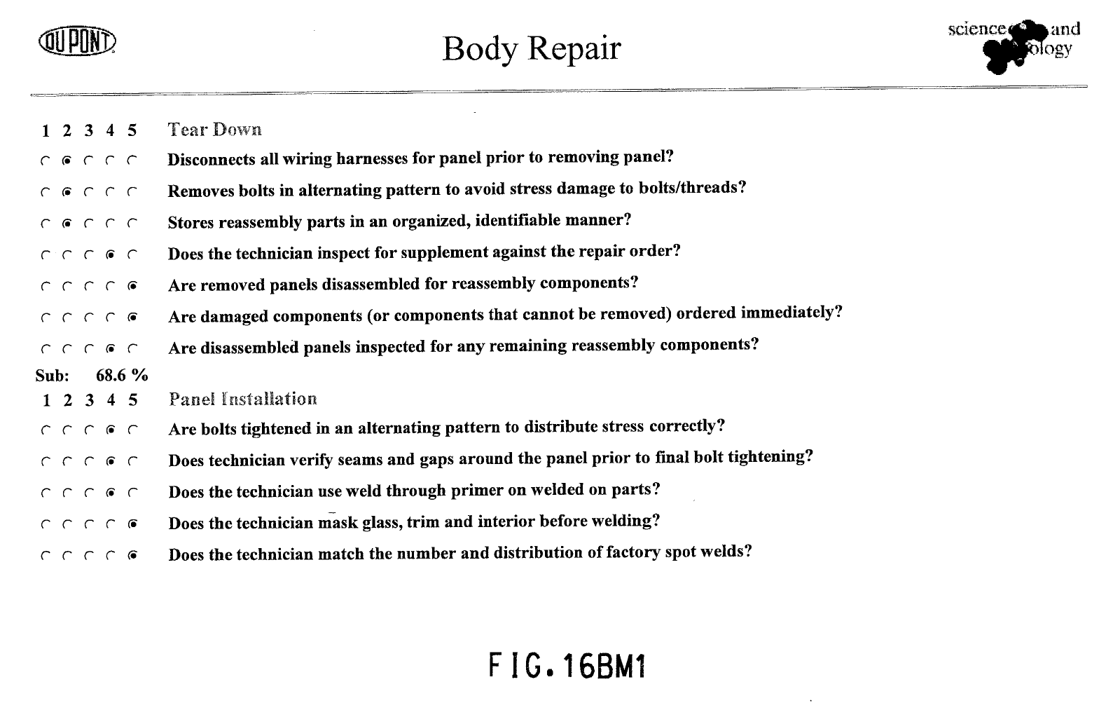

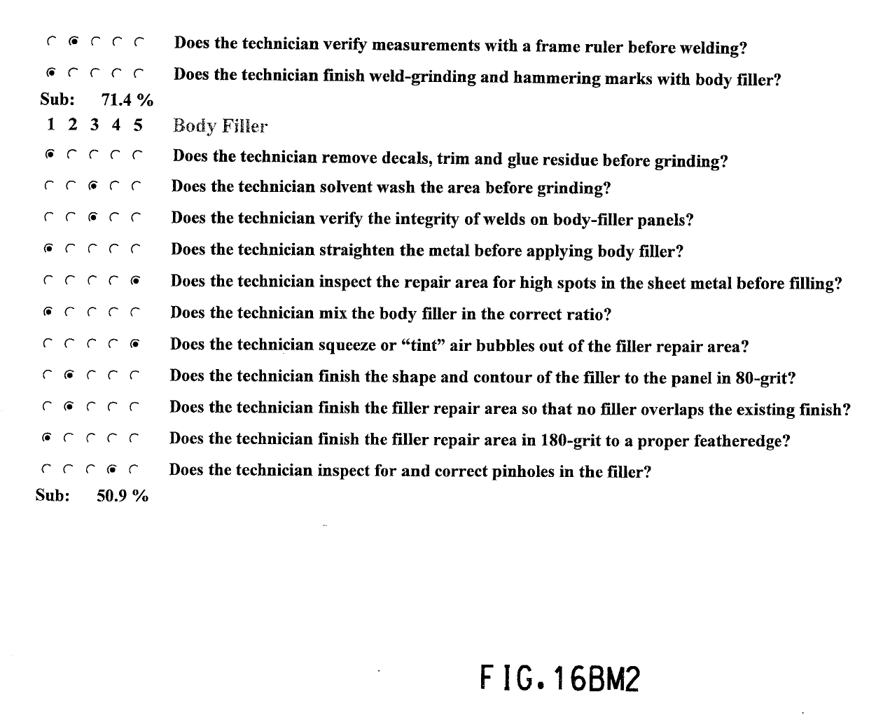

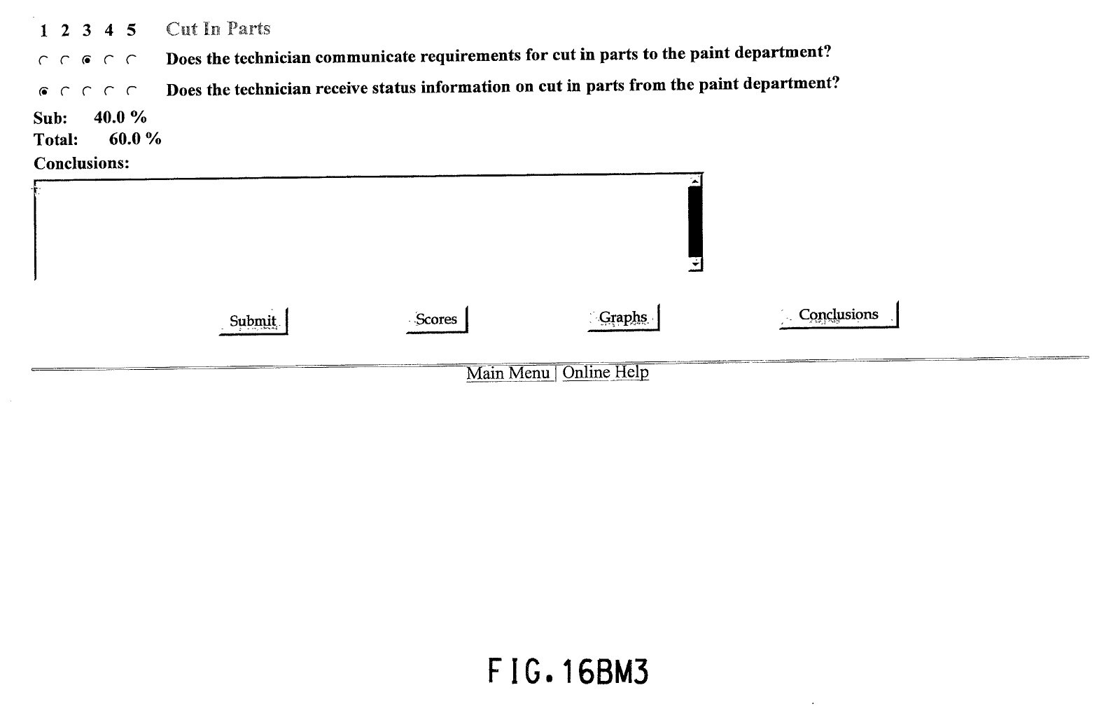

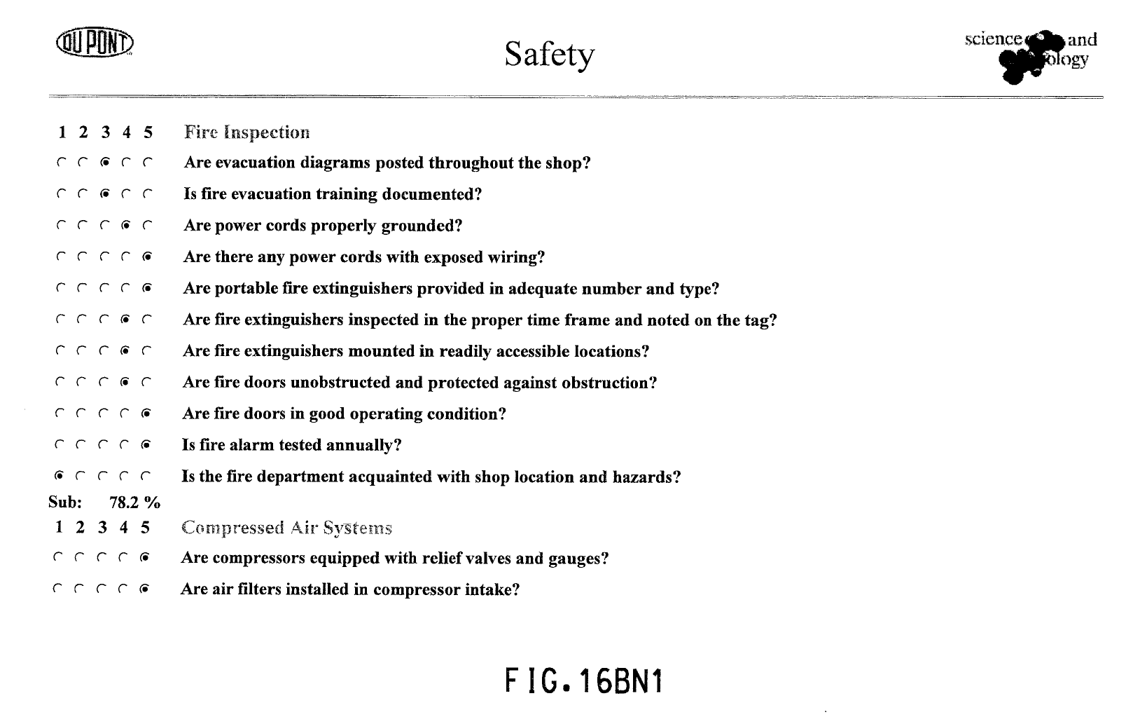

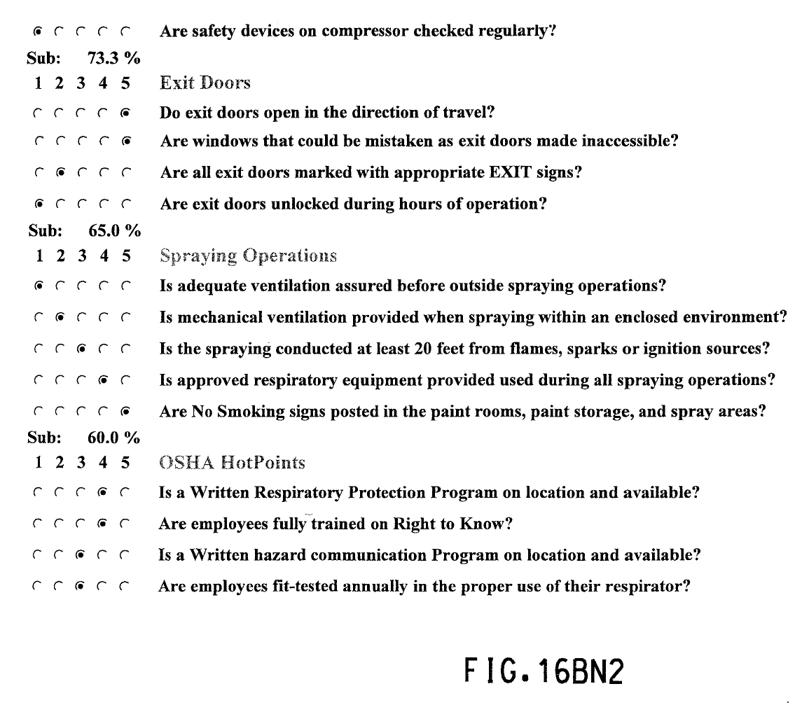

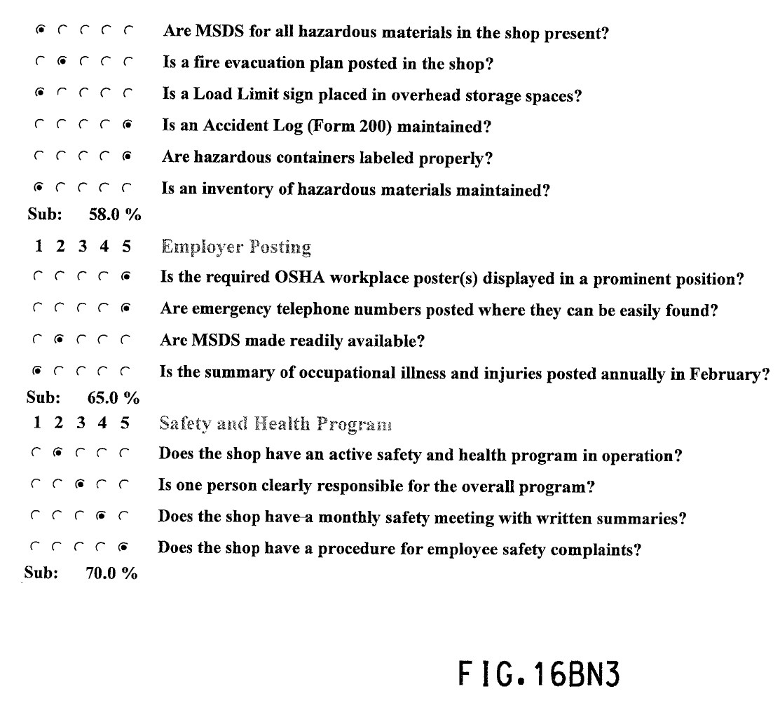

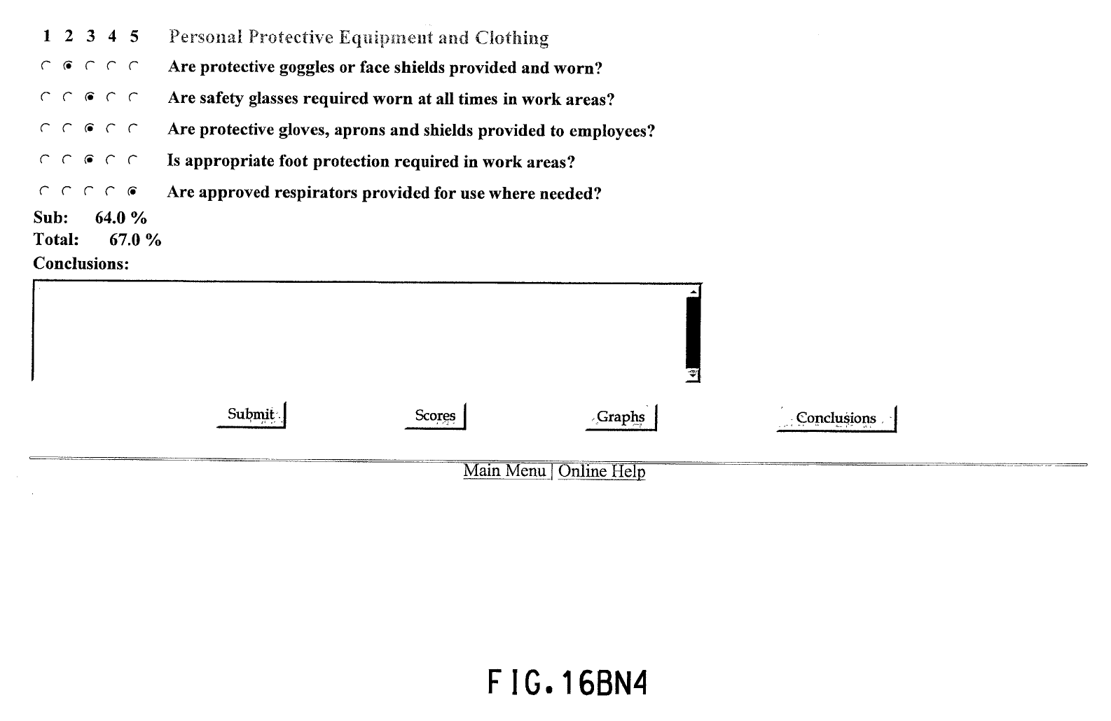

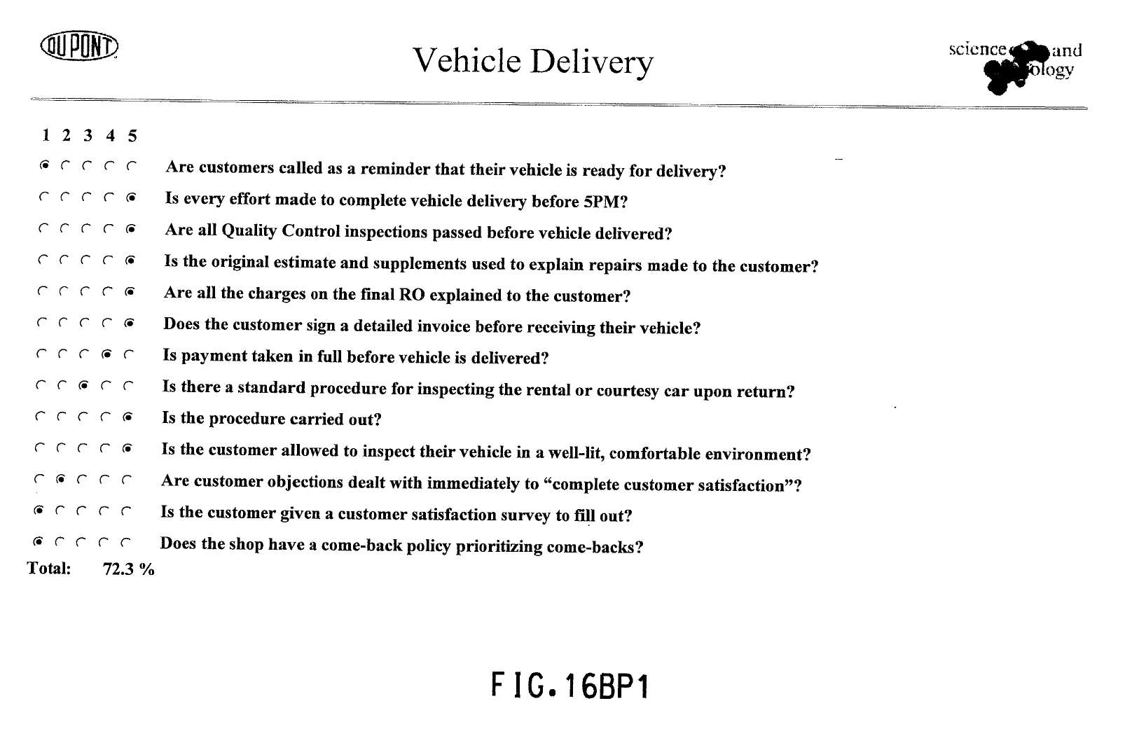

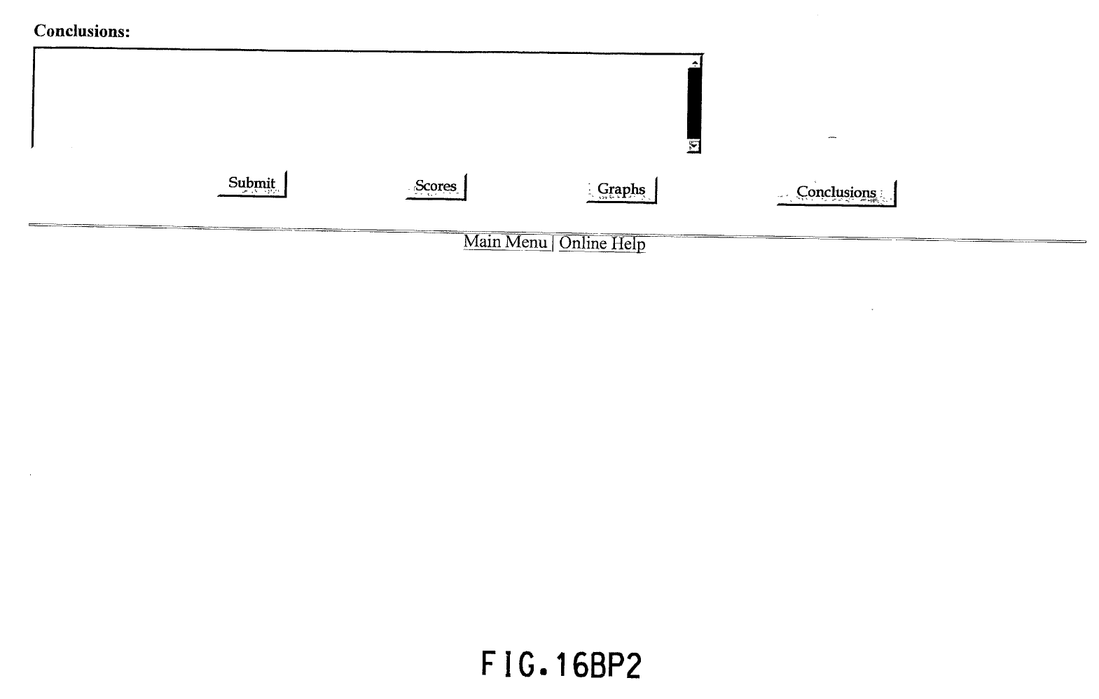

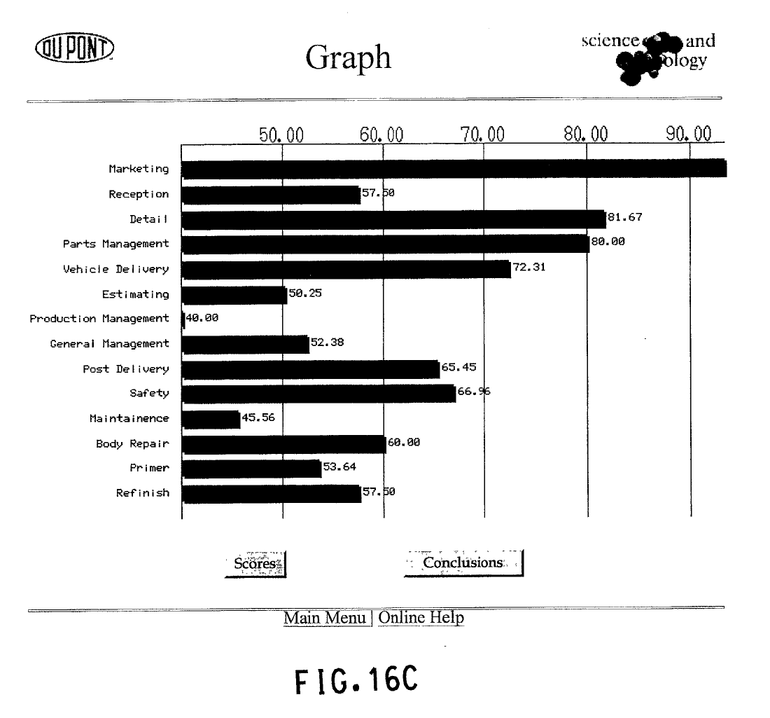

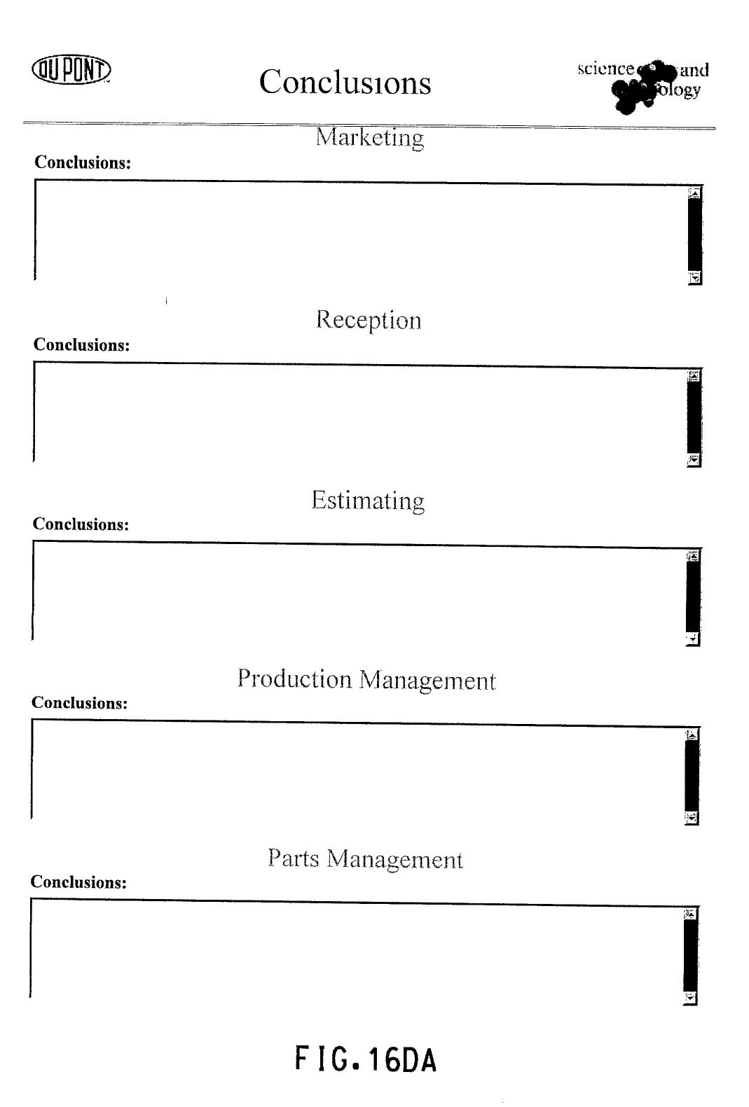

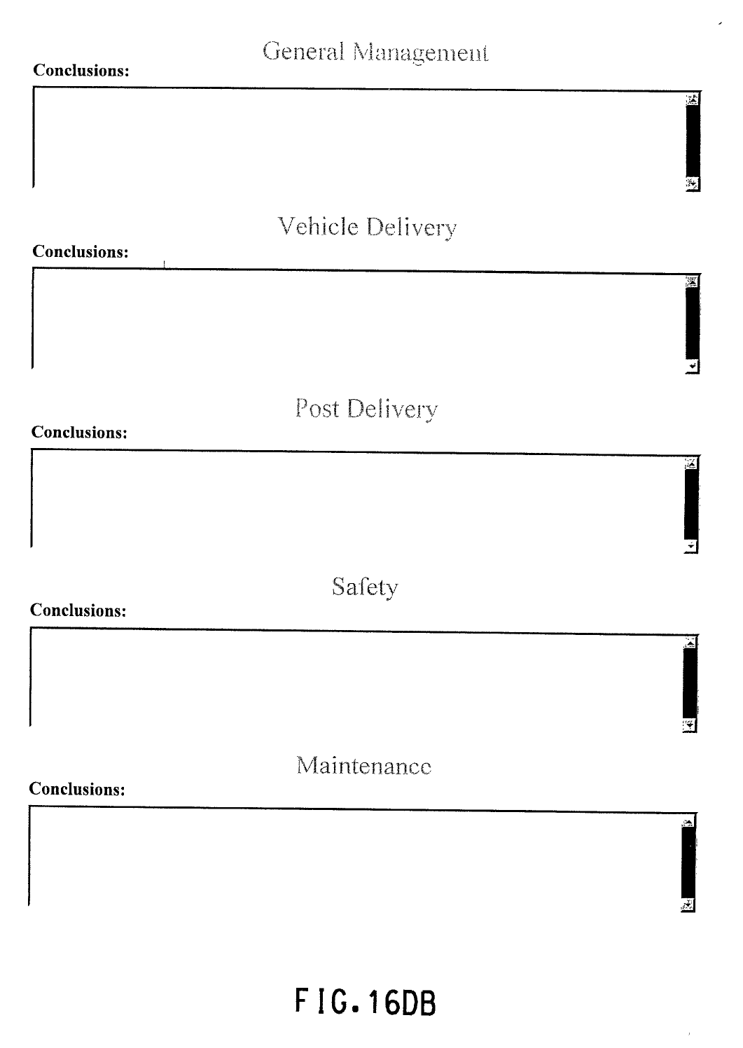

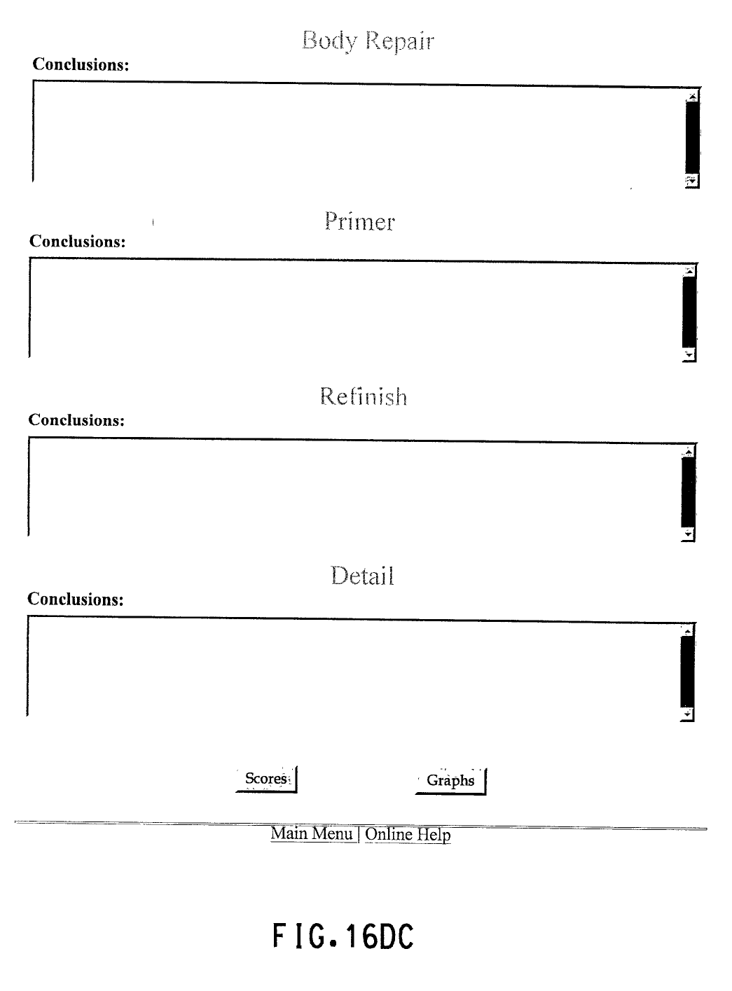

If customer computer 2 in step 132 selects a process audit business tool 1322 from menu 129, host computer 4 through step 134 then directs customer computer 2 to tool 1322. FIG. 16A shows screen shots of process audit business tool 1322 and provides instructions for using the chosen business tool.

The following instructions are provided in FIG. 16A for process audit business tool 1320, which is used to identify weaknesses in the shop practices followed in the customer's plant:

### “Purpose

The process audits are a series of checklists that you can use to identify weaknesses in the shop practices in your shop.

### Background

Auditing the process checklist below allows you to highlight areas for improvement or to identify people who need to be retrained in the standardized process:

| Detail | Production Management |
|---|---|
| Estimating | Reception |
| Estimating | Refinish |
| Maintenance | Body Repair |
| Marketing | Safety |
| Parts Management | Vehicle Delivery |
| Post Delivery | Primer |

### Data Needed for Input

You don't need to collect any data to do this audit but you do need a detailed knowledge of how your business process work. Thus, staff personnel from several disciplines would be needed to complete the audit.

### How to Use

The first screen that comes up when you start the audit process business tool is the scorecard. To complete the scorecard for a particular area, just click on the red text for the name of that area, which will bring up the checklist for that area. Next you rate that area from 1 to 5 by clicking on the radio button. As you complete the ratings, you will get a score for that part of the shop. At the bottom of each process checklist there is a comment box. You can make any additional comments here that you want to show up in the final report. Continue the aforedescribed rating process for each section of the shop you want to evaluate.

### Understanding the Output

Once you have completed all the checklists, you can get a graph of each audit score, which will identify those areas of the plant that are most in need of improvement. Try to focus on the worst areas first. Determine from the checklist whether you need more training, better systems, clearer written procedures, etc. Since, you cannot change all of your processes at the same time, begin with the areas needing most improvement and complete that improvement first before tackling other areas. Generally, if you determine the root cause of the problems, you can make a change that can correct several problems at the same time. Once you completed the improvements, decide how you would measure the improved process so that you can effectively monitor the process to prevent its degradation over time. You can use the run chart business tool for suggested measurements and then graphically chart the measurements that you feel are most important.”

Thus, FIG. 16B shows the screen used to enter rating for various categories and develop a scorecard. By clicking on the individual categories, computer 2 is linked to an individual score card for that category. The customer can then rate the category on the scale of 1 to 5, 5 being best and 1 being the worst. The screen shots of the ratings used for the various categories are shown in FIGS. 16BA1, 16BA2, 16BB1, 16BB2, 16BB3, 16BB4, 16BB5, 16BB6, 16BC1, 16BC2, 16BC3, 16BD1, 16BD2, 16BE1, 16BE2, 16BF1, 16BF2, 16BG1, 16BG2, 16BH1, 16BH2, 16BJ1, 16BJ2, 16BJ3, 16BJ4, 16BK1, 16BK2, 16BK3, 16BK4, 16BL1, 16BL2, 16BL3, 16BM1, 16BM2, 16BM3, 16BN1, 16BN2, 16BN3, 16BN4, 16BP1 and 16BP2. The results can be seen on the screen shot of FIG. 16B or through a graphical representation on the screen shot of FIG. 16C. As a result, the customer can then focus on those categories of the business that score low in the evaluation. FIGS. 16DA, 16DB and 16DC show the screen shots of conclusions regarding the various categories, which can be used in future and follow up.

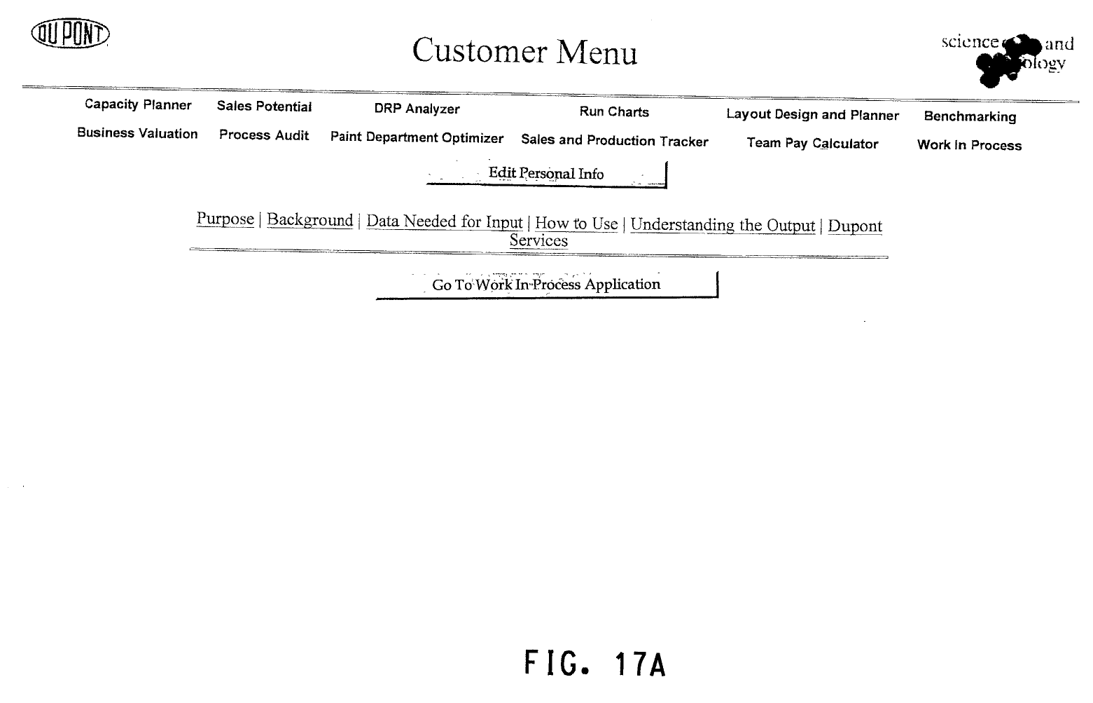

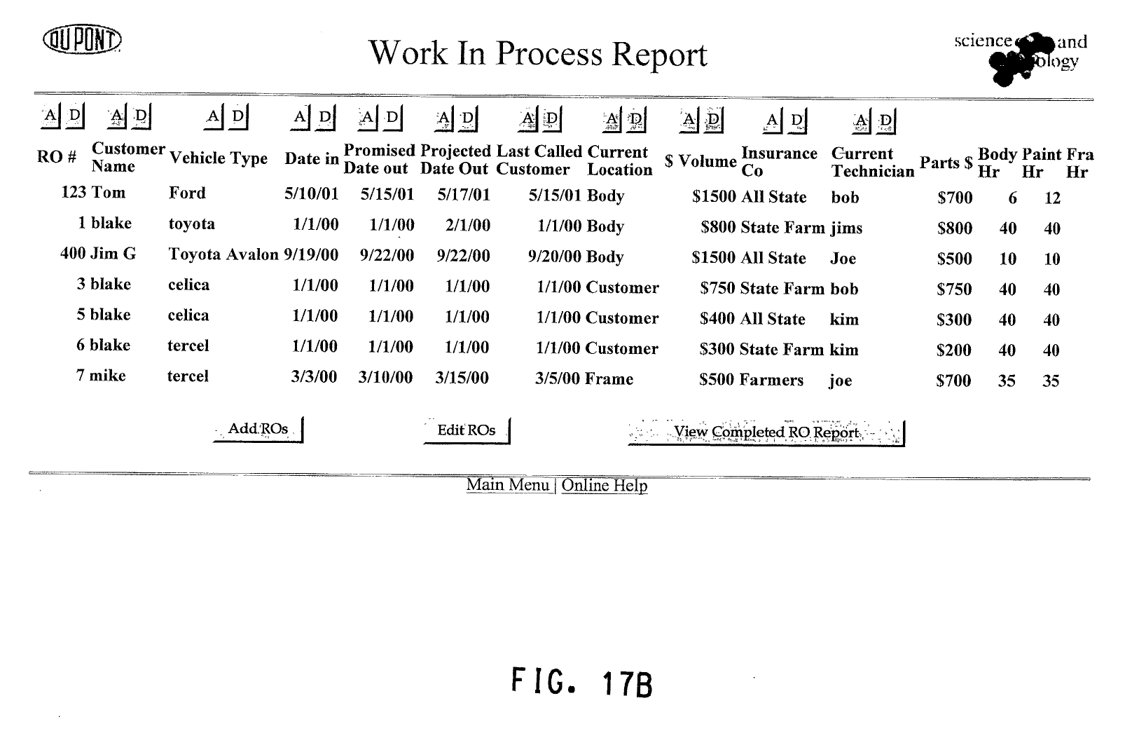

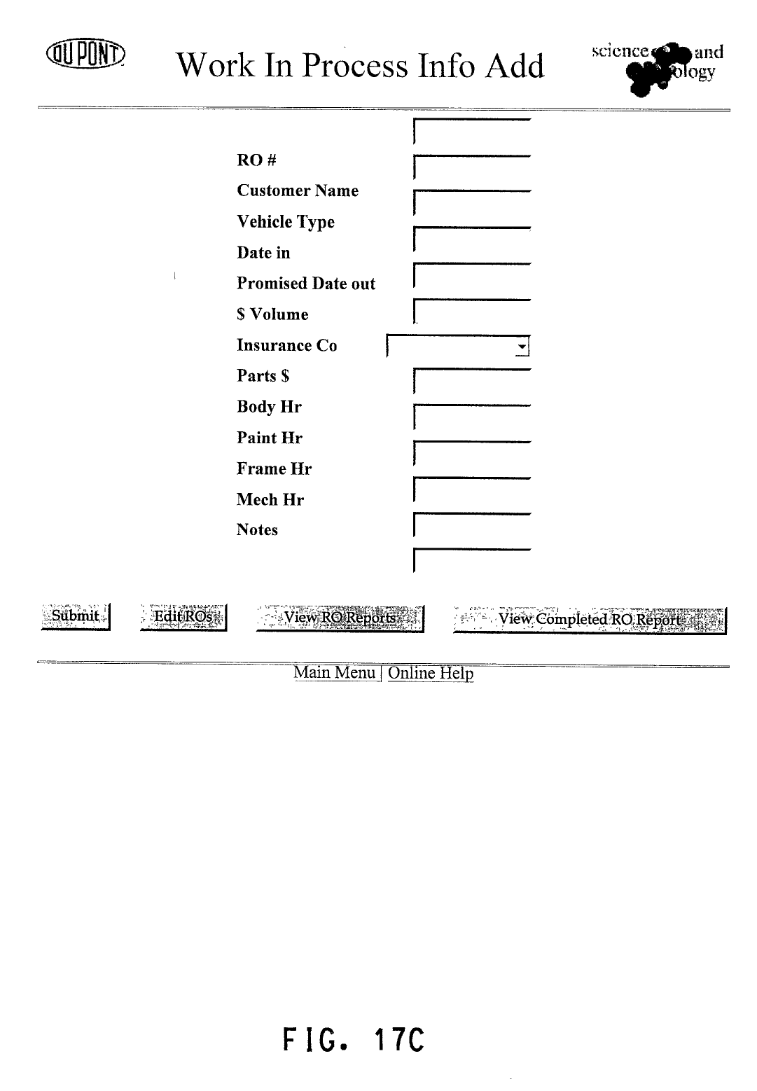

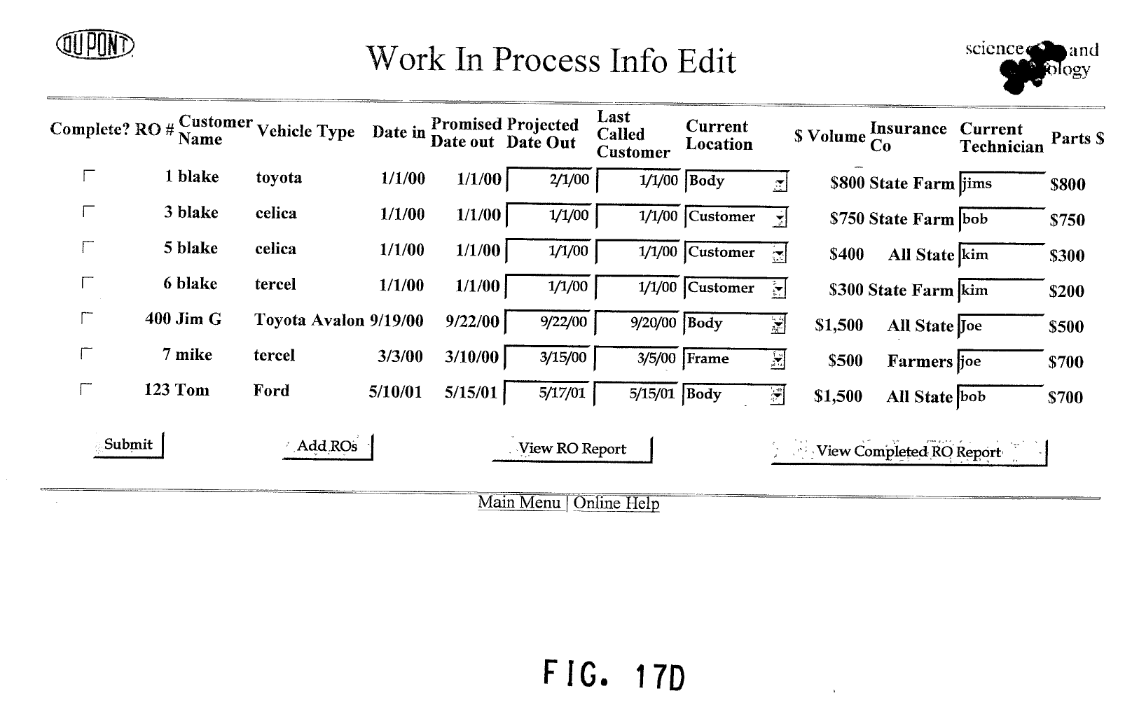

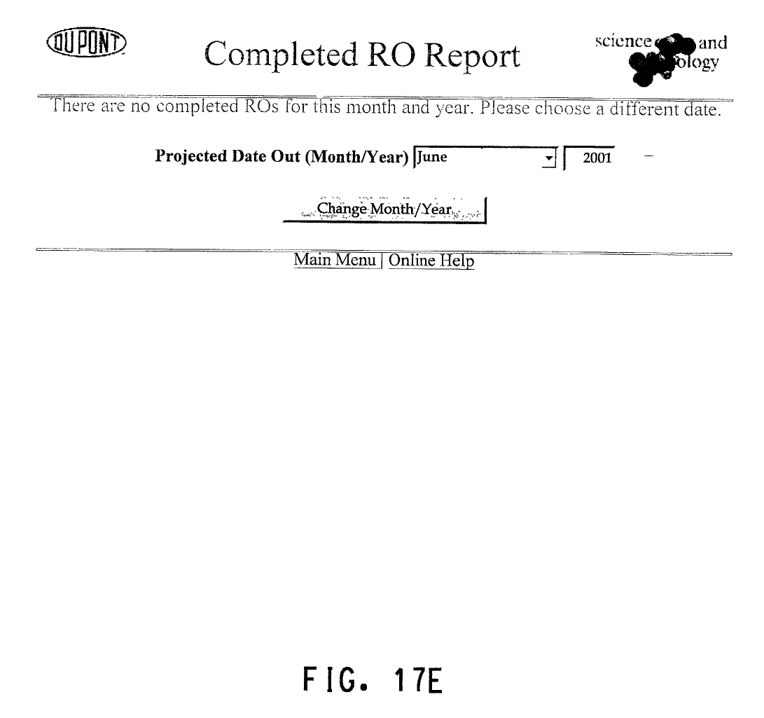

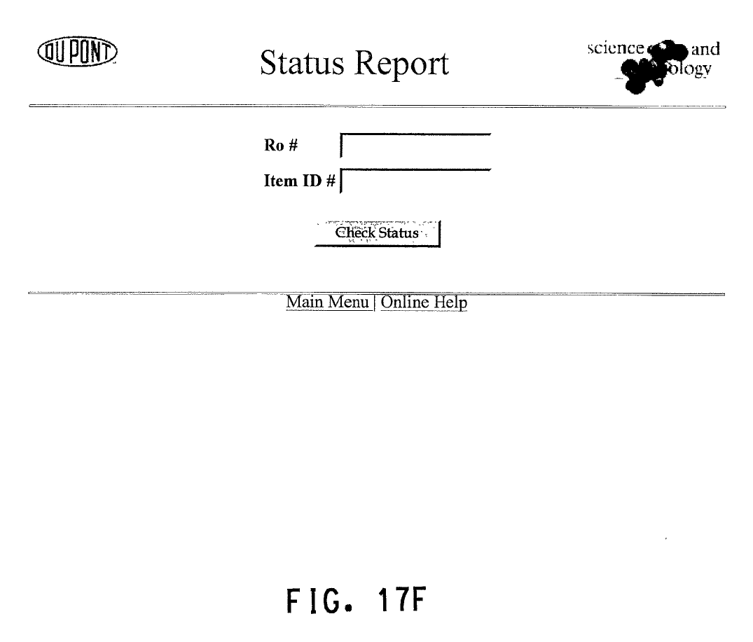

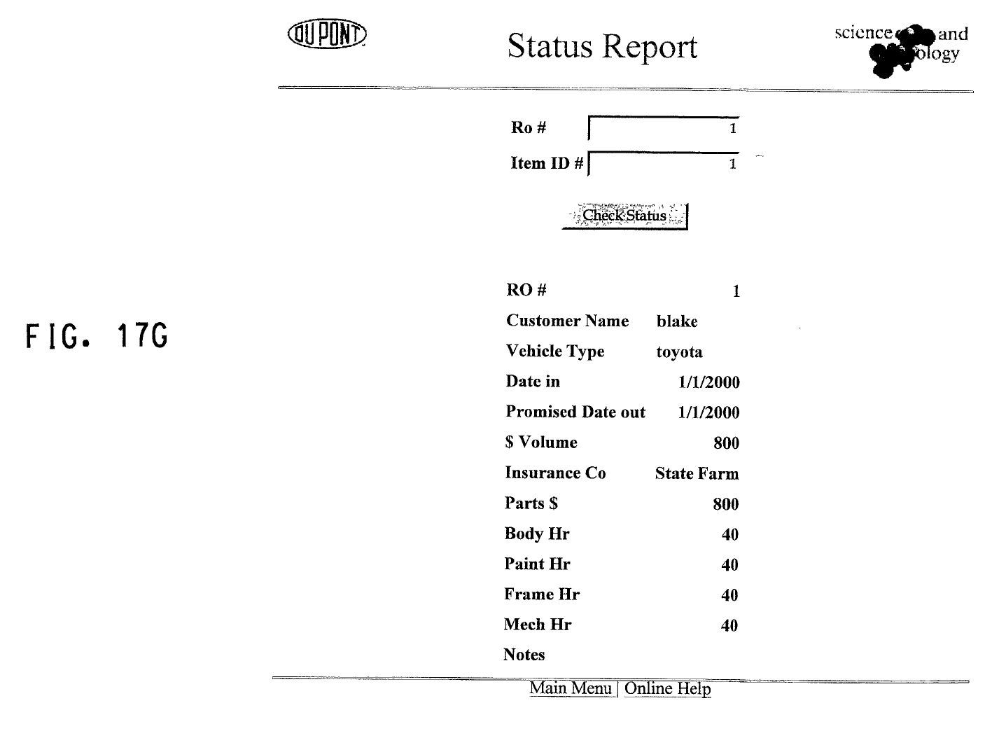

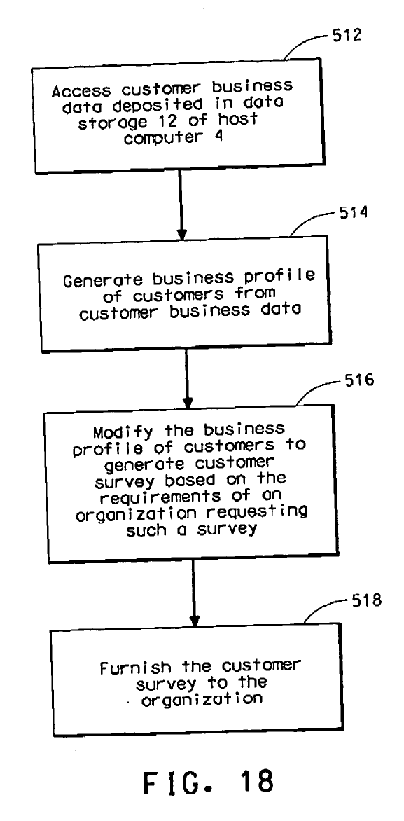

If customer computer 2 in step 132 selects a work-in-process business tool 1324 from menu 129, host computer 4 through step 134 then directs customer computer 2 to tool 1324. FIG. 17A shows screen shots of work-in-process business tool 1324 and provides instructions for using the chosen business tool.

The following instructions are provided in FIG. 17A for team work-in-process business tool 1324, which is used to allow the customer's clients access to the current completion date on their work being performed by the customer via a web site based access.

### “Purpose

The work-in-process business tool was developed to allow access to the shop manager and the client to the current status of the project, such as a car being repaired in the shop. The shop manager can access all projects but the client can only access his own.

### Background

When a car enters the collision repair shop system it is difficult to manage and communicate the status of all vehicles in the shop. This tool can be accessed by anyone in the shop and also by the client from any computer connected to the internet. This tool can be used regularly during the course of the day to communicate the status of all vehicles. The project information and its status should be updated preferably twice a day by entering on entry points provided on the shop floor or via conventional wireless remote entry pads provided to the personnel on the floor.

### Data Needed for Project Information and Project Status

| | |
|---|---|
| RO # | Job Status |
| Client Name | Insurance Co |
| Vehicle Type | Current Technician |
| Date in | Parts cost |
| Promised Date out | Body Hours |
| Projected Date Out | Paint Hours |
| Last Called Client | Frame Hours |
| Current Location | Mechanics Hours |
| Sales Volume | Notes |

### How to Use

Enter all new vehicles entering the collision process by using the “add RO” button. Twice a day tour the shop and collect data on the status of repair orders. Update any changes to the project information and project status into the application using the “edit ROs” button. This allows you to change the projected date out, date last called the client, location in the process, job completed, and technician then submit the data. When you select “view reports” you can then sort the data by pushing the ascending and descending buttons at the top of each column in the report. The client can remotely logon to the client information data location via the internet based web site at his home or elsewhere and enter a unique project identifier that represents his job. The client will then have access to the current project status of the job, including the latest projected completion date. When a job is complete, just check the “completed” button and submit. This will move the job from the work-in-process report to the completed report.

### Understanding the output

The main value of this report is that anyone in the shop can access the current status of a project and so can the client. You can also sort the work-in-progress data to use for different purposes, such as by insurance company when dealing with adjusters from different insurance companies, by projected completion date to select work priorities, or by client contact date to call the client, or by technician to see who is working on what job”

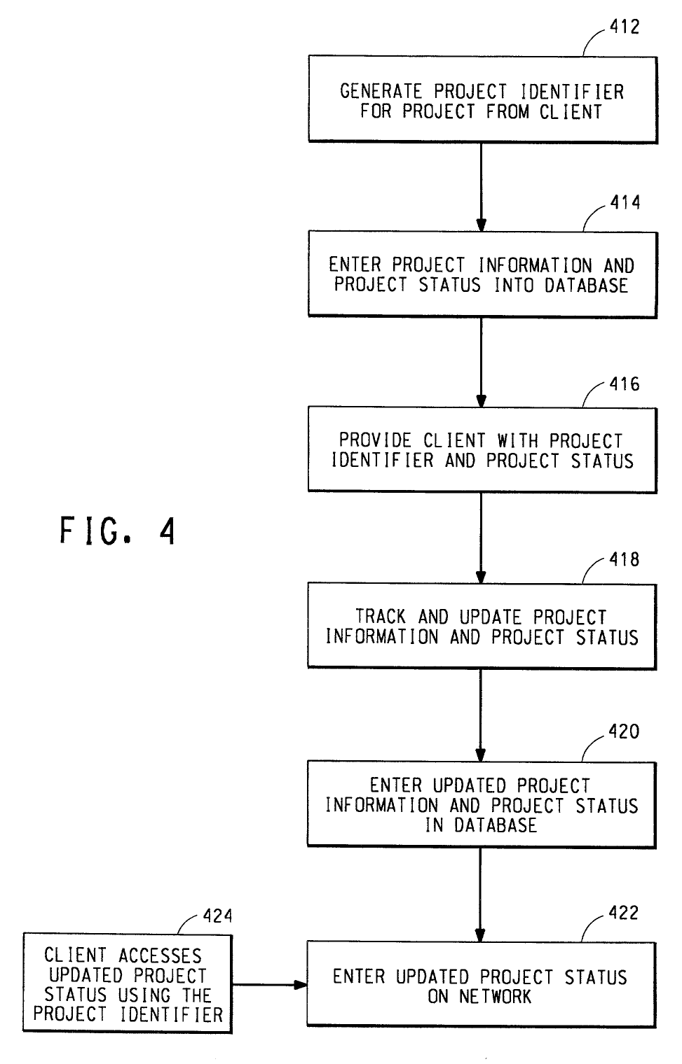

Step 150 for work-in-progress business tool 1324 shown in FIG. 4 include the following steps:

In a step 412, a project identifier is generated for an incoming project, such as repairing and/or painting an automobile, received from a customer's client. In a step 414, a projected status information and project status is generated. In a step 416, the client is provided with the project identifier such that the client can remotely log-on to data location on the internet website at his leisure and get the current status of the project. In a step 418, the project is tracked on the shop floor and project information and project status are updated by the personnel working on the shop floor by logging on to work-in-progress business tool 1324 via customer computer 2. The screen shot of FIG. 1 7B shows the work-in-progress report. FIG. 17C shows a screen shot where the project information is typically updated as the project moves through the process. The screen shot of FIG. 17D shows the work-in-progress project information as it is updated. Several conventional methods can be used to enter the data, such as by providing touch-type CRT monitors, keypads, or preferably via wireless remote computers (mobile or stationary), which permit the personnel to enter the data on customer computer 2 without moving away from the workstation. Alternatively, the updates can be entered by attaching to the project, such as a car, intelligent labels, such as Intellitag Tags supplied by Intermac Technologies Corporation, Everett, Wash. The data can be stored on these intelligent labels, which can be read and updated automatically as the project moves through the process. The labels can be read and the data sent to the database via a variety of input devices, such as 6110 Mobile Computer supplied by Intermac Technologies Corporation. Alternatively, the data can also be sent from host computer 4 to the intelligent label for adjusting the process conditions. A sales brochure of Intermac Technologies Corporation identified as #608875B 5/00 (2000), is incorporated herein by reference.

The screen shot of FIG. 17E shows the project information report once the project is completed. In a step 420, host computer 4 updates project information and project status onto to the database. In a step 422, host computer 4 enters the updated project status on a data location accessible to the client. In a step 424, client using his computer can access the updated project status by entering the project identifier. FIG. 17F shows the screen shot where the client can enter the identifier and FIG. 17G shows the screen shot of the updated project status, which includes the updated project completion date.

The business solution for work-in-progress business tool 1324 in step 156 comprises allowing the client to track the project status accessed by entering the project identifier at the data location.

In addition to the foregoing business tools, the process of the present invention also has other uses. For example, a substantial amount of the customer business data generated by various businesses accessing host computer 4 is deposited in data storage 12 of host computer 4. Thus, this information can be processed to generate valuable business profiles of customers accessing host computer 4. For example, organizations, such as insurance companies that pay for auto repairs, or companies that manufacture products, such as paints, or equipment, such as spray machines, may wish to have a market analysis or survey conducted to generate new business or improve existing business with companies that utilize their products or services. Thus, the process of the present invention can be used to process the customer business data stored in step 152 to generate a business profile of the customer. The business profile can then be modified to generate a customer survey or marketing analysis based on the requirement furnished to host computer 4 by an organization, such as an insurance company, a marketing company or a manufacturer, requesting such a survey or analysis. Finally, the organization can be furnished the marketing survey or analysis, either through hard copy or through a portal on the internet, which can be accessed by the organization provided with a special identifier.

It should be understand that the process of the present invention should not be construed to be suitable for just an auto repair shop, it is equally well suited for other businesses, such as machine shops, grocery stores, butcher shops, barber shops, manufacturing plants, etc.

1. A network-based business process comprising the steps of:
(a) receiving an Initial request from a customer computer linked with a host computer through a network;
(b) completing a log-on procedure to allow the customer computer to access said host computer having a main menu comprising business tools suitable for improving performance of a customer;
(c) requesting the customer computer to choose one of said business tools from said menu;
(d) requesting the customer computer to enter customer business data required for business performance analysis in said chosen business tool;
(e) processing said data through an algorithmic module of said chosen business tool to carry out a business analysis for said business tool; and
(f) providing a business solution based on said business analysis to said customer computer to identify process problems and poor financial performance of said customer.

2. The process of claim 1 further comprises the steps of:
requesting the customer computer to deposit a payment before said step (c); and
authenticating the receipt of said payment deposited by the customer computer.

3. The process of claim 1 wherein said log-on procedure in said step (b) comprises the steps of:
ascertaining identity of said customer computer to determine whether said customer computer is a new user computer or a current user computer,
requesting for said new user computer to enter new customer information into said host computer,
generating customer identification information,
sending a customer identity data to the new user computer for allowing access in future to said host computer, and
allowing said new user computer access to said main menu

4. The process of claim 1 wherein said log-on procedure in said step (b) comprises the steps of:
ascertaining Identity of said customer computer to determine whether said customer computer is a new user computer or a current user computer,
requesting for said current user computer to enter a customer identity data for matching against a current customer identity data stored on the host computer;
allowing said current user computer access to said main menu.

5. The process of claim 1 wherein one of said business tools in said main menu is PAINT DEPARTMENT OPTIMIZER.

6. The process of claim 1 wherein said step (c) further comprises providing instructions for using said chosen business tool.

7. The process of claim 6 further comprises providing said customer computer on-line help for using said chosen business tool.

8. The process of claim 1 wherein said stop (d) further comprises analyzing validity of said customer business data against a preprogrammed paradigm for said chosen business tool.

9. The process of claim 1 wherein said step (f) further comprises offering said customer computer on-line help to explain said business solution.

10. The process of any one of claims 1 through 9 wherein said network comprises internet.

11-33. (canceled)

34. The process of claim 5 wherein said step (e) for said business tool for said PAINT DEPARTMENT OPTIMIZER comprises the steps of:
tabulating monthly total sales, paint & materials revenues, paint & materials purchase cost, number of paint mixes made, average cost per paint mix, number of completed repair orders, average cost per said repair order, wherein the average total sales per number of repair orders is calculated by using the following formula;
$$\frac{Total sales}{Number of completed repair orders} \qquad ( xxvii )$$
wherein the average cost per paint mix is calculated by using the following formula:
$$\frac{Paint \& materials purchase cost }{Number of Mixes} ; and \qquad ( xxviii )$$
determining percent gross profit on paint & materials by using the following formula:
$$100 \times \frac{\begin{matrix}Paint \& materials revenues - \\ Paint \& materials purchase cost\end{matrix}}{Paint \& materials revenues} ; \qquad ( xxix )$$
determining percent cost for paint & materials as percentage of said total sales by using the following formula:
$$100 \times \frac{Paint \& materials purchase cost}{Total sales} ; \qquad ( xxx )$$
determining goal cost for paint & materials purchase as a percentage of said total sales by using the following formula:
$$Desired perentage rate \times \frac{Total sales}{100} ; and \qquad ( xxxi )$$
determining percent goal gross profit on paint & materials by using the following formula:
$$100 \times \frac{\begin{matrix}Paint \& materials revenues - Said goal cost \\ for paint \& materials purchase\end{matrix}}{Paint \& materials revenues} . \qquad ( xxxii )$$

35. The process of claim 34 wherein said business solution in said step (f) comprises tracking current performance of a paint department of said customer against a performance goal by:
comparing said percent gross profit on paint & materials on a monthly and annual basis against a percent industry standard gross profit for paint & materials for a comparable business accessed from a standardized performance database;
comparing said percent cost for paint & materials as percentage of said total sales on a monthly and annual basis against said percent goal cost for paint & materials as percentage of said total sales; and
comparing said number of paint mixes made, average cost per paint mix, number of completed repair orders and average cost per said repair order on a monthly and annual basis against industry standards of a comparable business accessed from a standardized performance database.

36. The process of claim 35 wherein said desired percent rate is 0.1% to 5%.

37. The process of claim 35 or 36 wherein said number of paint mixes made, average cost per paint mix, number of completed repair orders and average cost per said repair order are compared against upper 25^{th} percentile of comparable businesses accessed from said standardized performance database.

38-48. (canceled)

49. The process of claim 1 or 5 wherein said customer is a collision repair shop.

50-68. (canceled)

59. A network-based business process comprising the steps of:
(a) receiving an initial request from a customer computer linked with a host computer through a network;
(b) completing a log-on procedure to allow the customer computer to access said host computer having a main menu comprising a business tool suitable for improving performance of a customer;
(c) requesting the customer computer to enter customer business data required for business performance analysis in said business tool;
(e) processing said data through an algorithmic module of said business tool to carry out a business analysis for said business tool; and
(f) providing a business solution based on said business analysis to said customer computer to identify process problems and poor financial performance of said customer.
6O. A network-based business process consisting of the steps of:
(a) receiving an initial request from a customer computer linked with a host computer through a network;
(b) completing a log-on procedure to allow the customer computer to access said host computer having a main menu comprising business tools suitable for improving performance of a customer;
(c) requesting the customer computer to choose one of said business tools from said menu;
(d) requesting the customer computer to enter customer business data required for business performance analysis in said chosen business tool;
(e) processing said data through an algorithmic module of said chosen business tool to carry out a business analysis for said business tool; and
(f) providing a business solution based on said business analysis to said customer computer to identify process problems and poor financial performance of said customer.
